(19) United States
(12) Patent Application Publication
(10) Pub. No.: US 2025/0357481 A1
(43) Pub. Date: Nov. 20, 2025

(54) SECONDARY BATTERY

(71) Applicant: SEMICONDUCTOR ENERGY LABORATORY CO., LTD., Atsugi-shi, Kanagawa-ken (JP)

(72) Inventors: Shunpei YAMAZAKI, Setagaya, Tokyo (JP); Yohei MOMMA, Isehara, Kanagawa (JP); Shotaro MURATSUBAKI, Hachioji, Tokyo (JP); Tatsuyoshi TAKAHASHI, Atsugi, Kanagawa (JP); Mayumi MIKAMI, Atsugi, Kanagawa (JP); Jo SAITO, Atsugi, Kanagawa (JP); Teruaki OCHIAI, Atsugi, Kanagawa (JP); Atsushi KAWATSUKI, Yokohama, Kanagawa (JP)

(21) Appl. No.: 18/867,028

(22) PCT Filed: May 31, 2023
(86) PCT No.: PCT/IB2023/055549

§ 371 Date: Nov. 19, 2024

(30) Foreign Application Priority Data
Jun. 8, 2022 (JP) 2022-092768
Jun. 22, 2022 (JP) 2022-100362
Sep. 2, 2022 (JP) 2022-140024

(51) Int. Cl. H01M 4/525; H01M 4/02; H01M 4/58; H01M 10/0525

(52) U.S. Cl. CPC H01M 4/525; H01M 4/582; H01M 10/0525; H01M 2004/028

(57) ABSTRACT

A positive electrode active material which inhibits the discharge capacity from decreasing during charge and discharge cycles and a secondary battery using the positive electrode active material are provided. A highly safe secondary battery is provided. The secondary battery includes a positive electrode active material, which contains lithium cobalt oxide containing nickel and magnesium. The detected amounts of nickel and magnesium in a surface portion of the positive electrode active material are larger than the detected amounts of nickel and magnesium in an inner portion of the positive electrode active material. The distribution of nickel and the distribution of magnesium overlap with each other in the surface portion of the positive electrode active material. In the above, the positive electrode active material preferably further contains fluorine and the detected amount of fluorine in the surface portion of the positive electrode active material is preferably larger than the detected amount of fluorine in the inner portion of the positive electrode active material.

### TECHNICAL FIELD

One embodiment of the present invention relates to an object, a method, or a manufacturing method. Alternatively, the present invention relates to a process, a machine, manufacture, or a composition (composition of matter). One embodiment of the present invention relates to a power storage device including a secondary battery, a semiconductor device, a display device, a light-emitting device, a lighting device, an electronic device, or a manufacturing method thereof.

Electronic devices in this specification mean all devices including power storage devices, and electro-optical devices including power storage devices, information terminal devices including power storage devices, and the like are all electronic devices.

### BACKGROUND ART

In recent years, a variety of power storage devices such as lithium-ion secondary batteries, lithium-ion capacitors, air batteries, and all-solid-state batteries have been actively developed. In particular, demand for lithium-ion secondary batteries with high output and a high capacity has rapidly grown with the development of the semiconductor industry. The lithium-ion secondary batteries are essential as rechargeable energy supply sources for today's information society.

In particular, secondary batteries for mobile electronic devices, for example, are highly demanded to have high discharge capacity per weight and excellent cycle performance. In order to meet such demands, positive electrode active materials in positive electrodes of secondary batteries have been actively improved (e.g., Patent Document 1 to Patent Document 3). In addition, a crystal structure of a positive electrode active material has also been studied (Non-Patent Document 1 to Non-Patent Document 4).

In addition, X-ray diffraction (XRD) is one of methods used for analysis of the crystal structure of a positive electrode active material. With the use of the ICSD (Inorganic Crystal Structure Database) described in Non-Patent Document 5, XRD data can be analyzed. For example, the ICSD can be referred to for the lattice constant of the lithium cobalt oxide described in Non-Patent Document 6. For Rietveld analysis, the analysis program RIETAN-FP (Non-Patent Document 7) can be used, for example. VESTA (Non-Patent Document 8) can be used as software for drawing crystal structures.

As image processing software, for example, ImageJ (Non-Patent Document 9 to Non-Patent Document 11) is known. Using this software makes it possible to analyze the shape of a positive electrode active material, for example.

Nanobeam electron diffraction can also be effectively used to identify the crystal structure of a positive electrode active material, particularly the crystal structure of its surface portion. For analysis of electron diffraction patterns, an analysis program ReciPro (Non-Patent Document 12) can be used, for example.

Fluorides such as fluorite (calcium fluoride) have been used as fusing agents in iron manufacture and the like for a very long time, and the physical properties of fluorides have been studied (Non-Patent Document 13).

Various researches and developments have been conducted for the reliability and safety of lithium-ion secondary batteries. For example, Non-Patent Document 14 shows the thermal stability of a positive electrode active material and an electrolyte solution.

### REFERENCES

### Patent Documents

[Patent Document 1] Japanese Published Patent Application No. 2019-179758
[Patent Document 2] International Publication WO 2020/026078 Pamphlet
[Patent Document 3] Japanese Published Patent Application No. 2020-140954

### Non-Patent Documents

[Non-Patent Document 1] Toyoki Okumura et. al., “Correlation of lithium ion distribution and X-ray absorption near-edge structure in O3- and O2-lithium cobalt oxides from first-principle calculation”, Journal of Materials Chemistry, 2012, 22, pp. 17340-17348
[Non-Patent Document 2] Motohashi, T. et. al., “Electronic phase diagram of the layered cobalt oxide system LiₓCoO₂ (0.0≤x≤1.0)”, Physical Review B, 80 (16); 165114
[Non-Patent Document 3] Zhaohui Chen et. al., “Staging Phase Transitions in LiₓCoO₂”, Journal of The Electrochemical Society, 2002, 149(12), A1604-A1609
[Non-Patent Document 4] G. G. Amatucci et. al., “CoO₂, The End Member of the LiₓCoO₂ Solid Solution”, J. Electrochem. Soc., 143(3), 1114 (1996).
[Non-Patent Document 5] Belsky, A. et al., “New developments in the Inorganic Crystal Structure Database (ICSD): accessibility in support of materials research and design”, Acta Cryst., (2002) B58, 364-369.
[Non-Patent Document 6] Akimoto, J.; Gotoh, Y.; Oosawa, Y. “Synthesis and structure refinement of LiCoO₂ single crystals”, Journal of Solid State Chemistry (1998) 141, pp. 298-302.
[Non-Patent Document 7] F. Izumi and K. Momma, Solid State Phenom., 130, 15-20 (2007).
[Non-Patent Document 8] K. Momma and F. Izumi, J. Appl. Cryst. (2011). 44, 1272-1276
[Non-Patent Document 9] Rasband, W. S., ImageJ, U. S. National Institutes of Health, Bethesda, Maryland, USA, http://rsb.info.nih.gov/ij/, 1997-2012.
[Non-Patent Document 10] Schneider, C. A, Rasband, W. S., Eliceiri K. W., “NIH Image to ImageJ: 25 years of image analysis”, Nature Methods, 9, 671-675, 2012.
[Non-Patent Document 11] Abramoff, M. D., Magelbaes, P. J., Ram, S. J., “Image Processing with ImageJ”, Biophotonics International, volume 11, issue 7, pp. 36-42, 2004.
[Non-Patent Document 12] Seto, Y. & Ohtsuka, M., “ReciPro: free and open-source multipurpose crystallographic software integrating a crystal model database and viewer, diffraction and microscopy simulators, and diffraction data analysis tools” (2022) J. Appl. Cryst., 55.
[Non-Patent Document 13] W. E. Counts, R. Roy, and E. F. Osborn, “Fluoride Model Systems: II, The Binary Systems CaF₂—BeF₂, MgF₂—BeF₂, and LiF—MgF₂”, Journal of the American Ceramic Society, 36 [1] 12-17 (1953).
[Non-Patent Document 14] Shinya Kitano et al., GS Yuasa Technical Report, Vol. 2, No. 2, December 2015, pp. 18-24.

### SUMMARY OF THE INVENTION

### Problems to be Solved by the Invention

There is room for improvements in a variety of aspects of lithium-ion secondary batteries, such as discharge capacity, cycle performance, reliability, safety, and cost.

Therefore, positive electrode active materials that can improve discharge capacity, cycle performance, reliability, safety, cost, and the like when used in secondary batteries have been needed.

An object of one embodiment of the present invention is to provide a positive electrode active material or a composite oxide which can be used in a lithium-ion secondary battery and which inhibits the discharge capacity from decreasing during charge and discharge cycles. Another object is to provide a positive electrode active material or a composite oxide whose crystal structure is not easily broken even when charging and discharging are repeated. Another object is to provide a positive electrode active material or a composite oxide with high discharge capacity. Another object is to provide a highly safe or highly reliable secondary battery.

Another object of one embodiment of the present invention is to provide a positive electrode active material, a composite oxide, a power storage device, or a manufacturing method thereof.

Note that the description of these objects does not preclude the existence of other objects. One embodiment of the present invention does not need to achieve all of these objects. Other objects can be derived from the descriptions of the specification, the drawings, and the claims.

### Means for Solving the Problems

In order to solve the above objects, one embodiment of the present invention provides lithium cobalt oxide containing magnesium, nickel, and aluminum in a surface portion. In particular, nickel preferably exists on a plane where the diffusion path of lithium is exposed (also referred to as an edge plane or a plane other than a (001) plane of lithium cobalt oxide). In addition, it is preferable that a region containing magnesium and a region containing nickel overlap with each other, be connected to each other, or be combined with each other on a plane through which lithium can be inserted and extracted, that is, a plane other than the (001) plane. This structure can inhibit oxygen from releasing from the positive electrode active material or the positive electrode active material from changing its structure. In other words, when a shell is provided on a plane other than the (001) plane, release of oxygen from the plane other than the (001) plane can be inhibited in some cases. The (001) plane, a (003) plane, and the like are sometimes collectively referred to as a (00l) plane. The (00l) plane is sometimes referred to as a C-plane, a basal plane, or the like. In lithium cobalt oxide, lithium has a two-dimensional diffusion path. That is, it can be said that the diffusion path of lithium exists along a plane. In this specification and the like, a plane where the diffusion path of lithium is exposed, i.e., a plane through which lithium is inserted and extracted, which indicates a plane other than the (001) plane, is sometimes referred to as an edge plane.

The surface portion refers to a region from the surface to a certain depth in the inner portion. Here, in the lithium cobalt oxide of one embodiment of the present invention, it is particularly preferable that nickel exist in a portion where a surface is an edge plane in the surface portion.

In lithium cobalt oxide, lithium has a two-dimensional diffusion path. That is, the diffusion path of lithium can be expressed as being along the plane.

The diffusion path of lithium is exposed at the edge plane. In other words, the edge surface is a plane which is not parallel to the plane along which the diffusion path of lithium exists and which intersects with the plane along which the diffusion path of lithium exists.

The edge plane can also be regarded as a plane other than the (001) plane of the lithium cobalt oxide, for example. In the lithium cobalt oxide of one embodiment of the present invention, it is particularly preferable that nickel exist in a portion where a surface is a surface other than the (001) plane in the surface portion.

In addition to the above, the lithium cobalt oxide of one embodiment of the present invention preferably contains fluorine in the surface portion.

One embodiment of the present invention is a lithium-ion secondary battery including a positive electrode. The positive electrode includes a positive electrode active material. The positive electrode active material contains lithium cobalt oxide containing nickel and magnesium. A detected amount of nickel in a surface portion of the positive electrode active material is larger than a detected amount of nickel in an inner portion of the positive electrode active material. A detected amount of magnesium in the surface portion of the positive electrode active material is larger than a detected amount of magnesium in the inner portion of the positive electrode active material. A distribution of nickel and a distribution of magnesium overlap with each other in the surface portion of the positive electrode active material.

Nickel is preferably detected at a plane other than a (001) plane of lithium cobalt oxide in the surface portion of the positive electrode active material.

In the above, in EDX line analysis, a difference between a depth of a peak of the detected amount of nickel and a peak of the detected amount of magnesium in the surface portion of the positive electrode active material is preferably less than or equal to 3 nm.

In the above, the positive electrode active material preferably contains aluminum. In an EDX line analysis profile of nickel, magnesium, and aluminum contained in the positive electrode active material, a maximum value of a detected amount of aluminum is preferably observed at an inner portion than a maximum value of the detected amount of nickel and a maximum value of the detected amount of magnesium. When a peak width at a height of ⅕ of the maximum value of the detected amount of aluminum is divided to two parts by a vertical line drawn from the maximum value to the horizontal axis, a peak width W_{c} on an inner portion side is preferably larger than a peak width Wₛ on a surface side.

In the above, in a battery in which a counter electrode of the positive electrode is lithium, when the positive electrode is analyzed by powder X-ray diffraction using a CuKα1 ray in a state where the battery is charged to 4.6 V, a diffraction pattern of the positive electrode active material preferably includes a peak at least at 2θ of greater than or equal to 19.13° and less than 19.37° and 2θ of greater than or equal to 45.37° and less than 45.57°.

In the above, the positive electrode active material preferably contains titanium. The detected amount of titanium in the surface portion of the positive electrode active material is preferably larger than the detected amount of titanium in the inner portion of the positive electrode active material.

In the above, the positive electrode active material preferably contains fluorine. The detected amount of fluorine in the surface portion of the positive electrode active material is preferably larger than the detected amount of fluorine in the inner portion of the positive electrode active material.

### Effect of the Invention

According to one embodiment of the present invention, a positive electrode active material or a composite oxide which can be used in a lithium-ion secondary battery and which inhibits the discharge capacity from decreasing during charge and discharge cycles can be provided.

A positive electrode active material or a composite oxide whose crystal structure is not easily broken even when charging and discharging are repeated can be provided. A positive electrode active material or a composite oxide with high discharge capacity can be provided. Alternatively, a highly safe or highly reliable secondary battery can be provided.

Another embodiment of the present invention can provide a positive electrode active material, a composite oxide, a power storage device, or a manufacturing method thereof.

Note that the description of these effects does not preclude the existence of other effects. Note that one embodiment of the present invention does not necessarily need to have all these effects. Note that other effects will be apparent from the description of the specification, the drawings, the claims, and the like and other effects can be derived from the description of the specification, the drawings, the claims, and the like.

### BRIEF DESCRIPTION OF THE DRAWINGS

FIG. 1A and FIG. 1B are cross-sectional views of a positive electrode active material.

FIG. 2A to FIG. 2C are examples of distribution of additive elements contained in a positive electrode active material.

FIG. 3A is an example of distribution of additive elements contained in a positive electrode active material. FIG. 3B is a diagram showing distribution of an additive element.

FIG. 4 is a phase diagram showing a relationship between temperature and compositions of lithium fluoride and magnesium fluoride.

FIG. 5 is a diagram showing the result of DSC analysis.

FIG. 6 is an example of a TEM image showing crystal orientations substantially aligned with each other.

FIG. 7A is an example of a STEM image showing crystal orientations substantially aligned with each other. FIG. 7B is an FFT pattern of a region of a rock-salt crystal RS, and FIG. 7C is an FFT pattern of a region of a layered rock-salt crystal LRS.

FIG. 8 is a diagram illustrating crystal structures of a positive electrode active material.

FIG. 9 is a diagram illustrating crystal structures of a conventional positive electrode active material.

FIG. 10 is a diagram showing charge depths and lattice constants of a positive electrode active material.

FIG. 11 is a diagram showing XRD patterns calculated from crystal structures.

FIG. 12 is a diagram showing XRD patterns calculated from crystal structures.

FIG. 13A and FIG. 13B are diagrams showing XRD patterns calculated from crystal structures.

FIG. 14A to FIG. 14C are lattice constants calculated using XRD.

FIG. 15A to FIG. 15C are lattice constants calculated using XRD.

FIG. 16A and FIG. 16B are cross-sectional views of a positive electrode active material.

FIG. 17A to FIG. 17C are diagrams illustrating a method for forming a positive electrode active material.

FIG. 18 is a diagram illustrating a method for forming a positive electrode active material.

FIG. 19A to FIG. 19C are diagrams illustrating a method for forming a positive electrode active material.

FIG. 20 is a diagram illustrating the appearance of a secondary battery.

FIG. 21A to FIG. 21C are diagrams illustrating a method for manufacturing a secondary battery.

FIG. 22A to FIG. 22H are diagrams illustrating examples of electronic devices.

FIG. 23A to FIG. 23D are diagrams illustrating examples electronic devices.

FIG. 24A to FIG. 24C are diagrams illustrating examples electronic devices.

FIG. 25A to FIG. 25C are diagrams illustrating examples of vehicles.

FIG. 26 is a graph showing a temperature rise in a secondary battery.

FIG. 27A and FIG. 27B are diagrams illustrating a nail penetration test.

FIG. 28 is a graph showing a temperature rise in a secondary battery when an internal short-circuit occurs.

FIG. 29A and FIG. 29B are HAADF-STEM images of a positive electrode active material.

FIG. 30A and FIG. 30B are nanobeam electron diffraction patterns.

FIG. 31A and FIG. 31B are nanobeam electron diffraction patterns.

FIG. 32A and FIG. 32B are nanobeam electron diffraction patterns.

FIG. 33A is a HAADF-STEM image of a positive electrode active material, FIG. 33B is a cobalt mapping image, FIG. 33C is an oxygen mapping image, FIG. 33D is a magnesium mapping image, FIG. 33E is an aluminum mapping image, and FIG. 33F is a silicon mapping image.

FIG. 34A is a diagram showing a scanning method in STEM-EDX line analysis and FIG. 34B is a profile of the STEM-EDX line analysis.

FIG. 35 is an enlarged view of part of FIG. 34B.

FIG. 36 is a diagram selectively illustrating part of FIG. 35.

FIG. 37 is a diagram selectively illustrating part of FIG. 35.

FIG. 38A and FIG. 38B are HAADF-STEM images of a positive electrode active material.

FIG. 39A and FIG. 39B are nanobeam electron diffraction patterns.

FIG. 40A and FIG. 40B are nanobeam electron diffraction patterns.

FIG. 41A and FIG. 41B are nanobeam electron diffraction patterns.

FIG. 42A is a HAADF-STEM image of a positive electrode active material, FIG. 42B is a silicon mapping image, FIG. 42C is a cobalt mapping image, FIG. 42D is a magnesium mapping image, FIG. 42E is an aluminum mapping image, and FIG. 42F is a nickel mapping image.

FIG. 43A is a diagram showing a scanning method in STEM-EDX line analysis and FIG. 43B is a profile of the STEM-EDX line analysis.

FIG. 44 is an enlarged view of part of FIG. 43B.

FIG. 45 is a diagram selectively illustrating part of FIG. 44.

FIG. 46 is a diagram selectively illustrating part of FIG. 44.

FIG. 47 is a diagram selectively illustrating part of FIG. 44.

FIG. 48A and FIG. 48B are HAADF-STEM images.

FIG. 49 is an XRD pattern of a positive electrode active material after charging.

FIG. 50A and FIG. 50B are enlarged XRD patterns of part of FIG. 49.

FIG. 51 is an XRD pattern of a positive electrode active material after charging.

FIG. 52A and FIG. 52B are enlarged XRD patterns of part of FIG. 51.

FIG. 53A and FIG. 53B are diagrams illustrating a nail penetration test device.

FIG. 54A to FIG. 54C are diagrams showing the results of a nail penetration test.

FIG. 55A to FIG. 55C are diagrams showing the results of a nail penetration test.

FIG. 56 is a diagram showing the results of a DSC test.

### MODE FOR CARRYING OUT THE INVENTION

Examples of embodiments of the present invention will be described below with reference to the drawings and the like. Note that the present invention should not be interpreted as being limited to the examples of embodiments given below. Embodiments for carrying out the invention can be changed unless they deviate from the spirit of the present invention.

In this specification and the like, a space group is represented using the short notation of the international notation (or the Hermann-Mauguin notation). In addition, the Miller index is used for the expression of crystal planes and crystal orientations. In the crystallography, a bar is placed over a number in the expression of space groups, crystal planes, and crystal orientations; in this specification and the like, because of format limitations, space groups, crystal planes, and crystal orientations are sometimes expressed by placing “-” (a minus sign) in front of the number instead of placing a bar over the number. Furthermore, an individual direction which shows an orientation in a crystal is denoted with “[ ]”, a set direction which shows all of the equivalent orientations is denoted with “< >”, an individual plane which shows a crystal plane is denoted with “( )”, and a set plane having equivalent symmetry is denoted with “{ }”. A trigonal system represented by the space group R-3m is generally represented by a composite hexagonal lattice for easy understanding of the structure. In some cases, not only (hkl) but also (hkil) is used as the Miller index. Here, i is −(h+k). In this specification and the like, a crystal plane or the like in the space group R-3m is represented with use of a composite hexagonal lattice, unless otherwise specified.

In this specification and the like, particles are not necessarily spherical (with a circular cross section). Other examples of the cross-sectional shapes of particles include an ellipse, a rectangle, a trapezoid, a triangle, a quadrilateral with rounded corners, and an asymmetrical shape, and a particle may have an indefinite shape.

A theoretical capacity of a positive electrode active material refers to the amount of electricity obtained when all lithium that can be inserted and extracted and is contained in the positive electrode active material is extracted. For example, the theoretical capacity of LiCoO₂ is 274 mAh/g, the theoretical capacity of LiNiO₂ is 274 mAh/g, and the theoretical capacity of LiMn₂O₄ is 148 mA/g.

The remaining amount of lithium that can be inserted into and extracted from a positive electrode active material is represented by x in a compositional formula, e.g., LiₓCoO₂ or LiₓMO₂. In the case of a positive electrode active material in a secondary battery, x=(theoretical capacity−charge capacity)/theoretical capacity can be satisfied. For example, in the case where a secondary battery using LiCoO₂ as a positive electrode active material is charged to 219.2 mAh/g, it can be said that the positive electrode active material is represented by Li_{0.2}CoO₂ or x=0.2. Note that “x in LiₓCoO₂ is small” means, for example, 0.1<x≤0.24. The amount of lithium extracted from a positive electrode active material with respect to the theoretical capacity is sometimes referred to as a charge depth. In this specification and the like, a charge depth is 1-x.

Lithium cobalt oxide to be used for a positive electrode, which has been appropriately synthesized and almost satisfies the stoichiometric proportion, is LiCoO₂ with x=1. In a secondary battery after its discharging ends, it can be said that contained lithium cobalt oxide is also LiCoO₂ and x=1. Here, “discharging ends” means that a voltage becomes lower than or equal to 3.0 V or lower than or equal to 2.5 V at a current of 100 mA/g or lower, for example.

Charge capacity and/or discharge capacity used for calculation of x in LiₓCoO₂ is preferably measured under the condition where there is no influence or small influence of a short circuit and/or decomposition of an electrolyte solution or the like. For example, data of a secondary battery, suffering from a sudden change of capacity that seems to result from a short circuit, should not be used for calculation of x.

The space group of a crystal structure is identified by XRD, electron diffraction, neutron diffraction, or the like. Thus, in this specification and the like, belonging to a space group, being attributed to a space group, or being a space group can be rephrased as being identified as a space group.

Furthermore, when the arrangement of anions is close to a cubic close-packed structure, the arrangement can be regarded as the cubic close-packed structure. The arrangement of anions forming the cubic close-packed structure refers to a state where anions in a second layer are positioned right above voids between anions packed in a first layer, and anions in a third layer are placed at the positions that are positioned right above voids between the anions in the second layer and are not positioned right above the anions in the first layer. Accordingly, anions do not necessarily form a cubic lattice structure. In addition, actual crystals always have a defect and thus, analysis results are not necessarily consistent with the theory. For example, in an electron diffraction pattern or an FFT (fast Fourier transform) pattern of a TEM image or the like, a spot may appear in a position slightly different from a theoretical position. For example, anions may be regarded as forming a cubic close-packed structure when a difference in orientation from a theoretical position is less than or equal to 5° or less than or equal to 2.5°.

The distribution of an element indicates the region where the element is successively detected by a successive analysis method to the extent that the detection value is no longer on the noise level. The region where an element is successively detected to the extent that the detection value is no longer on the noise level can also be regarded as a region where the element is surely detected when the analysis is performed plural times.

A positive electrode active material to which an additive element is added is sometimes referred to as a composite oxide, a positive electrode member, a positive electrode material, a secondary battery positive electrode member, or the like. In this specification and the like, the positive electrode active material of one embodiment of the present invention preferably contains a compound. In this specification and the like, the positive electrode active material of one embodiment of the present invention preferably contains a composition. In this specification and the like, the positive electrode active material of one embodiment of the present invention preferably contains a composite.

In the case where the features of individual particles of a positive electrode active material are described in the following embodiment and the like, not all the particles necessarily have the features. When 50% or more, preferably 70% or more, further preferably 90% or more of three or more randomly selected particles of a positive electrode active material have the features, for example, it can be said that an effect of improving the characteristics of the positive electrode active material and a secondary battery including the positive electrode active material is sufficiently obtained.

The voltage of a positive electrode generally increases with increasing charge voltage of a secondary battery. The positive electrode active material of one embodiment of the present invention has a stable crystal structure even at a high voltage. The stable crystal structure of the positive electrode active material in a charged state can inhibit a charge and discharge capacity decrease due to repeated charging and discharging.

A short circuit of a secondary battery might cause not only a malfunction in charging operation and/or discharging operation of the secondary battery but also heat generation and ignition. In order to obtain a safe secondary battery, a short-circuit current is preferably inhibited even at a high charge voltage. In the positive electrode active material of one embodiment of the present invention, a short-circuit current is inhibited even at a high charge voltage. Thus, a secondary battery having a high discharge capacity and a high level of safety can be obtained.

In this specification and the like, ignition in a nail penetration test refers to a state where fire is observed outside an exterior body within one minute after nail penetration. In addition, the ignition refers to a state where thermal runway has occurred in a secondary battery. For example, when the temperature of a secondary battery exceeds 130° C., it can be said that thermal runaway has occurred. The temperature at this time can be measured with a temperature sensor attached to an exterior body of a secondary battery. In addition, a state where a solid thermal decomposition product of a positive electrode and/or a negative electrode is observed at a position more than or equal to 2 cm away from a penetration point after a nail penetration test is finished can also be referred to as ignition.

Note that the description is made on the assumption that materials (such as a positive electrode active material, a negative electrode active material, an electrolyte, and a separator) of a secondary battery have not deteriorated unless otherwise specified. A decrease in discharge capacity due to aging treatment and burn-in treatment during the manufacturing process of a secondary battery is not regarded as deterioration. For example, the case where discharge capacity is higher than or equal to 97% of the rated capacity of a lithium-ion secondary battery cell and an assembled lithium-ion secondary battery (hereinafter, referred to as a lithium-ion secondary battery) can be regarded as a non-deteriorated state. The rated capacity conforms to JIS C 8711:2019 in the case of a lithium-ion secondary battery for a portable device. The rated capacities of other lithium-ion secondary batteries conform to JIS described above, JIS for electric vehicle propulsion, industrial use, and the like, standards defined by IEC, and the like.

Note that in this specification and the like, in some cases, materials included in a secondary battery that have not deteriorated are referred to as initial products or materials in an initial state, and materials that have deteriorated (have discharge capacity lower than 97% of the rated capacity of the secondary battery) are referred to as products in use, materials in a used state, products that are already used, or materials in an already-used state.

### Embodiment 1

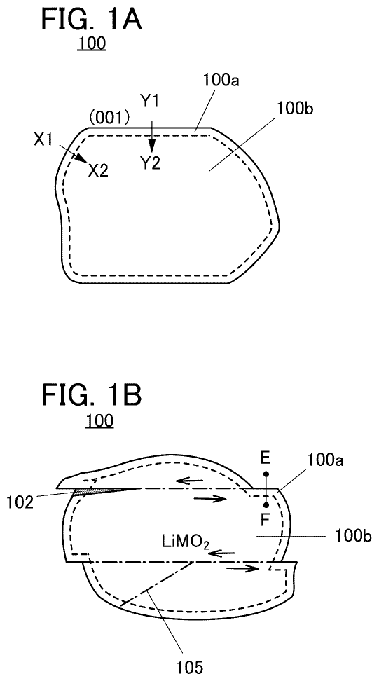

In this embodiment, a positive electrode active material 100 of one embodiment of the present invention is described with reference to FIG. 1 to FIG. 16.

FIG. 1A and FIG. 1B are each a cross-sectional view of the positive electrode active material 100 of one embodiment of the present invention. As illustrated in FIG. 1A, the positive electrode active material 100 includes a surface portion 100a and an inner portion 100b. In each drawing, the dashed line denotes a boundary between the surface portion 100a and the inner portion 100b. In FIG. 1B, the dashed-dotted line represents a part of a crystal grain boundary 105. FIG. 1B illustrates the positive electrode active material 100 including a filling portion 102. In the drawing, (001) refers to a (001) plane of lithium cobalt oxide. LiCoO₂ belongs to a space group R-3m.

In this specification and the like, the surface portion 100a of the positive electrode active material 100 refers to a region that is within 50 nm, preferably within 35 nm, further preferably within 20 nm in depth from the surface toward the inner portion, and most preferably a region positioned within 10 nm in depth from the surface toward the inner portion in a direction perpendicular or substantially perpendicular to the surface. Note that “substantially perpendicular” refers to a state where an angle is greater than or equal to 80° and less than or equal to 100°. A plane generated by a split and/or a crack can also be referred to as a surface. The surface portion 100a can be rephrased as the vicinity of a surface, a region in the vicinity of a surface, or a shell.

The inner portion 100b refers to a region deeper than the surface portion 100a of the positive electrode active material. The inner portion 100b can be rephrased as an inner region or a core.

A surface of the positive electrode active material 100 refers to a surface of a composite oxide including the surface portion 100a, the inner portion 100b, and the like. Thus, the positive electrode active material 100 does not contain a material to which a metal oxide that does not contain a lithium site contributing to charging and discharging, such as aluminum oxide (Al₂O₃), is attached, or a carbonate, a hydroxy group, or the like which is chemically adsorbed after formation of the positive electrode active material. The attached metal oxide refers to, for example, a metal oxide having a crystal structure different from that of the inner portion 100b.

Furthermore, an electrolyte, an organic solvent, a binder, a conductive material, and a compound originating from any of these that are attached to the positive electrode active material 100 are not contained either.

The crystal grain boundary 105 refers to, for example, a portion where particles of the positive electrode active material 100 adhere to each other or a portion where a crystal orientation changes inside the positive electrode active material 100, i.e., a portion where repetition of bright lines and dark lines is discontinuous in a STEM image or the like, a portion including a large number of crystal defects, a portion with a disordered crystal structure, or the like. A crystal defect refers to a defect that can be observed with a cross-sectional TEM (Transmission Electron Microscope) image, a cross-sectional STEM (Scanning Transmission Electron Microscope) image, or the like, i.e., a shift in the crystal structure, a structure where another atom enters a lattice, a cavity, or the like. The crystal grain boundary 105 can be regarded as one of plane defects. The vicinity of the crystal grain boundary 105 refers to a region within 10 nm from the crystal grain boundary 105.

### <Contained Element>

The positive electrode active material 100 contains lithium, cobalt, oxygen, and an additive element. Alternatively, the positive electrode active material 100 contains lithium cobalt oxide (LiCoO₂) to which an additive element is added. Note that the positive electrode active material 100 of one embodiment of the present invention has a crystal structure described later. Thus, the composition of the lithium cobalt oxide is not strictly limited to Li:Co:O=1:1:2.

A positive electrode active material of a lithium-ion secondary battery needs to contain a transition metal that can be oxidized and reduced. This is because the positive electrode active material needs to maintain charge neutrality even when lithium ions are inserted and extracted. It is preferable that the positive electrode active material 100 of one embodiment of the present invention mainly contain cobalt as the transition metal taking part in an oxidation-reduction reaction. In addition to cobalt, at least one or two selected from nickel and manganese may be used. When cobalt is used as the transition metal contained in the positive electrode active material 100 at higher than or equal to 75 at %, preferably higher than or equal to 90 at %, further preferably higher than or equal to 95 at %, synthesis and handling of a positive electrode active material become relatively easy. Moreover, a secondary battery using the positive electrode active material has many advantages such as excellent cycle performance, which is preferable.

When cobalt is used as the transition metal contained in the positive electrode active material 100 at higher than or equal to 75 at %, preferably higher than or equal to 90 at %, further preferably higher than or equal to 95 at %, LiₓCoO₂ with small x is more stable than a composite oxide in which nickel accounts for the majority of the transition metal, such as lithium nickel oxide (LiNiO₂). This is probably because the influence of distortion by the Jahn-Teller effect is smaller in the case of using cobalt than in the case of using nickel. The Jahn-Teller effect in a transition metal compound varies in degree according to the number of electrons in the d orbital of the transition metal. The influence of the Jahn-Teller effect is large in a composite oxide having a layered rock-salt crystal structure, such as lithium nickel oxide, in which octahedral coordinated low-spin nickel (III) accounts for the majority of the transition metal, and a layer having an octahedral structure formed of nickel and oxygen is likely to be distorted. Thus, there is a concern that the crystal structure might break in charge and discharge cycles. The size of a nickel ion is larger than the size of a cobalt ion and close to that of a lithium ion. Thus, there is a problem in that cation mixing between nickel and lithium is likely to occur in a composite oxide having a layered rock-salt crystal structure in which nickel accounts for the majority of the transition metal, such as lithium nickel oxide.

As the additive element contained in the positive electrode active material 100, one or two or more selected from magnesium, fluorine, nickel, aluminum, titanium, zirconium, vanadium, iron, manganese, chromium, niobium, arsenic, zinc, silicon, sulfur, phosphorus, boron, bromine, and beryllium is preferably used. The total percentage of the transition metal among the additive elements is preferably less than 25 at %, further preferably less than 10 at %, still further preferably less than 5 at %.

That is, the positive electrode active material 100 can contain lithium cobalt oxide to which magnesium and fluorine are added, lithium cobalt oxide to which magnesium, fluorine, and titanium are added, lithium cobalt oxide to which magnesium, fluorine, and aluminum are added, lithium cobalt oxide to which magnesium, fluorine, and nickel are added, lithium cobalt oxide to which magnesium, fluorine, nickel, and aluminum are added, or the like.

The additive element preferably forms a solid solution with the positive electrode active material 100. Thus, in STEM-energy dispersive X-ray spectroscopy (EDX) line analysis, for example, a position where the amount of the detected additive element increases is preferably at a deeper level than a position where the amount of the detected transition metal M increases, i.e., on the inner portion side of the positive electrode active material 100.

In this specification and the like, the depth at which the amount of detected element increases in STEM-EDX line analysis refers to the depth at which a measured value, which can be determined not to be a noise in terms of intensity, spatial resolution, and the like, is successively obtained.

As described later, such an additive element further stabilizes a crystal structure of the positive electrode active material 100. In this specification and the like, the additive element can be rephrased as a mixture or part of a raw material.

Note that as the additive element, magnesium, fluorine, nickel, aluminum, titanium, zirconium, vanadium, iron, manganese, chromium, niobium, arsenic, zinc, silicon, sulfur, phosphorus, boron, bromine, or beryllium is not necessarily contained.

For example, when the positive electrode active material 100 is substantially free from manganese, the above advantages such as relatively easy synthesis, easy handling, and excellent cycle performance are sometimes enhanced. The weight of manganese contained in the positive electrode active material 100 is preferably less than or equal to 600 ppm, further preferably less than or equal to 100 ppm, for example.

<<x in LiₓCoO₂ being 1>>

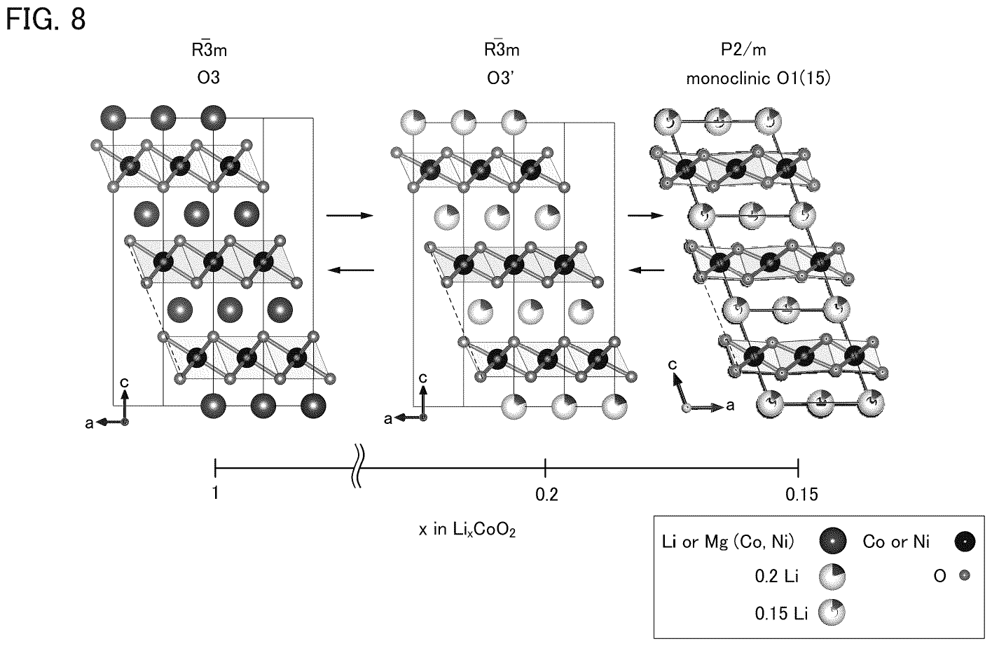

The positive electrode active material 100 of one embodiment of the present invention preferably has a layered rock-salt crystal structure belonging to the space group R-3m in a discharged state, i.e., a state where x in LiₓCoO₂ is 1. A composite oxide having a layered rock-salt structure excels as a positive electrode active material of a secondary battery because it has high discharge capacity and a two-dimensional diffusion path for lithium ions and is thus suitable for an insertion/extraction reaction of lithium ions. For this reason, it is particularly preferable that the inner portion 100b, which accounts for the majority of the volume of the positive electrode active material 100, have a layered rock-salt crystal structure. In FIG. 8, the layered rock-salt crystal structure denoted by R-3m O3 is shown. In the R-3m O3-type structure, the lattice constants are as follows: a=2.81610, b=2.81610, c=14.05360, α=90.0000, β=90.0000, and Y=120.0000; the coordinates of lithium, cobalt, and oxygen in a unit cell are represented by Li (0, 0, 0), Co (0, 0, 0.5), and O (0, 0, 0.23951), respectively (Non-Patent Document 6).

Meanwhile, the surface portion 100a of the positive electrode active material 100 of one embodiment of the present invention preferably has a function of reinforcing the layered structure, which is formed of octahedrons of cobalt and oxygen, of the inner portion 100b so that the layered structure does not break even when lithium is extracted from the positive electrode active material 100 by charge. Alternatively, the surface portion 100a preferably functions as a barrier film of the positive electrode active material 100. Alternatively, the surface portion 100a, which is the outer portion of the positive electrode active material 100, preferably reinforces the positive electrode active material 100. Here, the term “reinforce” means inhibiting extraction of oxygen and/or a structural change of the surface portion 100a and the inner portion 100b of the positive electrode active material 100 such as a shift in the layered structure formed of octahedrons of cobalt and oxygen. In addition or alternatively, the term “reinforce” means inhibiting oxidative decomposition of an electrolyte on the surface of the positive electrode active material 100.

Accordingly, the surface portion 100a preferably has a crystal structure different from that of the inner portion 100b. The surface portion 100a preferably has a more stable composition and a more stable crystal structure than those of the inner portion 100b at room temperature (e.g., 25° C.). For example, at least part of the surface portion 100a of the positive electrode active material 100 of one embodiment of the present invention preferably has the rock-salt crystal structure. Alternatively, the surface portion 100a preferably has both a layered rock-salt crystal structure and a rock-salt crystal structure. Alternatively, the surface portion 100a preferably has features of both a layered rock-salt crystal structure and a rock-salt crystal structure.

The surface portion 100a is a region from which lithium ions are extracted initially in charging, and is a region that tends to have a lower concentration of lithium than the inner portion 100b. It can be said that bonds between atoms are partly cut on the surface of the particle of the positive electrode active material 100 included in the surface portion 100a. Thus, the surface portion 100a is regarded as a region that tends to be unstable and easily starts deterioration of the crystal structure. For example, it is presumable that a shift in the crystal structure of the layered structure formed of octahedrons of cobalt and oxygen in the surface portion 100a has an influence on the inner portion 100b to cause a shift in the crystal structure of the layered structure in the inner portion 100b, leading to degradation of the crystal structure in the whole positive electrode active material 100. Meanwhile, when the surface portion 100a can be made sufficiently stable, the layered structure, which is formed of octahedrons of cobalt and oxygen, of the inner portion 100b is unlikely to break even with small x in LiₓCoO₂, e.g., with x of 0.24 or less. Furthermore, a shift in layers, which are formed of octahedrons of cobalt and oxygen, of the inner portion 100b can be inhibited.

### [Distribution]

In order that the surface portion 100a can have a stable composition and a stable crystal structure, the surface portion 100a preferably contains an additive element, further preferably contains a plurality of additive elements. The surface portion 100a preferably has a higher concentration of one or two or more selected from the additive elements than the inner portion 100b. The one or two or more selected from the additive elements contained in the positive electrode active material 100 preferably have a concentration gradient. It is further preferable that the additive elements contained in the positive electrode active material 100 be differently distributed. For example, it is further preferable that peaks of the detected amounts of the additive elements in the surface portion be exhibited at different depths from the surface or the reference point in EDX line analysis described later. The peak of the detected amount here refers to the local maximum value of the detected amount in the surface portion 100a or a region ranging from the surface to 50 nm or less. The detected amount refers to counts in EDX line analysis, for example.

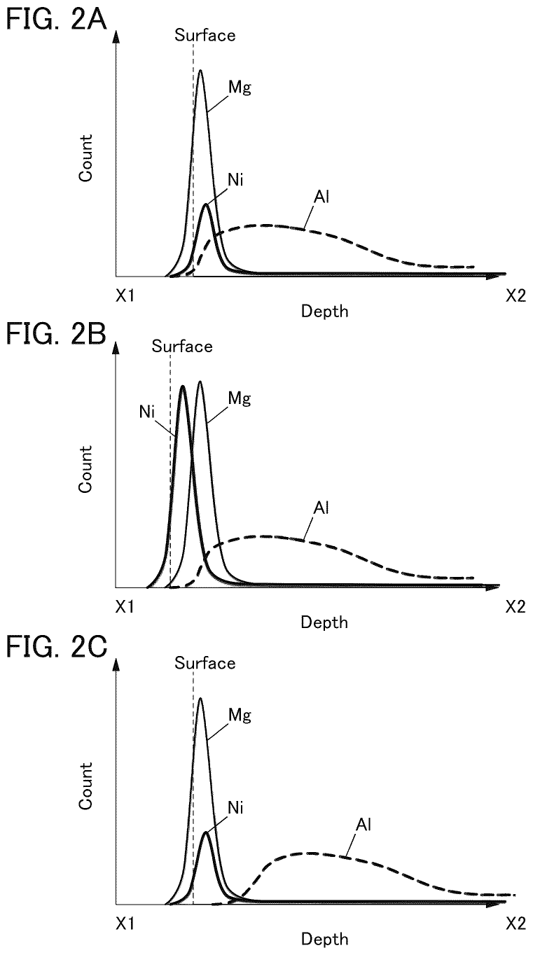

The arrow X1-X2 is shown in FIG. 1A as a depth direction example of a crystal plane, which is not the (001) plane, of lithium cobalt oxide of the positive electrode active material 100 of one embodiment of the present invention. FIG. 2A to FIG. 2C show examples of an additive element profile in the case where the EDX line analysis is performed along the arrow X1-X2.

As shown in FIG. 2A to FIG. 2C, it is preferable that at least magnesium and nickel among the added elements have a larger detection amount in the surface portion 100a than in the inner portion 100b. Furthermore, it is preferable that in the surface portion 100a, there be a peak of detected amount concentrated in a region closer to the surface. For example, the detected amounts preferably have peaks within 3 nm from the surface or a reference point. The distribution of magnesium and that of nickel preferably overlap with each other. The peak of the detected amount of magnesium and that of the detected amount of nickel are at the same depth, the peak of magnesium may be closer to the surface, or the peak of nickel may be closer to the surface as shown in FIG. 2B. The difference in depth between the peak of the detected amount of nickel and the peak of the detected amount of magnesium is preferably less than or equal to 3 nm, further preferably less than or equal to 1 nm.

In some cases, the detected amount of nickel in the inner portion 100b is much smaller than that of nickel in the surface portion 100a or lower than or equal to 1 at %, or no nickel is detected in the inner portion 100b.

Although not illustrated in the drawing, as in the case of magnesium or nickel, the detected amount of fluorine is preferably larger in the surface portion 100a than in the inner portion. A peak of the detected amount of fluorine is preferably located in a region of the surface portion 100a that is closer to the surface. For example, the detected amount preferably has the peak within 3 nm from the surface or a reference point. Similarly, the detected amounts of titanium, silicon, phosphorus, boron, and/or calcium are/is also preferably larger in the surface portion 100a than in the inner portion. The peaks of the detected amounts are preferably located in a region of the surface portion 100a that is closer to the surface. For example, the detected amounts preferably have the peaks within 3 nm from the surface or a reference point.

At least aluminum among the additive elements preferably has a peak of the detected amount deeper inside than magnesium. The distribution of magnesium and that of aluminum may overlap with each other as shown in FIG. 2A; alternatively, there may be almost no overlap between the distribution of magnesium and that of aluminum as shown in FIG. 2C. The peak of the detected amount of aluminum may be located in the surface portion 100a or located deeper than the surface portion 100a. For example, the peak is preferably located in a region ranging from the surface or the reference point to a depth of from 5 nm to 30 nm, both inclusive, toward the inner portion.

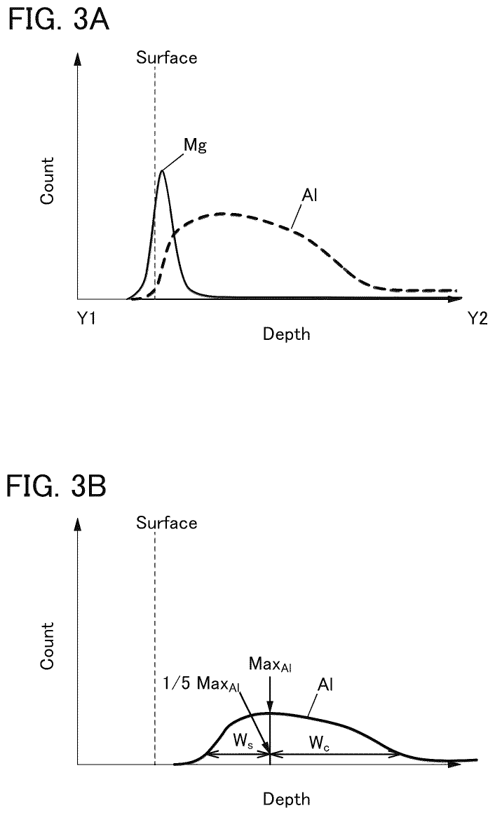

The distribution of aluminum is not normal distribution in some cases. For example, when the distribution of aluminum is divided by the maximum value Max_{Al}, the length of the tail on the surface side is sometimes different from that of the tail on the inner portion side. More specifically, when the peak width at the height (⅕ Max_{Al}) that is ⅕ of the height of the maximum value (Max_{Al}) of the detected amount of aluminum is divided into two parts by a perpendicular extending from the maximum value to the horizontal axis, the peak width W_{c} on the inner portion side is sometimes larger than the peak width Wₛ on the surface side as shown in FIG. 3B.

Aluminum is distributed more inwardly than magnesium as described above probably because the diffusion rate of aluminum is higher than that of magnesium. On the other hand, the detected amount of aluminum is small in the region that is the closest to the surface. This is presumably because aluminum can stay stably in a region other than a region where magnesium or the like at a high concentration forms a solid solution.

To be specific, in a region having a layered rock-salt crystal structure belonging to the space group R-3m or a cubic rock-salt crystal structure, the distance between a cation and oxygen in a region where magnesium at a high concentration forms a solid solution is longer than the distance between a cation and oxygen in LiAlO₂ having a layered rock-salt crystal structure, and aluminum is thus likely to be unstable. In the vicinity of cobalt, valence change due to replacement of Li⁺ with Mg²⁺ can be offset by Co²⁺ which is changed from Co³⁺, so that cation balance can be maintained. By contrast, Al is always trivalent and is thus presumed to be unlikely to coexist with magnesium in a rock-salt or layered rock-salt crystal structure.

Although not illustrated, as in the case of aluminum, manganese preferably has a peak of the detected amount deeper inside than magnesium.

Note that the additive elements do not necessarily have similar concentration gradients and similar distributions throughout the surface portion 100a of the positive electrode active material 100. The arrow Y1-Y2 is shown in FIG. 1 as a depth direction example of the (001) plane of lithium cobalt oxide of the positive electrode active material 100. FIG. 3A shows an example of an additive element profile on the arrow Y1-Y2.

The distribution of the additive element at the surface having a (001) orientation may be different from that at other surfaces. For example, the surface having a (001) orientation and the surface portion 100a thereof may have a lower detected amount of one or two or more elements selected from the additive elements than a surface having an orientation other than a (001) orientation. Specifically, the detected amount of nickel may be smaller. Alternatively, at the surface having a (001) orientation and the surface portion 100a thereof, one or two or more selected from the additive elements may be detected at 1 at % or less, or may not be detected. Specifically, nickel may be detected at 1 at % or less, or may not be detected. Especially in the case of EDX or any other analysis method by which characteristic X-rays are detected, the energy of KB for cobalt is close to that of Kα for nickel and it is thus difficult to detect a slight amount of nickel in a material whose main element is cobalt. At the surface having a (001) orientation and the surface portion 100a thereof, the peaks of the detected amounts of one or two or more selected from the additive elements may be located shallow from the surface as compared with the surface having an orientation other than a (001) orientation. Specifically, the peaks of the detected amounts of magnesium and aluminum may be located at positions shallower from the surface than the peaks of the detected amounts of magnesium and aluminum at other surface.

In a layered rock-salt crystal structure belonging to R-3m, cations are arranged parallel to the (001) plane. In other words, CoO₂ layers and lithium layers are alternately stacked parallel to the (001) plane. Accordingly, a diffusion path of lithium ions also exists parallel to the (001) plane.

The CoO₂ layer is relatively stable and thus, the surface of the positive electrode active material 100 is more stable when having a (001) orientation. A main diffusion path of lithium ions in charging and discharging is not exposed at the (001) plane.

By contrast, a diffusion path of lithium ions is exposed at the surface having an orientation other than a (001) orientation. Thus, the surface having an orientation other than a (001) orientation and the surface portion 100a thereof easily lose stability because they are regions where extraction of lithium ions starts as well as important regions for maintaining a diffusion path of lithium ions. It is thus extremely important to reinforce the surface having an orientation other than a (001) orientation and the surface portion 100a thereof so that the crystal structure of the whole the positive electrode active material 100 is maintained.

Accordingly, in the positive electrode active material 100 of another embodiment of the present invention, it is important that the additive element profile at the surface having an orientation other than a (001) orientation and the surface portion 100a thereof is distribution in any one of FIG. 2A to FIG. 2C. In particular, among the additive elements, nickel is preferably detected at the surface having an orientation other than a (001) orientation and the surface portion 100a thereof. By contrast, in the surface having a (001) orientation and the surface portion 100a thereof, the concentration of the additive element may be low as described above or the additive element may be absent.

For example, the half width of the distribution of magnesium at the surface having a (001) orientation and the surface portion 100a thereof is preferably greater than or equal to 10 nm and less than or equal to 200 nm, further preferably greater than or equal to 50 nm and less than or equal to 150 nm, still further preferably greater than or equal to 80 nm and less than or equal to 120 nm. The half width of the distribution of magnesium at the surface having an orientation other than a (001) orientation and the surface portion 100a thereof is preferably greater than 200 nm and less than or equal to 500 nm, further preferably greater than 200 nm and less than or equal to 300 nm, still further preferably greater than or equal to 230 nm and less than or equal to 270 nm.

The half width of the distribution of nickel at the surface having an orientation other than a (001) orientation and the surface portion 100a thereof is preferably greater than or equal to 30 nm and less than or equal to 150 nm, further preferably greater than or equal to 50 nm and less than or equal to 130 nm, still further preferably greater than or equal to 70 nm and less than or equal to 110 nm.

In the formation method, as described in the following embodiment, in which high-purity LiCoO₂ is formed, the additive element is mixed afterwards, and heating is performed, the additive element spreads mainly through a diffusion path of lithium ions. Thus, distribution of the additive element at the surface having an orientation other than a (001) orientation and the surface portion 100a thereof can easily fall within a preferred range.

### [Magnesium]

Magnesium is divalent, and a magnesium ion is more stable in lithium sites than in cobalt sites in a layered rock-salt crystal structure; thus, magnesium is likely to enter the lithium sites. An appropriate concentration of magnesium in the lithium sites of the surface portion 100a has an effect of inhibiting contraction in the c-axis direction even though force of expansion and contraction in the c-axis direction acts due to the insertion and extraction of lithium ions. In addition, the layered rock-salt crystal structure can be easily maintained. This is probably because magnesium in the lithium sites serves as a column supporting the CoO₂ layers. Moreover, magnesium can inhibit extraction of oxygen therearound in a state where x in LiₓCoO₂ is, for example, 0.24 or less. Magnesium is also expected to increase the density of the positive electrode active material 100. In addition, a high concentration of magnesium in the surface portion 100a can be expected to increase the corrosion resistance to hydrofluoric acid generated by the decomposition of an electrolyte solution.

An appropriate concentration of magnesium does not have an adverse effect on insertion and extraction of lithium in charging and discharging, and the above-described advantages can be obtained. However, excess magnesium might adversely affect insertion and extraction of lithium. Furthermore, the effect of stabilizing the crystal structure might be reduced. This is probably because magnesium enters the cobalt sites in addition to the lithium sites. Moreover, an undesired magnesium compound (e.g., an oxide and a fluoride) which is substituted for neither the lithium site nor the cobalt site might segregate at the surface of the positive electrode active material or the like to serve as a resistance component of a secondary battery. As the concentration of magnesium in the positive electrode active material increases, the discharge capacity of the positive electrode active material decreases in some cases. This is probably because excess magnesium enters the lithium sites and the amount of lithium contributing to charging and discharging decreases.

Thus, the entire positive electrode active material 100 preferably contains an appropriate amount of magnesium. For example, the number of magnesium atoms is preferably greater than or equal to 0.002 times and less than or equal to 0.06 times, further preferably greater than 0.005 times and less than or equal to 0.03 times, still further preferably approximately 0.01 times the number of cobalt atoms. The amount of magnesium contained in the entire positive electrode active material 100 here may be a value obtained by element analysis on the entire positive electrode active material 100 using GD-MS, ICP-MS, or the like, or may be a value based on the ratio of the raw materials mixed in the formation process of the positive electrode active material 100, for example.

### [Nickel]

Nickel in a layered rock-salt crystal structure of LiMeO₂ can exist in both the cobalt site and the lithium site. Since nickel has a lower oxidation-reduction potential than cobalt, when nickel exists in the cobalt site, lithium and electrons can be regarded as being easily released during charging, for example. As a result, the charge and discharge speed is expected to be increased. Accordingly, even at the same charge voltage, higher charge and discharge capacity can be obtained in the case where the transition metal M is nickel than in the case where the transition metal M is cobalt.

In addition, when nickel exists in lithium sites, a shift in the layered structure formed of octahedrons of cobalt and oxygen can be inhibited. Moreover, a change in volume in charge and discharge is inhibited. Furthermore, an elastic becomes large, i.e., hardness increases. This is probably because nickel in the lithium sites serves as a column supporting the CoO₂ layers. Thus, in particular, the crystal structure is expected to be more stable in a charged state at high temperatures, e.g., 45° C. or higher, which is preferable.

The distance between a cation and an anion of nickel oxide (NiO) is closer to the average of the distance between a cation and an anion of LiCoO₂ than those of MgO having a rock-salt crystal structure and CoO having a rock-salt crystal structure, and the orientations of NiO and LiCoO₂ are likely to be aligned with each other.

Ionization tendency increases in the order of magnesium, aluminum, cobalt, and nickel. Therefore, it is considered that in charging, nickel is less likely to be dissolved into an electrolyte solution than the other elements described above. Accordingly, nickel is considered to have a high effect of stabilizing the crystal structure of the surface portion in a charged state.

Furthermore, in nickel, Ni²⁺ is the most stable among Ni²⁺, Ni³⁺, and Ni⁴⁺, and nickel has higher trivalent ionization energy than cobalt. Thus, it is known that a spinel crystal structure does not appear only with nickel and oxygen. Therefore, nickel can be considered to have an effect of inhibiting a phase change from a layered rock-salt crystal structure to a spinel crystal structure.

Meanwhile, excess nickel increases the influence of distortion due to the Jahn-Teller effect, which is not preferable. Moreover, excess nickel might adversely affect insertion and extraction of lithium.

Thus, the entire positive electrode active material 100 preferably contains an appropriate amount of nickel. For example, in the positive electrode active material 100, the number of nickel atoms is preferably greater than 0% and less than or equal to 7.5%, further preferably greater than or equal to 0.05% and less than or equal to 4%, still further preferably greater than or equal to 0.1% and less than or equal to 2%, yet still further preferably greater than or equal to 0.2% and less than or equal to 1% of the number of cobalt atoms. Alternatively, it is preferably greater than 0% and less than or equal to 4%. Alternatively, it is preferably greater than 0% and less than or equal to 2%. Alternatively, it is preferably greater than or equal to 0.05% and less than or equal to 7.5%. Alternatively, it is preferably greater than or equal to 0.05% and less than or equal to 2%. Alternatively, it is preferably greater than or equal to 0.1% and less than or equal to 7.5%. Alternatively, it is preferably greater than or equal to 0.1% and less than or equal to 4%. The amount of nickel described here may be a value obtained by element analysis on the entire positive electrode active material by GD-MS, ICP-MS, or the like, or may be a value based on the ratio of the raw materials mixed in the process of forming the positive electrode active material, for example.

### [Aluminum]

Aluminum can exist in a cobalt site in a layered rock-salt crystal structure. Since aluminum is a trivalent representative element and its valence does not change, lithium around aluminum is unlikely to move even in charging and discharging. Thus, aluminum and lithium therearound serve as columns to inhibit a change in the crystal structure. Thus, as described later, aluminum has an effect of keeping the c-axis length even though force of expansion and contraction in the c-axis direction acts on the positive electrode active material 100 due to the insertion and extraction of lithium ions. Therefore, the deterioration of the positive electrode active material 100 can be inhibited.

Furthermore, aluminum has effects of inhibiting dissolution of cobalt around aluminum and improving continuous charge tolerance. Moreover, an Al—O bond is stronger than a Co—O bond; thus, extraction of oxygen around aluminum can be inhibited. These effects improve thermal stability. Hence, a secondary battery including the positive electrode active material 100 containing aluminum as the additive element can have improved safety. Furthermore, the positive electrode active material 100 can have a crystal structure that is unlikely to be broken by repeated charging and discharging.

Meanwhile, excess aluminum might adversely affect insertion and extraction of lithium.

Thus, the entire positive electrode active material 100 preferably contains an appropriate amount of aluminum. For example, in the entire positive electrode active material 100, the number of aluminum atoms is preferably greater than or equal to 0.05% and less than or equal to 4%, further preferably greater than or equal to 0.1% and less than or equal to 2%, still further preferably greater than or equal to 0.3% and less than or equal to 1.5% of the number of cobalt atoms. Alternatively, it is preferably greater than or equal to 0.05% and less than or equal to 2%. Alternatively, it is preferably greater than or equal to 0.1% and less than or equal to 4%. Here, the amount of aluminum contained in the entire positive electrode active material 100 may be a value obtained by element analysis on the entire positive electrode active material 100 with GD-MS, ICP-MS, or the like or may be a value based on the ratio of the raw materials mixed in the process of forming the positive electrode active material 100, for example.

### [Fluorine]

When fluorine, which is a monovalent anion, is substituted for part of oxygen in the surface portion 100a, the lithium extraction energy is lowered. This is because the oxidation-reduction potential of cobalt ions associated with lithium extraction differs depending on the presence or absence of fluorine. That is, when fluorine is not included, cobalt ions change from a trivalent state to a tetravalent state owing to lithium extraction. Meanwhile, when fluorine is included, cobalt ions change from a divalent state to a trivalent state owing to lithium extraction. The oxidation-reduction potential of cobalt ions differs between these cases. It can thus be said that when fluorine is substituted for part of oxygen in the surface portion 100a of the positive electrode active material 100, lithium ions in the vicinity of fluorine are likely to be extracted and inserted smoothly. Thus, a secondary battery including the positive electrode active material 100 can have improved charge and discharge characteristics, improved large current characteristics, or the like. When fluorine exists at the surface portion 100a including the surface that is in contact with an electrolyte solution, or when a fluoride is attached to the surface, an overreaction between the positive electrode active material 100 and the electrolyte solution can be inhibited. In addition, the corrosion resistance to hydrofluoric acid can be effectively increased.

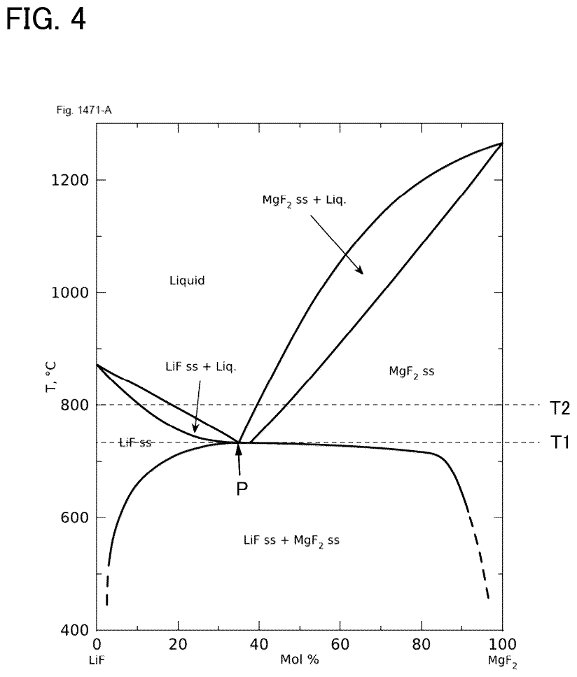

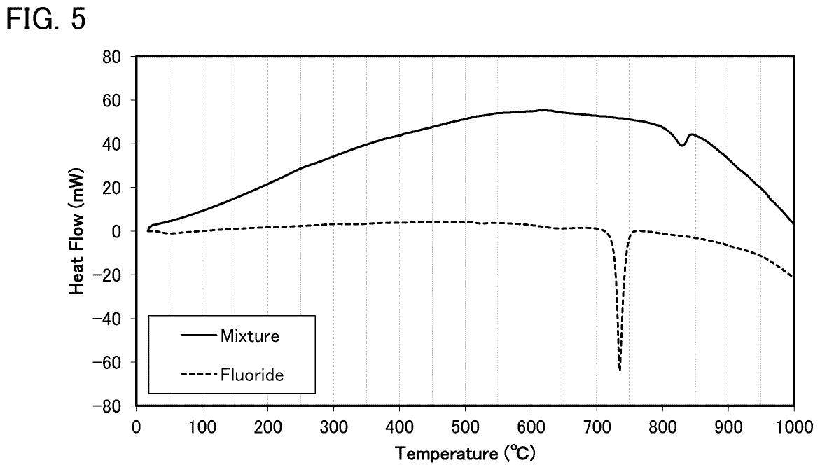

In the case where a fluoride such as lithium fluoride has a lower melting point than the other additive element sources, the fluoride can serve as a fusing agent (also referred to as a flux agent) for lowering the melting points of the other additive element sources. In the case where the fluoride contains LiF and MgF₂, as shown in FIG. 4 (which is cited from FIG. 5 of Non-Patent Document 13 and retouched, and Liquid in the drawing means a liquid phase), since the eutectic point P of LiF and MgF₂ is around 742° C. (T1), the heating temperature in the heating step after the mixing of the additive element is preferably higher than or equal to 742° C.

Here, the differential scanning calorimetry measurement (DSC measurement) of the fluoride and the mixture is described with reference to FIG. 5. In FIG. 5, the vertical axis represents heat flow and the horizontal axis represents temperature. The fluoride in FIG. 5 is a mixture of LiF and MgF₂. LiF and MgF₂ were mixed in a molar ratio of LiF:MgF₂=1:3 (molar ratio). The mixture in FIG. 5 is obtained by mixing of lithium cobalt oxide as the lithium oxide and LiF and MgF₂ as the fluoride. LiCoO₂, LiF, and MgF₂ are mixed in a molar ratio of LiCoO₂:LiF:MgF₂=100:0.33:1 (molar ratio).

As shown in FIG. 5, the endothermic peak of the fluoride is observed around 735° C. In addition, the endothermic peak of the mixture is observed around 830° C. Thus, the temperature of the heating following the mixing of the additive element is preferably higher than or equal to 742° C., further preferably higher than or equal to 830° C. Alternatively, the temperature of the heating may be higher than or equal to 800° C. (T2 in FIG. 4), which is between the above temperatures.

Note that the effect of the fusing agent, i.e., the fluoride in the heating step is extremely strong; however, the effect of the fluoride in the secondary battery is limited. Thus, there is no problem even though at least part of the fluoride has been evaporated when the heating step ends. That is, the amount of fluorine remaining in the completed positive electrode active material 100 is slight in some cases and is too slight to be detected in some cases.

### [Other Additive Elements]

A titanium oxide is known to have superhydrophilicity. Accordingly, the positive electrode active material 100 that contains titanium oxide in the surface portion 100a presumably has good wettability with respect to a high-polarity solvent. In a secondary battery formed using this positive electrode active material 100, the positive electrode active material 100 and a high-polarity electrolyte solution can have favorable contact at the interface therebetween, which may inhibit an internal resistance increase.

When the surface portion 100a contains phosphorus, a short circuit can be inhibited while a state with small x in LiₓCoO₂ is maintained, in some cases, which is preferable. For example, a compound containing phosphorus and oxygen preferably exists in the surface portion 100a.

When the positive electrode active material 100 contains phosphorus, phosphorus may react with hydrogen fluoride generated by the decomposition of the electrolyte solution or the electrolyte, which can decrease the concentration of hydrogen fluoride in the electrolyte and is thus preferable.

In the case where the electrolyte contains LiPF₆, hydrogen fluoride might be generated by hydrolysis. In addition, hydrogen fluoride might be generated by the reaction of polyvinylidene fluoride (PVDF) used as a component of the positive electrode and alkali. The decrease in the hydrogen fluoride concentration in the electrolyte can inhibit corrosion of a current collector and/or separation of a coating portion 104 in some cases. Furthermore, a reduction in adhesion properties due to gelling and/or insolubilization of PVDF can be inhibited in some cases.

The positive electrode active material 100 preferably contains magnesium and phosphorus, in which case the stability in a state with small x in LiₓCoO₂ is extremely high. In the case where the positive electrode active material 100 contains phosphorus, the number of phosphorus atoms is preferably greater than or equal to 1% and less than or equal to 20%, further preferably greater than or equal to 2% and less than or equal to 10%, still further preferably greater than or equal to 3% and less than or equal to 8% of the number of cobalt atoms. Alternatively, it is preferably greater than or equal to 1% and less than or equal to 10%. Alternatively, it is preferably greater than or equal to 1% and less than or equal to 8%. Alternatively, it is preferably greater than or equal to 2% and less than or equal to 20%. Alternatively, it is preferably greater than or equal to 2% and less than or equal to 8%. Alternatively, it is preferably greater than or equal to 3% and less than or equal to 20%. Alternatively, it is preferably greater than or equal to 3% and less than or equal to 10%. In addition, the number of magnesium atoms is preferably greater than or equal to 0.1% and less than or equal to 10%, further preferably greater than or equal to 0.5% and less than or equal to 5%, still further preferably greater than or equal to 0.7% and less than or equal to 4% of the number of cobalt atoms. Alternatively, it is preferably greater than or equal to 0.1% and less than or equal to 5%. Alternatively, it is preferably greater than or equal to 0.1% and less than or equal to 4%. Alternatively, it is preferably greater than or equal to 0.5% and less than or equal to 10%. Alternatively, it is preferably greater than or equal to 0.5% and less than or equal to 4%. Alternatively, it is preferably greater than or equal to 0.7% and less than or equal to 10%. Alternatively, it is preferably greater than or equal to 0.7% and less than or equal to 5%. The concentrations of phosphorus and magnesium described here may each be a value obtained by element analysis on the entire positive electrode active material 100 by GD-MS, ICP-MS, or the like, or may be a value based on the ratio of the raw materials mixed in the formation process of the positive electrode active material 100, for example.

In the case where the positive electrode active material 100 has a crack, crack development can be inhibited by phosphorus, more specifically, a compound containing phosphorus and oxygen, for example, being in the inner portion of the positive electrode active material having the crack on its surface, e.g., the filling portion 102.

### [Synergistic Effect Between a Plurality of Additive Elements]

When the surface portion 100a contains both magnesium and nickel, divalent nickel can exist more stably in the vicinity of divalent magnesium. Thus, dissolution of magnesium might be inhibited even when x in LiₓCoO₂ is small. This can contribute to stabilization of the surface portion 100a.

For a similar reason, when the additive element is added to lithium cobalt oxide in the formation process, magnesium is preferably added in a step before addition of nickel. Alternatively, magnesium and nickel are preferably added in the same step. While magnesium has a large ion radius and thus is likely to remain in the surface portion of lithium cobalt oxide regardless of in which step magnesium is added, nickel may be widely diffused to the inner portion of lithium cobalt oxide when magnesium is absent. Thus, when nickel is added before magnesium is added, nickel might be diffused to the inner portion of lithium cobalt oxide and a preferable amount of nickel might not remain in the surface portion.

Additive elements that are differently distributed are preferably contained at a time, in which case the crystal structure in a wider region can be stabilized. For example, the stable crystal structure can be obtained in a wider region in the case where the positive electrode active material 100 contains, in the surface portion 100a, magnesium and nickel distributed in a region closer to the surface and aluminum distributed in a region deeper than magnesium and nickel, than in the case where only one or two of the additive elements are contained. In the case where the positive electrode active material 100 contains the additive elements that are differently distributed as described above, the surface can be sufficiently stabilized by magnesium, nickel, or the like; thus, aluminum is not necessary for the surface. It is preferable that aluminum be widely distributed in a deeper region. For example, it is preferable that aluminum be continuously detected in a region ranging from the surface to a depth of from 1 nm to 25 nm, both inclusive. Aluminum is preferably widely distributed in a region ranging from the surface to a depth of from 0 nm to 100 nm, both inclusive, further preferably a region ranging from the surface to a depth of from 0.5 nm to 50 nm, both inclusive, in which case the crystal structure of a wider region can be stabilized.

When a plurality of the additive elements are contained as described above, the effects of the additive elements contribute synergistically to further stabilization of the surface portion 100a. In particular, magnesium, nickel, and aluminum are preferably contained, in which case a high effect of stabilizing the composition and the crystal structure can be obtained.

Note that the surface portion 100a occupied by only a compound of an additive element and oxygen is not preferable because this surface portion 100a would make insertion and extraction of lithium difficult. For example, it is not preferable that the surface portion 100a be occupied by only MgO, a structure in which MgO and NiO(II) form a solid solution, and/or a structure in which MgO and CoO(II) form a solid solution. Thus, the surface portion 100a should contain at least cobalt, also contain lithium in a discharged state, and have the path through which lithium is inserted and extracted.

To ensure the sufficient path through which lithium is inserted and extracted, the concentration of cobalt is preferably higher than that of magnesium in the surface portion 100a. For example, when measurement by XPS is performed from the surface of the positive electrode active material 100, Mg/Co, which is the ratio of the number of magnesium atoms Mg to the number of cobalt atoms Co is preferably less than or equal to 0.62. Alternatively, the concentration of cobalt is preferably higher than that of nickel in the surface portion 100a. Alternatively, the concentration of cobalt is preferably higher than that of aluminum in the surface portion 100a. Alternatively, the concentration of cobalt is higher than that of fluorine in the surface portion 100a.

Moreover, excess nickel might hinder diffusion of lithium; thus, the concentration of magnesium is preferably higher than that of nickel in the surface portion 100a. For example, when measurement by XPS is performed from the surface of the positive electrode active material 100, the number of nickel atoms is preferably ⅙ or less of that of magnesium atoms.

It is preferable that some additive elements, in particular, magnesium, nickel, and aluminum have higher concentrations in the surface portion 100a than in the inner portion 100b and exist randomly also in the inner portion 100b to have low concentrations. When magnesium and aluminum exist in the lithium sites of the inner portion 100b at appropriate concentrations, an effect of facilitating maintenance of the layered rock-salt crystal structure can be obtained in a manner similar to the above. When nickel exists in the inner portion 100b at an appropriate concentration, a shift in the layered structure formed of octahedrons of cobalt and oxygen can be inhibited in a manner similar to the above. Also in the case where both magnesium and nickel are contained, a synergistic effect of inhibiting dissolution of magnesium can be expected in a manner similar to the above.

It is preferable that the crystal structure continuously change from the inner portion 100b toward the surface owing to the above-described concentration gradient of the additive element. Alternatively, the crystal orientations of the surface portion 100a and the inner portion 100b are preferably substantially aligned with each other.

For example, a crystal structure preferably changes continuously from the layered rock-salt inner portion 100b toward the surface and the surface portion 100a that have a rock-salt structure or have features of both a rock-salt structure and a layered rock-salt structure. Alternatively, the orientation of the surface portion 100a that has a rock-salt structure or has the features of both a rock-salt structure and a layered rock-salt structure and the orientation of the inner portion 100b having the layered rock-salt structure are preferably substantially aligned with each other.

In this specification and the like, a layered rock-salt crystal structure, which belongs to the space group R-3m, of a composite oxide containing lithium and the transition metal such as cobalt refers to a crystal structure in which a rock-salt ion arrangement where cations and anions are alternately arranged is included and lithium and the transition metal are regularly arranged to form a two-dimensional plane, so that lithium can be diffused two-dimensionally. Note that a defect such as a cation or anion vacancy may exist. Moreover, in the layered rock-salt crystal structure, strictly, a lattice of a rock-salt crystal is distorted in some cases.

A rock-salt crystal structure refers to a structure in which a cubic crystal structure with the space group Fm-3m or the like is included and cations and anions are alternately arranged. Note that a cation or anion vacancy may be included.

Having features of both a layered rock-salt crystal structure and a rock-salt crystal structure can be determined by electron diffraction, a TEM image, a cross-sectional STEM image, and the like.

There is no distinction among cation sites in a rock-salt structure. Meanwhile, a layered rock-salt crystal structure has two types of cation sites: one type is mostly occupied by lithium, and the other is occupied by the transition metal. A stacked-layer structure where two-dimensional planes of cations and two-dimensional planes of anions are alternately arranged is the same in a rock-salt structure and a layered rock-salt structure. Given that the center spot (transmission spot) among bright spots in an electron diffraction pattern corresponding to crystal planes that form the two-dimensional planes is at the origin point 000, the bright spot nearest to the center spot is on the (111) plane in an ideal rock-salt crystal structure, for instance, and on the (003) plane in a layered rock-salt crystal structure, for instance. For example, when electron diffraction patterns of MgO having a rock-salt crystal structure and LiCoO₂ having a layered rock-salt structure are compared to each other, the distance between the bright spots on the (003) plane of LiCoO₂ is observed at a distance approximately half the distance between the bright spots on the (111) plane of MgO. Thus, for instance, when two phases of rock-salt MgO and layered rock-salt LiCoO₂ are included in a region to be analyzed, a plane orientation in which bright spots with high luminance and bright spots with low luminance are alternately arranged is seen in an electron diffraction pattern. A bright spot common between the rock-salt structure and the layered rock-salt structure has high luminance, whereas a bright spot caused only in the layered rock-salt structure has low luminance.

When a layered rock-salt crystal structure is observed from a direction perpendicular to the c-axis in a cross-sectional STEM image and the like, layers observed with high luminance and layers observed with low luminance are alternately observed. Such a feature is not observed in a rock-salt crystal structure because there is no distinction among cation sites therein. When a crystal structure having the features of both a rock-salt crystal structure and a layered rock-salt crystal structure is observed from a given crystal orientation, layers observed with high luminance and layers observed with low luminance are alternately observed in a cross-sectional STEM image and the like, and a metal that has a larger atomic number than lithium exists in part of the layers with low luminance, i.e., the lithium layers.

Anions of a layered rock-salt crystal and anions of a rock-salt crystal form a cubic close-packed structure (face-centered cubic lattice structure). Anions of an O3′ crystal and a monoclinic O1(15) crystal described later are presumed to form a cubic close-packed structure. Thus, when a layered rock-salt crystal and a rock-salt crystal are in contact with each other, there is a crystal plane at which orientations of cubic close-packed structures formed of anions are aligned with each other.

The description can also be made as follows. Anions on the {111} plane of a cubic crystal structure have a triangle lattice. A layered rock-salt structure, which belongs to the space group R-3m and is a rhombohedral structure, is generally represented by a composite hexagonal lattice for easy understanding of the structure, and the (0001) plane of the layered rock-salt structure has a hexagonal lattice. The triangle lattice on the {111} plane of the cubic crystal has atomic arrangement similar to that of the hexagonal lattice on the (0001) plane of the layered rock-salt structure. These lattices being consistent with each other can be expressed as “orientations of the cubic close-packed structures are aligned with each other”.

Note that a space group of the layered rock-salt crystal and the O3′ crystal is R-3m, which is different from the space group Fm-3m of a rock-salt crystal (the space group of a general rock-salt crystal); thus, the Miller index of the crystal plane satisfying the above conditions in the layered rock-salt crystal and the O3′ crystal is different from that in the rock-salt crystal. In this specification, in the layered rock-salt crystal, the O3′ crystal, and the rock-salt crystal, a state where the orientations of the cubic close-packed structures formed of anions are aligned with each other may be referred to as a state where crystal orientations are substantially aligned with each other. In addition, topotaxy refers to having similarity in a three-dimensional structure such that crystal orientations are substantially aligned with each other, or to having the same orientations crystallographically.

The crystal orientations in two regions being substantially aligned with each other can be determined, for example, from a TEM (Transmission Electron Microscope) image, a STEM (Scanning Transmission Electron Microscope) image, a HAADF-STEM (High-angle Annular Dark Field Scanning TEM) image, an ABF-STEM (Annular Bright-Field Scanning Transmission Electron Microscope) image, an electron diffraction pattern, and an FFT pattern of a TEM image, a STEM image, and the like. XRD (X-ray Diffraction), electron diffraction, neutron diffraction, and the like can also be used for judging.

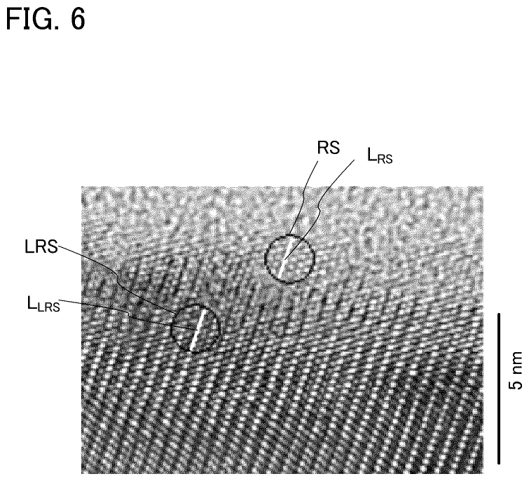

FIG. 6 shows an example of a TEM image in which orientations of a layered rock-salt crystal LRS and a rock-salt crystal RS are substantially aligned with each other. In a TEM image, a STEM image, a HAADF-STEM image, an ABF-STEM image, and the like, an image reflecting a crystal structure is obtained.

For example, in a high-resolution TEM image, a contrast derived from a crystal plane is obtained. When an electron beam is incident perpendicularly to the c-axis of a layered rock-salt type composite hexagonal lattice, for example, a contrast derived from the (0003) plane is obtained as repetition of bright bands (bright strips) and dark bands (dark strips) because of diffraction and interference of the electron beam. Thus, when repetition of bright lines and dark lines is observed and the angle between the bright lines (e.g., Las and LERS in FIG. 6) is less than or equal to 5° or less than or equal to 2.5° in the TEM image, it can be determined that the crystal planes are substantially aligned with each other, that is, orientations of the crystals are substantially aligned with each other. Similarly, when the angle between the dark lines is less than or equal to 5° or less than or equal to 2.5°, it can be judged that the crystal orientations are substantially aligned with each other.

In a HAADF-STEM image, a contrast proportional to the atomic number is obtained, and an element having a larger atomic number is observed to be brighter. For example, in the case of lithium cobalt oxide that has a layered rock-salt structure belonging to the space group R-3m, cobalt (atomic number: 27) has the largest atomic number; hence, an electron beam is strongly scattered at the position of a cobalt atom, and arrangement of the cobalt atoms is observed as bright lines or arrangement of high-luminance dots. Thus, when the lithium cobalt oxide having a layered rock-salt crystal structure is observed in the direction perpendicular to the c-axis, arrangement of the cobalt atoms is observed as bright lines or arrangement of high-luminance dots, and arrangement of lithium atoms and oxygen atoms is observed as dark lines or a low-luminance region in the direction perpendicular to the c-axis. The same applies to the case where fluorine (atomic number: 9) and magnesium (atomic number: 12) are included as the additive elements of the lithium cobalt oxide.

Consequently, in the case where repetition of bright lines and dark lines is observed in two regions having different crystal structures and the angle between the bright lines is less than or equal to 5° or less than or equal to 2.5° in a HAADF-STEM image, it can be judged that arrangements of the atoms are substantially aligned with each other, that is, orientations of the crystals are substantially aligned with each other. Similarly, when the angle between the dark lines is less than or equal to 5° or less than or equal to 2.5°, it can be judged that orientations of the crystals are substantially aligned with each other.

With an ABF-STEM, an element having a smaller atomic number is observed to be brighter, but a contrast corresponding to the atomic number is obtained as with a HAADF-STEM; hence, in an ABF-STEM image, crystal orientations can be judged as in a HAADF-STEM image.

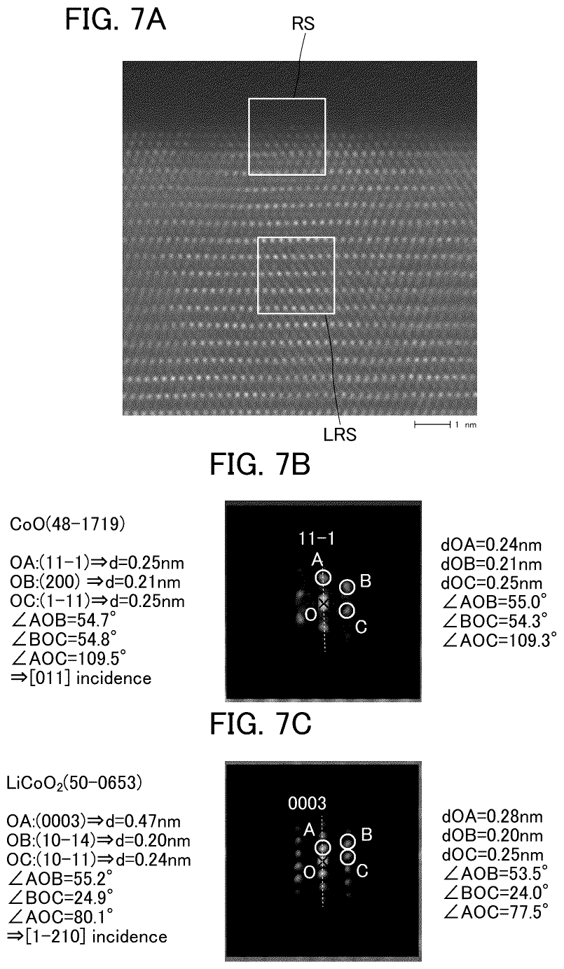

FIG. 7A shows an example of a STEM image in which orientations of the layered rock-salt crystal LRS and the rock-salt crystal RS are substantially aligned with each other. FIG. 7B shows an FFT pattern of a region of the rock-salt crystal RS, and FIG. 7C shows an FFT pattern of a region of the layered rock-salt crystal LRS. In FIG. 7B and FIG. 7C, the composition, the JCPDS card number, d values, angles, and incidence to be calculated are shown on the left. The measured values are shown on the right. A spot denoted by O is zero-order diffraction.

A spot denoted by A in FIG. 7B is derived from 11-1 reflection of a cubic structure. A spot denoted by A in FIG. 7C is derived from 0003 reflection of a layered rock-salt structure. It is found from FIG. 7B and FIG. 7C that the direction of the 11-1 reflection of the cubic structure and the direction of the 0003 reflection of the layered rock-salt structure are substantially aligned with each other. That is, a straight line that passes through AO in FIG. 7B is substantially parallel to a straight line that passes through AO in FIG. 7C. Here, the terms “substantially aligned” and “substantially parallel” mean that the angle is less than or equal to 5° or less than or equal to 2.5°.

When the orientations of the layered rock-salt crystal and the rock-salt crystal are substantially aligned with each other in the above manner in an FFT pattern and an electron diffraction pattern, the <0003> orientation of the layered rock-salt crystal and the <11-1> orientation of the rock-salt crystal may be substantially aligned with each other. In that case, it is preferable that these reciprocal lattice points be spot-shaped, that is, they be not connected to other reciprocal lattice points. The state where reciprocal lattice points are spot-shaped and not connected to other reciprocal lattice points means high crystallinity.

When the direction of the 11-1 reflection of the cubic structure and the direction of the 0003 reflection of the layered rock-salt structure are substantially aligned with each other as described above, a spot that is not derived from the 0003 reflection of the layered rock-salt structure may be observed, depending on the incident direction of the electron beam, on a reciprocal lattice space different from the direction of the 0003 reflection of the layered rock-salt structure. For example, a spot denoted by B in FIG. 7C is derived from 1014 reflection of the layered rock-salt structure. This is sometimes observed at a position where the difference in orientation from the reciprocal lattice point derived from the 0003 reflection of the layered rock-salt crystal structure (A in FIG. 7C) is greater than or equal to 52° and less than or equal to 56° (i.e., ∠AOB is greater than or equal to 52° and less than or equal to 56°) and d is greater than or equal to 0.19 nm and less than or equal to 0.21 nm. Note that these indices are just an example, and the spot does not necessarily correspond with them. For example, the spot may be a reciprocal lattice point equivalent to 0003 and 1014.

Similarly, a spot that is not derived from the 11-1 reflection of the cubic structure may be observed on a reciprocal lattice space different from the direction where the 11-1 reflection of the cubic structure is observed. For example, a spot denoted by B in FIG. 7B is derived from 200 reflection of the cubic structure. This diffraction spot is sometimes observed at a position where the difference in orientation from the spot derived from the 11-1 reflection of the cubic structure (A in FIG. 7B) is greater than or equal to 54° and less than or equal to 56° (i.e., ∠AOB is greater than or equal to 54° and less than or equal to 56°). Note that these indices are just an example, and the spot does not necessarily correspond with them. For example, the spot may be a reciprocal lattice point equivalent to 11-1 and 200.

It is known that in a layered rock-salt positive electrode active material, such as lithium cobalt oxide, the (0003) plane and a plane equivalent thereto and the (10-14) plane and a plane equivalent thereto are likely to be crystal planes. Thus, a sample to be observed can be processed to be thin by FIB or the like such that an electron beam of a TEM, for example, enters in [12-10], in order to easily observe the (0003) plane in careful observation of the shape of the positive electrode active material with a SEM or the like. To judge whether crystal orientations are aligned, a sample is preferably processed to be thin so that the (0003) plane of the layered rock-salt structure is easily observed.

<<State where x in LiₓCoO₂ is Small>>

The crystal structure in a state where x in LiₓCoO₂ is small of the positive electrode active material 100 of one embodiment of the present invention is different from that of a conventional positive electrode active material because the positive electrode active material 100 has the above-described additive element distribution and/or crystal structure in a discharged state. Here, “x is small” means 0.1<x≤0.24.

A conventional positive electrode active material and the positive electrode active material 100 of one embodiment of the present invention are compared and changes in crystal structures owing to a change in x in LiₓCoO₂ will be described with reference to FIG. 8 to FIG. 13.

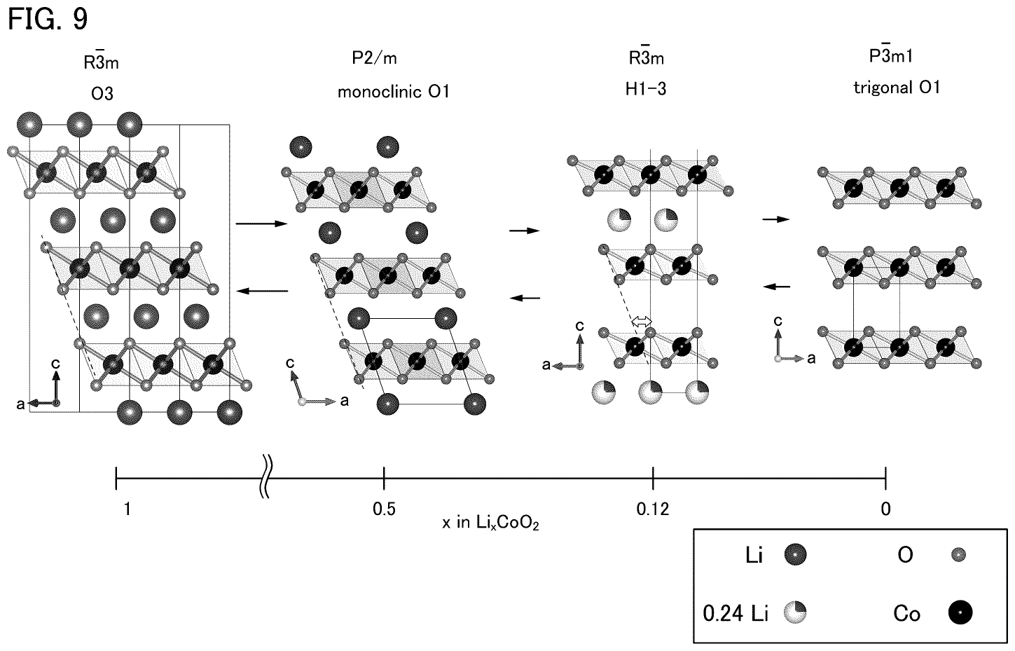

A change in the crystal structure of the conventional positive electrode active material is illustrated in FIG. 9. The conventional positive electrode active material shown in FIG. 9 is lithium cobalt oxide (LiCoO₂) containing no additive element. A change in the crystal structure of lithium cobalt oxide containing no additive element is described in Non-Patent Document 1 to Non-Patent Document 4 and the like.

In FIG. 9, the crystal structure of lithium cobalt oxide with x in LiₓCoO₂ of 1 is denoted by R-3m O3. In this crystal structure, lithium occupies octahedral sites and a unit cell includes three CoO₂ layers. Thus, this crystal structure is referred to as an O3-type structure in some cases. Note that the CoO₂ layer has a structure in which an octahedral structure with cobalt coordinated to six oxygen atoms continues on a plane in an edge-shared state. Such a layer is sometimes referred to as a layer formed of octahedrons of cobalt and oxygen.

Conventional lithium cobalt oxide with x being approximately 0.5 is known to have an improved symmetry of lithium and have a monoclinic crystal structure belonging to the space group P2/m. This structure includes one CoO₂ layer in a unit cell. Thus, this crystal structure is referred to as an O1-type structure or a monoclinic O1-type structure in some cases.

A positive electrode active material with x of 0 has the trigonal crystal structure belonging to the space group P-3 ml and includes one CoO₂ layer in a unit cell. Thus, this crystal structure is referred to as an O1-type structure or a trigonal O1-type structure in some cases. Moreover, in some cases, this crystal structure is referred to as a hexagonal O1-type structure when the trigonal crystal is converted into a composite hexagonal lattice.

Conventional lithium cobalt oxide with x being approximately 0.12 has the crystal structure belonging to the space group R-3m. This structure can also be regarded as a structure in which CoO₂ structures such as trigonal O1-type structures and LiCoO₂ structures such as R-3m O3 are alternately stacked. Thus, this crystal structure is referred to as an H1-3-type structure in some cases. Note that since insertion and extraction of lithium do not necessarily uniformly occur in the positive electrode active material in reality, the lithium concentrations can vary; thus, the H1-3-type structure is started to be observed when x is approximately 0.25 in practice. The number of cobalt atoms per unit cell in the actual H1-3-type structure is twice that in other structures. However, in this specification including FIG. 9, the c-axis of the H1-3-type structure is half that of the unit cell for easy comparison with the other crystal structures.

For the H1-3-type structure, as disclosed in Non-Patent Document 3, the coordinates of cobalt and oxygen in the unit cell can be expressed as follows, for example: Co (0, 0, 0.42150±0.00016), O1 (0, 0, 0.27671±0.00045), and O2 (0, 0, 0.11535±0.00045). O1 and O2 are each an oxygen atom. A unit cell that should be used for representing a crystal structure in a positive electrode active material can be judged by the Rietveld analysis of XRD patterns, for example. In this case, a unit cell is selected such that the value of GOF (goodness of fit) is small.

When charging that makes x in LiₓCoO₂ be 0.24 or less and discharging are repeated, the crystal structure of conventional lithium cobalt oxide repeatedly changes between the R-3m O3-type structure in a discharged state and the H1-3-type structure (i.e., an unbalanced phase change).

However, there is a large shift in the CoO₂ layers between these two crystal structures. As denoted by the dotted lines and the arrows in FIG. 9, the CoO₂ layer in the H1-3-type structure largely shifts from that in the structure belonging to R-3m O3 in a discharged state. Such a dynamic structural change can adversely affect the stability of the crystal structure.

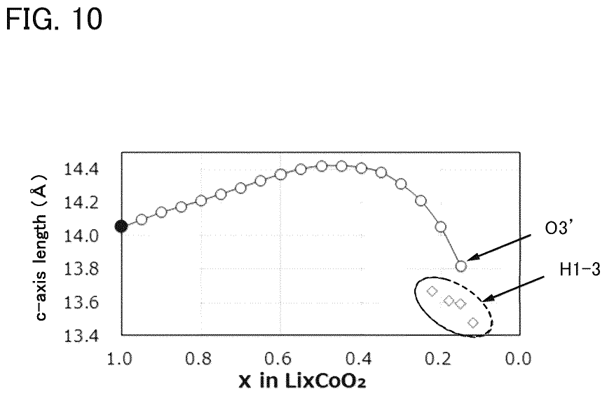

A difference in volume between these two crystal structures is also large. The crystal structure and the volume of the unit cell of lithium cobalt oxide change in accordance with a change in charge depth, i.e., a change in x in LiₓCoO₂. FIG. 10 shows a change in c-axis length of conventional lithium cobalt oxide described in Non-Patent Document 4. A circle indicates a hexagonal phase and a rhombus indicates a monoclinic phase. The c-axis length contracts in an H1-3 phase as shown by the rhombuses in FIG. 10. The phase transition from an O3 phase to an H1-3 phase is due to extraction of lithium ions, whereby a phase transition probably occurs from a surface of a positive electrode active material from which lithium ions are extracted first and eventually spreads to the entire positive electrode active material.

A change in c-axis length of lithium cobalt oxide corresponds to a change in the angle at which a peak of, for example, the (003) plane of lithium cobalt oxide appears in an XRD pattern. It is known that a peak of the (003) plane of lithium cobalt oxide appears at around 20=19° to 20° in XRD using CuKα1 radiation.

Thus, the difference in volume per the same number of cobalt atoms between the R-3m O3-type structure in a discharged state and the H1-3-type structure is greater than 3.5%, typically greater than or equal to 3.9%.

In addition, a structure in which CoO₂ layers are arranged continuously, such as the trigonal O1-type structure, included in the H1-3-type structure is highly likely to be unstable.

Accordingly, when charging that makes x be 0.24 or less and discharging are repeated, the crystal structure of conventional lithium cobalt oxide is gradually broken. The broken crystal structure triggers degradation of the cycle performance. This is because the broken crystal structure has a smaller number of sites where lithium can exist stably and makes it difficult to insert and extract lithium.

On the other hand, in the positive electrode active material 100 of one embodiment of the present invention shown in FIG. 8, a change in the crystal structure between a discharged state with x in LiₓCoO₂ being 1 and a state with x being 0.24 or less is smaller than that in a conventional positive electrode active material. Specifically, a shift in the CoO₂ layers between the state with x of 1 and the state with x of 0.24 or less can be small. Furthermore, a change in the volume can be small in the case where the positive electrode active materials have the same number of cobalt atoms. Thus, the positive electrode active material 100 of one embodiment of the present invention can have a crystal structure that is difficult to break even when charge that makes x be 0.24 or less and discharge are repeated, and enables excellent cycle performance. In addition, the positive electrode active material 100 of one embodiment of the present invention with x in LiₓCoO₂ being 0.24 or less can have a more stable crystal structure than a conventional positive electrode active material. Thus, the positive electrode active material 100 of one embodiment of the present invention with x in LiₓCoO₂ being kept at 0.24 or less inhibits a short circuit. This is preferable because the safety of the secondary battery is improved.

FIG. 8 shows crystal structures of the inner portion 100b of the positive electrode active material 100 in a state where x in LiₓCoO₂ is approximately 1, in a state where x in LiₓCoO₂ is approximately 0.2, and in a state where x in LiₓCoO₂ is approximately 0.15. The inner portion 100b, accounting for the majority of the volume of the positive electrode active material 100, largely contributes to charge and discharge and is accordingly a portion where a shift in CoO₂ layers and a volume change matter most.

The positive electrode active material 100 with x being 1 has the R-3m O3-type structure, which is the same as that of conventional lithium cobalt oxide.

However, the positive electrode active material 100 has a crystal structure different from the H1-3-type structure when x is 0.24 or less, e.g., approximately 0.2 or approximately 0.15, with which conventional lithium cobalt oxide has the H1-3-type structure.

The positive electrode active material 100 of one embodiment of the present invention with x being approximately 0.2 has a trigonal crystal structure belonging to the space group R-3m. The symmetry of the CoO₂ layers of this structure is the same as that of O3. Thus, this crystal structure is called an O3′-type structure. In FIG. 8, this crystal structure is denoted by R-3m O3′.

In the unit cell of the O3′-type structure, the coordinates of cobalt and oxygen can be represented by Co (0, 0, 0.5) and O (0, 0, x) within the range of 0.20≤ x≤0.25. In the unit cell, the lattice constant of the a-axis is preferably 2.797≤a≤2.837 (Å), further preferably 2.807≤a≤2.827 (Å), typically a=2.817 (Å). The lattice constant of the c-axis is preferably 13.681≤c≤13.881 (Å), further preferably 13.751≤c≤13.811 (Å), typically c=13.781 (Å).

When x is approximately 0.15, the positive electrode active material 100 of one embodiment of the present invention has a monoclinic crystal structure belonging to the space group P2/m. This structure includes one CoO₂ layer in a unit cell. Here, lithium in the positive electrode active material 100 is approximately 15 atomic % of that in a discharged state. Thus, this crystal structure is referred to as a monoclinic O1(15)-type structure. In FIG. 8, this crystal structure is denoted by P2/m monoclinic O1(15).

In the unit cell of the monoclinic O1(15)-type structure, the coordinates of cobalt and oxygen can be represented within the ranges below;

$$Co 1 ( 0.5 , 0 , 0.5 ) ,$$

$$Co 2 ( 0 , 0.5 , 0.5 ) ,$$

$$O 1 ( {X}_{O 1} , 0 , {Z}_{O 1} ) ,$$

$$0.23 \leq {X}_{O 1} \leq 0.24 , 0.61 \leq {Z}_{O 1} \leq 0.65 ,$$

$$O 2 ( {X}_{O 2} , 0.5 , {Z}_{O 2} ) , and$$

$$0.75 \leq {X}_{O 2} \leq 0.78 and 0.68 \leq {Z}_{O 2} \leq 0.71 .$$

The lattice constant of the unit cell is as follows:

$$a = 4.880 \pm 0.05 Å ,$$

$$b = 2. 817 \pm 0.05 Å ,$$

$$c = 4. 839 \pm 0.05 Å ,$$

$$α = 90 ° ,$$

$$β = 10 \; 9.6 \pm 0.1 ° ,$$

$$γ = 90 ° .$$

Note that this crystal structure can have the lattice constants even when belonging to the space group R-3m if a certain error is allowed. The coordinates of cobalt and oxygen in the unit cell in this case can be represented by

Co(0,0,0.5),

O(0,0,Z_{O}),

within the range of 0.21≤Z_{O}≤0.23. The lattice constant of the unit cell is as follows:

$$a = 2.817 \pm 0.02 Å ,$$

$$c = 13.68 \pm 0.1 Å .$$

In both of the O3′-type structure and the monoclinic O1(15)-type structure, an ion of cobalt, nickel, magnesium, or the like occupies a site coordinated to six oxygen atoms. Note that light elements such as lithium and magnesium sometimes occupy a site coordinated to four oxygen atoms.

As denoted by the dotted lines in FIG. 8, the CoO₂ layers hardly shift between the R-3m O3 in the discharged state, the O3′-type structure, and the monoclinic O1(15)-type structure.

The R-3m O3-type structure in a discharged state and the O3′-type structure which contain the same number of cobalt atoms have a difference in volume of 2.5% or less, specifically 2.2% or less, typically 1.8%.

The R-3m O3-type structure in a discharged state and the monoclinic O1(15)-type structure which contain the same number of cobalt atoms have a difference in volume of 3.3% or less, specifically 3.0% or less, typically 2.5%.

Table 1 shows a difference in volume per cobalt atom between the R-3m O3-type structure in a discharged state, the O3′-type structure, the monoclinic O1(15)-type structure, the H1-3-type structure, and the trigonal O1-type structure. For the lattice constants of the R-3m O3-type structure in a discharged state and the trigonal O1-type structure in Table 1, which are used for the calculation, the literature values (ICSD coll. code. 172909 and 88721) can be referred to. For the lattice constants of the H1-3-type structure, Non-Patent Document 3 can be referred to. In the case of the O3′-type structure and the monoclinic O1(15)-type structure, the lattice constants thereof can be calculated from the experimental values of XRD.

TABLE 1

| Crystal | Lattice constant | | | | Volume of | Volume per one | Volume change |
|---|---|---|---|---|---|---|---|
| structure | a (Å) | b (Å) | c (Å) | β (°) | unit cell (Å³) | cobalt atom (Å³) | rate (%) |
| R-3m O3 | 2.8156 | 2.8156 | 14.0542 | 90 | 96.49 | 32.16 | — |
| (LiCoO₂) | | | | | | | |
| O3′ | 2.818 | 2.818 | 13.78 | 90 | 94.76 | 31.59 | 1.8 |
| Monoclinic O1(15) | 4.881 | 2.817 | 4.839 | 109.6 | 62.69 | 31.35 | 2.5 |
| H1-3 | 2.82 | 2.82 | 26.92 | 90 | 185.4 | 30.90 | 3.9 |
| Trigonal O1 | 2.8048 | 2.8048 | 4.2509 | 90 | 28.96 | 28.96 | 10.0 |
| (CoO [symbol] ) | | | | | | | |

[symbol]

indicates data missing or illegible when filed

As described above, in the positive electrode active material 100 of one embodiment of the present invention, a change in the crystal structure caused when x in LiₓCoO₂ is small, i.e., when a large amount of lithium is extracted, is smaller than that in a conventional positive electrode active material. In addition, a change in the volume per the same number of cobalt atoms is inhibited. Thus, the crystal structure of the positive electrode active material 100 is less likely to break even when charging that makes x be 0.24 or less and discharging are repeated. Thus, the positive electrode active material 100 inhibits a decrease in charge and discharge capacity in charge and discharge cycles. Furthermore, the positive electrode active material 100 can stably use a larger amount of lithium than a conventional positive electrode active material and thus has high discharge capacity per weight and per volume. Thus, with the use of the positive electrode active material 100, a secondary battery with high discharge capacity per weight and per volume can be manufactured.

Note that the positive electrode active material 100 is confirmed to have the O3′-type structure in some cases when x in LiₓCoO₂ is greater than or equal to 0.15 and less than or equal to 0.24, and is assumed to have the O3′-type structure even when x is greater than 0.24 and less than or equal to 0.27. In addition, the positive electrode active material 100 is confirmed to have the monoclinic O1(15)-type structure in some cases when x in LiₓCoO₂ is greater than 0.1 and less than or equal to 0.2, typically greater than or equal to 0.15 and less than or equal to 0.17. However, the crystal structure is influenced by not only x in LiₓCoO₂ but also the number of charge and discharge cycles, a charge current and a discharge current, temperature, an electrolyte, and the like, so that the range of x is not limited to the above.

Thus, when x in LiₓCoO₂ is greater than 0.1 and less than or equal to 0.24, the positive electrode active material 100 may have the O3′-type structure only or both the O3′-type structure and the monoclinic O1(15)-type structure. Not all particles of the inner portion 100b of the positive electrode active material 100 necessarily have the O3′-type structure and/or the monoclinic O1(15)-type structure. The positive electrode active material may include another crystal structure or may be partly amorphous.

In order to make x in LiₓCoO₂ small, charge at a high charge voltage is necessary in general. Thus, the state where x in LiₓCoO₂ is small can be rephrased as a state where charge at a high charge voltage has been performed. For example, when CCCV (constant current/constant voltage) charge is performed at 25° C. and 4.6 V or higher with reference to the potential of a lithium metal, the H1-3-type structure appears in a conventional positive electrode active material. Thus, a charge voltage of 4.6 V or higher can be regarded as a high charge voltage with reference to the potential of a lithium metal. In this specification and the like, unless otherwise specified, a charge voltage is shown with reference to the potential of a lithium metal.

Thus, the positive electrode active material 100 of one embodiment of the present invention is preferable because the crystal structure with the symmetry of R-3m O3 can be maintained even when charging at a high charge voltage, e.g., a voltage higher than or equal to 4.6 V, is performed at 25° C. Moreover, the positive electrode active material 100 of one embodiment of the present invention is preferable because the O3′-type structure can be obtained when charging with a higher charge voltage, e.g., a voltage higher than or equal to 4.65 V and lower than or equal to 4.7 V is performed at 25° C. Furthermore, the positive electrode active material 100 of one embodiment of the present invention is preferable because the monoclinic O1(15)-type structure can be obtained when charging at a much higher charge voltage, e.g., a voltage higher than 4.7 V and lower than or equal to 4.8 V is performed at 25° C.

In the positive electrode active material 100, when the charge voltage is increased, the H1-3-type structure is eventually observed in some cases. As described above, the crystal structure is influenced by the number of charge and discharge cycles, a charge current and a discharge current, temperature, an electrolyte, and the like, so that the positive electrode active material 100 of one embodiment of the present invention sometimes has the O3′-type structure even at a lower charge voltage, e.g., a charge voltage higher than or equal to 4.5 V and lower than 4.6 V at 25° C. Similarly, the positive electrode active material 100 may sometimes have the monoclinic O1(15)-type structure at a charge voltage higher than or equal to 4.65 V and lower than or equal to 4.7 V at 25° C.

Note that in the case where graphite is used as a negative electrode active material in a secondary battery, for example, the voltage of the secondary battery is lower than the above-mentioned voltage by the potential of graphite. The potential of graphite is approximately 0.05 V to 0.2 V with reference to the potential of a lithium metal. Thus, for a secondary battery using graphite as a negative electrode active material, a similar crystal structure is obtained at a voltage corresponding to a difference between the above-described voltage and the potential of the graphite.

Although a chance of the existence of lithium is the same in all lithium sites in O3′ and monoclinic O1(15) in FIG. 8, one embodiment of the present invention is not limited thereto. Lithium may exist unevenly in only some of the lithium sites; for example, lithium may symmetrically exist as in the monoclinic O1 (Li_{0.5}CoO₂) shown in FIG. 9. Distribution of lithium can be analyzed by neutron diffraction, for example.

The O3′-type structure and the monoclinic O1(15) structure can be regarded as a crystal structure that contains lithium between layers randomly but is similar to a CdCl-type structure. The crystal structure similar to the CdCl₂-type structure is close to a crystal structure of lithium nickel oxide that is charged to be Li_{0.06}NiO₂; however, pure lithium cobalt oxide or a layered rock-salt positive electrode active material containing a large amount of cobalt is known not to have the CdCl₂-type structure in general.

### <<Crystal Grain Boundary>>

It is further preferable that the additive element contained in the positive electrode active material 100 of one embodiment of the present invention have the above-described distribution and be at least partly unevenly distributed at the crystal grain boundary 105 and the vicinity thereof.

Note that in this specification and the like, uneven distribution means that the concentration of an element in a certain region differs from that in another region. This may be rephrased as segregation, precipitation, unevenness, deviation, or a mixture of a high-concentration portion and a low-concentration portion.

For example, the concentration of magnesium at the crystal grain boundary 105 and the vicinity thereof in the positive electrode active material 100 is preferably higher than that in the other regions in the inner portion 100b. In addition, the fluorine concentration at the crystal grain boundary 105 and the vicinity thereof is preferably higher than that in the other regions in the inner portion 100b. In addition, the concentration of nickel at the crystal grain boundary 105 and the vicinity thereof is preferably higher than that in the other regions in the inner portion 100b. In addition, the concentration of aluminum at the crystal grain boundary 105 and the vicinity thereof is preferably higher than that in the other regions in the inner portion 100b.

The crystal grain boundary 105 is a type of plane defect. Thus, the crystal grain boundary tends to be unstable and the crystal structure easily starts to change like the surface of the particle. Thus, the higher the concentration of the additive element at the crystal grain boundary 105 and the vicinity thereof is, the more effectively the change in the crystal structure can be reduced.

When the magnesium concentration and the fluorine concentration are high at the crystal grain boundary 105 and the vicinity thereof, the magnesium concentration and the fluorine concentration in the vicinity of a surface generated by a crack are also high even when the crack is generated along the crystal grain boundary 105 of the positive electrode active material 100 of one embodiment of the present invention. Thus, the positive electrode active material including a crack can also have an increased corrosion resistance to hydrofluoric acid. In addition, the positive electrode active material including a crack can inhibit a side reaction between the electrolyte solution and the positive electrode active material.

### <Single Particle>

The positive electrode active material 100 preferably has high crystallinity and is further preferably a single crystal. That is, the positive electrode active material 100 preferably includes a single particle. It is preferable that the positive electrode active material 100 of one embodiment of the present invention be a single particle, in which case a crack is not easily generated even though a volume change occurs in the positive electrode active material 100 by charging and discharging. Furthermore, when the positive electrode active material 100 is a single particle, it is thought that the secondary battery using the positive electrode active material 100 is less likely to ignite and can improve safety.

### <Crystallite Size>

For example, in the positive electrode active material 100, the lower limit of the crystallite size calculated from the half width of the diffraction pattern of XRD is preferably greater than or equal to 250 nm, further preferably greater than or equal to 420 nm. Fr example, the crystallite size can be calculated from the Scherrer Formula below.

$$Crystallite size [ nm ] = \frac{Scherrer constant \times X - ray wavelength [ nm ]}{Half width [ rad ] \times cos ( \frac{Diffraction angle of peak [ rad ]}{2} ) )} \qquad [ Formula 1 ]$$

Note that in order to increase the crystallite size, excess amount of lithium is added and then heating is performed. However, excess amount of lithium might cause gelation of a binder in forming an electrode such as a positive electrode. It is preferable that the upper limit of the crystallite size be set in order to avoid this disadvantage. For example, when the crystallite size calculated from the XRD diffraction pattern is less than or equal to 600 nm, preferably less than or equal to 500 nm, the above disadvantage can be avoided. This upper limit value can be freely combined with the above-described lower limit of the crystallite size.

An XRD diffraction pattern for calculation of the half width is preferably obtained in a state of the positive electrode active material alone, or may be obtained in a state of a positive electrode including a current collector, a binder, a conductive material, and the like in addition to the positive electrode active material. Note that the positive electrode active material may have orientation in the positive electrode owing to, for example, pressure application in a formation process. When many of the positive electrode active material particles are oriented, the crystallite size might fail to be calculated accurately; thus, an XRD diffraction pattern is preferably obtained in the following manner: a positive electrode active material layer is taken out from the positive electrode; the binder and the like in the positive electrode active material layer is eliminated to some extent using a solvent or the like; and a sample holder is filled with the resultant positive electrode active material.

### <Particle Diameter>

When the particle diameter of the positive electrode active material 100 of one embodiment of the present invention is too large, there are problems such as difficulty in lithium diffusion and large surface roughness of an active material layer at the time when the material is applied to a current collector. By contrast, too small a particle diameter causes problems such as overreaction with the electrolyte solution. Thus, the median diameter (D50) is preferably greater than or equal to 1 μm and less than or equal to 100 μm, further preferably greater than or equal to 2 μm and less than or equal to 40 μm, still further preferably greater than or equal to 5 μm and less than or equal to 30 μm. Alternatively, it is preferably greater than or equal to 1 μm and less than or equal to 40 μm. Alternatively, it is preferably greater than or equal to 1 μm and less than or equal to 30 μm. Alternatively, it is preferably greater than or equal to 2 μm and less than or equal to 100 μm. Alternatively, it is preferably greater than or equal to 2 μm and less than or equal to 30 μm. Alternatively, it is preferably greater than or equal to 5 μm and less than or equal to 100 μm. Alternatively, it is preferably greater than or equal to 5 μm and less than or equal to 40 μm.

A positive electrode is preferably formed using a mixture of particles having different particle diameters, which can increase the electrode density and thus a secondary battery with a high energy density can be achieved. The positive electrode active material 100 with a relatively small particle diameter is expected to have high charge-discharge rate characteristics. The positive electrode active material 100 with a relatively large particle diameter is expected to have high charge-discharge cycle performance and maintain high discharge capacity.

### <Analysis Method>

Whether or not a given positive electrode active material is the positive electrode active material 100 of one embodiment of the present invention, which has the O3′-type structure and/or monoclinic O1(15)-type structure when x in LiₓCoO₂ is small, can be judged by analyzing a positive electrode including the positive electrode active material with small x in LiₓCoO₂ by XRD, electron diffraction, neutron diffraction, electron spin resonance (ESR), nuclear magnetic resonance (NMR), or the like.

XRD is particularly preferable because the symmetry of a transition metal such as cobalt in the positive electrode active material can be analyzed with high resolution, comparison of the degree of crystallinity and comparison of the crystal orientation can be performed, distortion of lattice periodicity and the crystallite size can be analyzed, and a positive electrode obtained only by disassembling a secondary battery can be measured with sufficient accuracy, for example. A diffraction peak reflecting the crystal structure of the inner portion 100b of the positive electrode active material 100, which accounts for the majority of the volume of the positive electrode active material 100, is obtained through XRD, in particular, powder XRD.

In the case where the crystallite size is measured by powder XRD, the measurement is preferably performed while the influence of orientation due to pressure or the like is removed. For example, it is preferable that the positive electrode active material be taken out from a positive electrode obtained by disassembling a secondary battery, the positive electrode active material be made into a powder sample, and then the measurement be performed.

As described above, the positive electrode active material 100 of one embodiment of the present invention has a feature of a small change in the crystal structure between when x in LiₓCoO₂ is 1 and when x is less than or equal to 0.24. A material where 50% or more of the crystal structure largely changes in high-voltage charge is not preferable because the material cannot withstand high-voltage charge and discharge.

It should be noted that the O3′-type structure or the monoclinic O1(15)-type structure is not obtained in some cases only by addition of the additive element. For example, when x in LiₓCoO₂ is less than or equal to 0.24, lithium cobalt oxide containing magnesium and fluorine or lithium cobalt oxide containing magnesium and aluminum has the O3′-type structure and/or the monoclinic O1(15)-type structure at 60% or more in some cases, and has the H1-3-type structure at 50% or more in other cases, depending on the concentration and distribution of the additive element.

In addition, in the case where x is too small, e.g., 0.1 or less, or under the condition where charge voltage is higher than 4.9 V, the positive electrode active material 100 of one embodiment of the present invention sometimes has the H1-3-type structure or the trigonal O1-type structure. Thus, determining whether or not a positive electrode active material is the positive electrode active material 100 of one embodiment of the present invention requires analysis of the crystal structure by XRD and other methods and data such as charge capacity or charge voltage.

Note that a positive electrode active material with small x sometimes causes a change in the crystal structure when exposed to the air. For example, the O3′-type structure and the monoclinic O1(15)-type structure change into the H1-3-type structure in some cases. For that reason, all samples subjected to analysis of crystal structures are preferably handled in an inert atmosphere such as an argon atmosphere.

Whether or not the additive element contained in a given positive electrode active material has the above-described distribution can be determined by, for example, analysis using XPS, energy dispersive X-ray spectroscopy (EDX), EPMA (Electron Probe Micro Analysis), or the like.

The crystal structure of the surface portion 100a, the crystal grain boundary 105, or the like can be analyzed by electron diffraction of a cross section of the positive electrode active material 100, for example.

### <<Charge Method>>

Charge for determining whether or not a given composite oxide is the positive electrode active material 100 of one embodiment of the present invention can be performed on a coin cell (CR2032 type with a diameter of 20 mm and a height of 3.2 mm) with a lithium counter electrode, for example

More specifically, a positive electrode can be formed by application of slurry in which the positive electrode active material, a conductive material, and a binder are mixed to a positive electrode current collector made of aluminum foil.

A lithium metal can be used for a counter electrode. Note that when the counter electrode is formed using a material other than the lithium metal, the potential of a secondary battery differs from the potential of the positive electrode. Unless otherwise specified, the voltage and the potential in this specification and the like refer to the potential of a positive electrode.

As an electrolyte contained in the electrolyte solution, 1 mol/L lithium hexafluorophosphate (LiPF₆) can be used. As the electrolyte solution, an electrolyte solution in which ethylene carbonate (EC) and diethyl carbonate (DEC) at EC:DEC=3:7 (volume ratio) and vinylene carbonate (VC) at 2 wt % are mixed can be used.

As a separator, a 25-μm-thick polypropylene porous film can be used.

Stainless steel (SUS) can be used for a positive electrode can and a negative electrode can.

The coin cell fabricated under the above conditions is charged with a given voltage (e.g., 4.5 V, 4.55 V, 4.6 V, 4.65 V, 4.7 V, 4.75 V, or 4.8 V). The charging method is not particularly limited as long as charging with a given voltage can be performed for sufficient time. In the case of CCCV charge, for example, CC (constant current) charge can be performed with a current higher than or equal to 20 mA/g and lower than or equal to 100 mA/g. CV charging can be ended with a current higher than or equal to 2 mA/g and lower than or equal to 10 mA/g. To observe a phase change of the positive electrode active material, charging with such a small current value is preferably performed. Meanwhile, in the case where a current does not reach higher than or equal to 2 mA/g and lower than or equal to 10 mA/g even when CV charge is performed for a long time, the CV charge may be ended after the sufficient time passes from the start because the current is probably consumed not for charging the positive electrode active material but for decomposing the electrolyte solution. The sufficient time in this case can be longer than or equal to 1.5 hours and shorter than or equal to 3 hours. The temperature is set to 25° C. or 45° C. After charge is performed in this manner, the coin cell is disassembled in a glove box with an argon atmosphere to take out the positive electrode, whereby the positive electrode active material with predetermined charge capacity can be obtained. In order to inhibit a reaction with components in the external environment, the positive electrode is preferably enclosed in an argon atmosphere in performing various analyses later. For example, XRD can be performed on the positive electrode enclosed in an airtight container with an argon atmosphere. After charging is completed, the positive electrode is preferably taken out immediately and subjected to the analysis. Specifically, the positive electrode is preferably subjected to analysis within an hour, further preferably within 30 minutes after the completion of charging.

In the case where the crystal structure in a charged state after charge and discharge are performed multiple times is analyzed, the conditions of the charge and discharge performed multiple times may be different from the above-described charge conditions. For example, the charging can be performed by constant current charging with a current value greater than or equal to 20 mA/g and less than or equal to 100 mA/g to a given voltage (e.g., 4.6 V, 4.65 V, 4.7 V, 4.75 V, or 4.8 V) and then constant voltage charging until the current value becomes greater than or equal to 2 mA/g and less than or equal to 10 mA/g. The discharging can be performed by constant current discharging with greater than or equal to 20 mA/g and less than or equal to 100 mA/g to 2.5 V.

Also in the case where the crystal structure in a discharged state after the charging and discharging are performed multiple times is analyzed, constant current discharging can be performed with a current value greater than or equal to 20 mA/g and less than or equal to 100 mA/g to 2.5 V, for example.

Note that in this specification and the like, unless otherwise specified, charge and discharge capacity, a charge current, and a discharge current are shown per weight of the positive electrode active material.

### <<XRD>>

The apparatus and conditions for the XRD measurement are not particularly limited. For example, the measurement can be performed using the following apparatus and conditions.
XRD apparatus: D8 ADVANCE produced by Bruker AXS
X-ray source: CuKα₁ radiation
Output: 40 kV, 40 mA
Angle of divergence: Div. Slit, 0.5° Detector: LynxEye
Scanning method: 2θ/θ continuous scan
Measurement range (2θ): from 15° to 90°
Step width (2θ): 0.01°
counting time: 1 second/step
Rotation of sample stage: 15 rpm

In the case where the measurement sample is a powder, the sample can be set by, for example, being put in a glass sample holder or being sprinkled on a reflection-free silicon plate to which grease is applied. In the case where the measurement sample is a positive electrode, the sample can be set in such a manner that the positive electrode is attached to a substrate with a double-sided adhesive tape so that the position of the positive electrode active material layer can be adjusted to the measurement plane required by the apparatus.

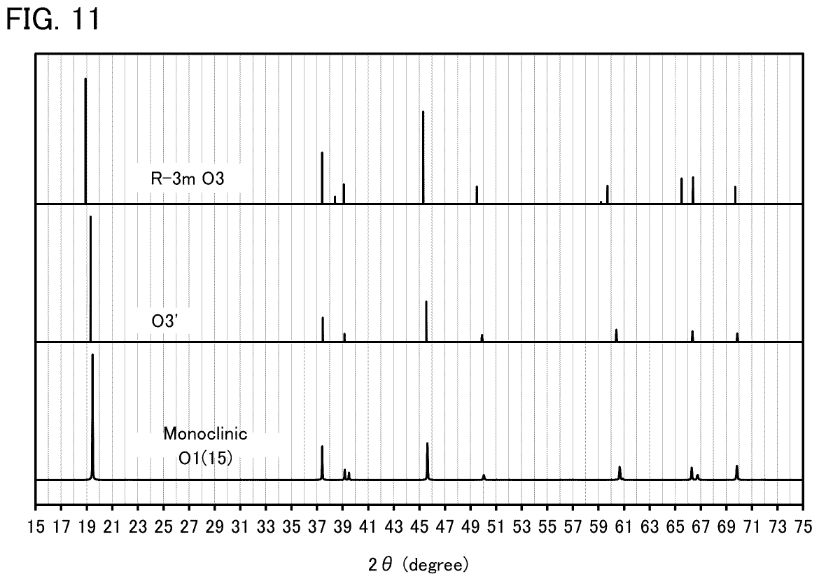

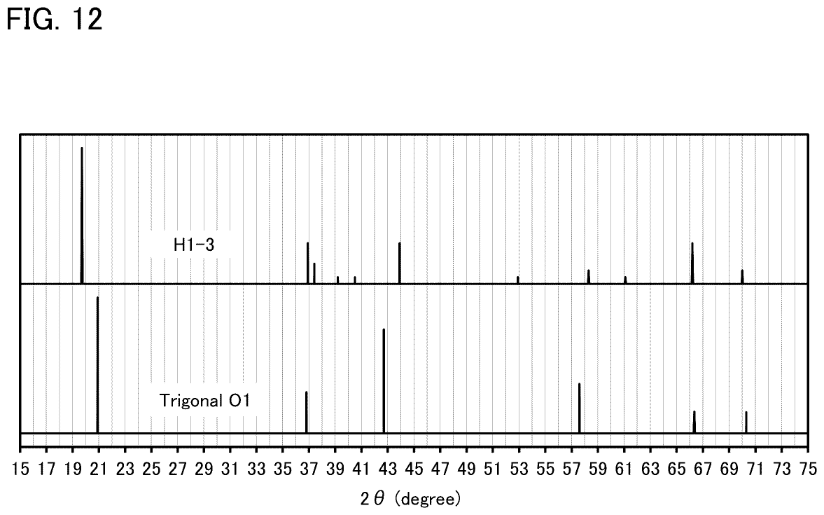

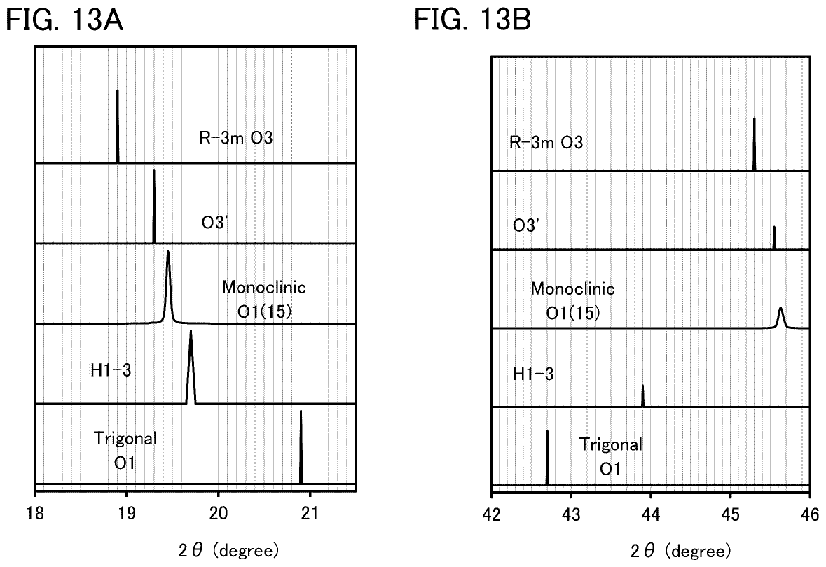

FIG. 11, FIG. 12, FIG. 13A, and FIG. 13B show ideal powder XRD patterns with CuKα₁ radiation that are calculated from models of the O3′-type structure, the monoclinic O1(15)-type structure, and the H1-3-type structure. For comparison, ideal XRD patterns calculated from the crystal structure of LiCoO₂ O3 with x in LiₓCoO₂ of 1 and the crystal structure of the trigonal O1 with x of 0 are also shown. FIG. 13A and FIG. 13B each show the XRD patterns of the O3′-type structure, the monoclinic O1(15)-type structure, and the H1-3-type structure. FIG. 13A and FIG. 13B are enlarged diagrams showing a range of 20 greater than or equal to 18° (degree) and less than or equal to 21° and a range of 20 greater than or equal to 42° and less than or equal to 46°, respectively. Note that the patterns of LiCoO₂ O3 and CoO₂ O1 were made from crystal structure data obtained from ICSD (Inorganic Crystal Structure Database) (see Non-Patent Document 5) with Reflex Powder Diffraction, which is a module of Materials Studio (BIOVIA). The 20 range is from 15° to 75°, the step size is 0.01, the wavelength λ1 is 1.540562×10⁻¹⁰ m, the wavelength 22 is not set, and a single monochromator is used. The pattern of the H1-3-type structure is similarly made from the crystal structure data disclosed in Non-Patent Document 3. The O3′-type structure and the monoclinic O1(15)-type structure are estimated from the XRD pattern of the positive electrode active material of one embodiment of the present invention, the crystal structure is fitted with TOPAS ver. 3 (crystal structure analysis software produced by Bruker Corporation), and the XRD patterns of the O3′-type structure and the monoclinic O1(15)-type structure are made in a manner similar to that for other structures.

As shown in FIG. 11, FIG. 13A, and FIG. 13B, the O3′-type structure exhibits diffraction peaks at 2θ of 19.25±0.12° (greater than or equal to 19.13° and less than 19.37°) and 2ζ of 45.47±0.10° (greater than or equal to 45.37° and less than 45.57°).

Furthermore, the monoclinic O1(15)-type structure exhibits diffraction peaks at 2θ of 19.47±0.10° (greater than or equal to 19.37° and less than or equal to 19.57°) and 2θ of 45.62±0.05° (greater than or equal to 45.57° and less than or equal to 45.67°).

However, as shown in FIG. 12, FIG. 13A, and FIG. 13B, the H1-3-type structure and the trigonal O1 do not exhibit peaks at these positions. Thus, it can be said that exhibiting peaks at greater than or equal to 19.13° and less than 19.37° and/or greater than or equal to 19.37° and less than or equal to 19.57° and at greater than or equal to 45.37° and less than 45.57° and/or greater than or equal to 45.57° and less than or equal to 45.67° in a state with small x in LiₓCoO₂ is the feature of the positive electrode active material 100 of one embodiment of the present invention.

It can also be said that in the positive electrode active material 100 of one embodiment of the present invention, the XRD diffraction peaks exhibited by the crystal structure with x=1 and the crystal structure with x≤0.24 appear at close positions. More specifically, it can be said that a difference in 2θ between the main diffraction peak exhibited by the crystal structure with x=1 and the main diffraction peak exhibited by the crystal structure with x≤0.24, which are exhibited at 2θ of greater than or equal to 42° and less than or equal to 46°, is less than or equal to 0.7°, preferably less than or equal to 0.5°.

Although the positive electrode active material 100 of one embodiment of the present invention has the O3′-type structure and/or the monoclinic O1(15)-type structure when x in LiₓCoO₂ is small, not all particles necessarily have the O3′-type structure and/or the monoclinic O1(15)-type structure. The positive electrode active material may include another crystal structure or may be partly amorphous. Note that when the XRD patterns are subjected to the Rietveld analysis, the O3′-type structure and/or the monoclinic O1(15)-type structure preferably account(s) for greater than or equal to 50%, further preferably greater than or equal to 60%, still further preferably greater than or equal to 66%. The positive electrode active material in which the O3′-type structure and/or the monoclinic O1(15)-type structure account(s) for greater than or equal to 50%, preferably greater than or equal to 60%, further preferably greater than or equal to 66% can achieve sufficiently good cycle performance.

In addition, the H1-3-type structure and the O1-type structure account for preferably less than or equal to 50% in the Rietveld analysis performed in a similar manner. Alternatively, the H1-3-type structure and the O1-type structure account for preferably less than or equal to 34%. It is still further preferable that substantially no H1-3-type structure and substantially no O1-type structure be observed.

Furthermore, even after 100 or more cycles of charging and discharging after the measurement starts, the O3′-type structure and/or the monoclinic O1(15)-type structure preferably account for more than or equal to 35%, further preferably more than or equal to 40%, still further preferably more than or equal to 43% when the Rietveld analysis is performed.

Sharpness of a diffraction peak in an XRD pattern indicates the degree of crystallinity. It is thus preferable that the diffraction peaks after charging be sharp, in other words, have a small half width. For example, the full width at half maximum is preferably small. Even peaks that are derived from the same crystal phase have different half widths depending on the XRD measurement conditions and the 20 value. In the case of the above-described measurement conditions, the peak observed at 2θ of greater than or equal to 43° and less than or equal to 46° preferably has a full width at half maximum of less than or equal to 0.2°, further preferably less than or equal to 0.15°, still further preferably less than or equal to 0.12°. Note that not all peaks need to fulfill the requirement. A crystal phase can be regarded as having high crystallinity when one or more peaks fulfill the requirement. Such high crystallinity contributes to stability of the crystal structure after sufficient charge.

The crystallite sizes of the O3′-type structure and the monoclinic O1(15)-type structure included in the positive electrode active material 100 do not decrease to less than approximately one-twentieth that of LiCoO₂ (O3) in a discharged state. Thus, a clear peak of the O3′-type structure and/or the monoclinic O1(15)-type structure can be observed when x in LiₓCoO₂ is small, even under the same XRD measurement conditions as those of a positive electrode before charging and discharging. In contrast, conventional LiCoO₂ has a small crystallite size and a broad and small peak even when it can have a structure part of which is similar to the O3′-type structure and/or the monoclinic O1(15)-type structure. The crystallite size can be calculated from the half width of the XRD peak.

As described above, the influence of the Jahn-Teller effect is preferably small in the positive electrode active material 100 of one embodiment of the present invention. The positive electrode active material 100 may contain a transition metal such as nickel or manganese as the additive element in addition to cobalt as long as the influence of the Jahn-Teller effect is small. The proportions of nickel and manganese and the range of the lattice constants in each of which the influence of the Jahn-Teller effect is presumed to be small in the positive electrode active material are examined by XRD analysis.

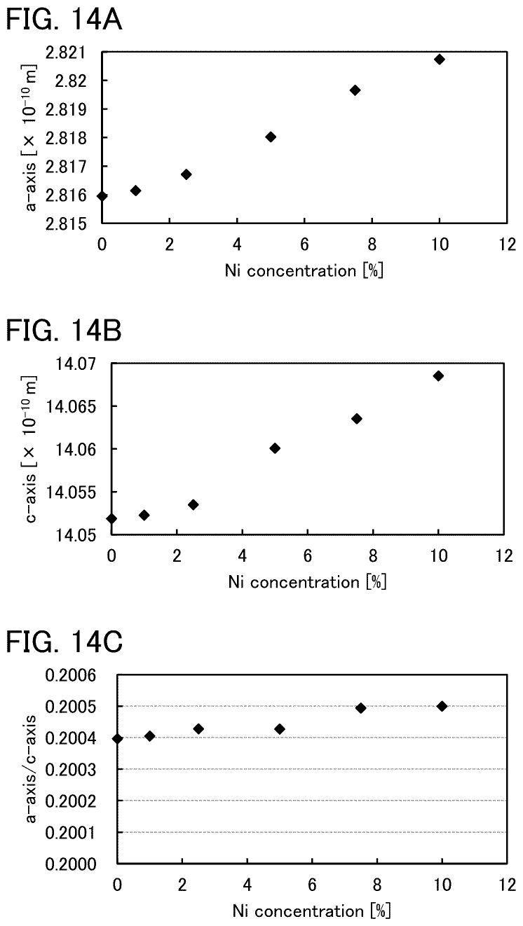

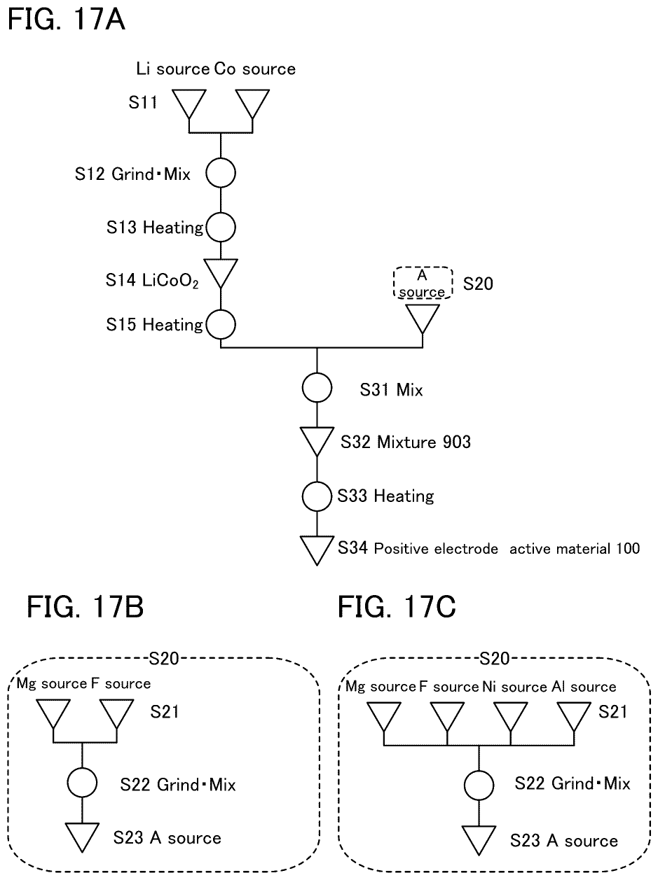

FIG. 14 shows the calculation results of the lattice constants of the a-axis and the c-axis by XRD in the case where the positive electrode active material 100 of one embodiment of the present invention has a layered rock-salt crystal structure and contains cobalt and nickel. FIG. 14A shows the results of the a-axis, and FIG. 14B shows the results of the c-axis. Note that the XRD patterns of a powder after the synthesis of the positive electrode active material before incorporation into a positive electrode are used for the calculation. The nickel concentration on the horizontal axis represents a nickel concentration with the sum of cobalt atoms and nickel atoms assumed as 100%. The positive electrode active material was formed in accordance with the formation method in FIG. 17 except that the aluminum source was not used.

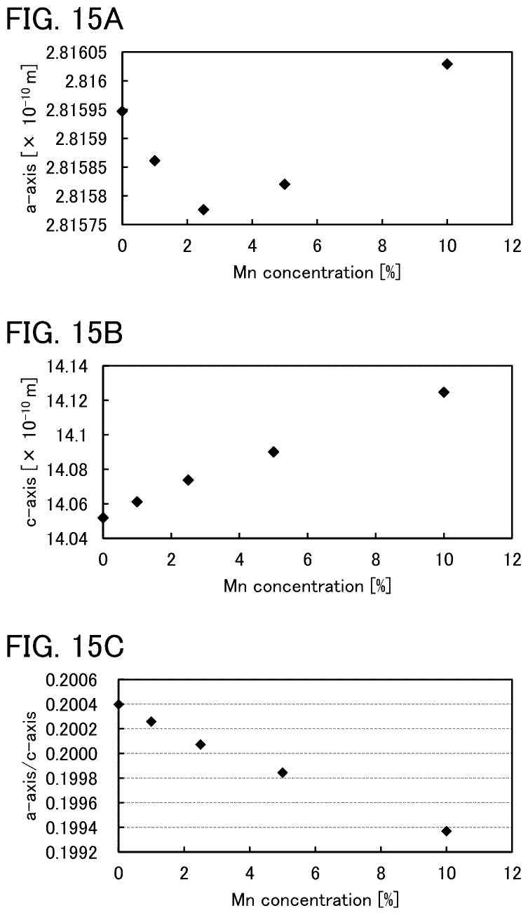

FIG. 15 shows the estimation results of the lattice constants of the a-axis and the c-axis by XRD in the case where the positive electrode active material 100 of one embodiment of the present invention has a layered rock-salt crystal structure and contains cobalt and manganese. FIG. 15A shows the results of the a-axis, and FIG. 15B shows the results of the c-axis. Note that the lattice constants shown in FIG. 15 were obtained by XRD of a powder after the synthesis of the positive electrode active material before incorporation into a positive electrode. The manganese concentration on the horizontal axis represents a manganese concentration with the sum of cobalt atoms and manganese atoms assumed as 100%. The positive electrode active material was formed in accordance with the formation method of FIG. 17 except that a manganese source was used instead of the nickel source and the aluminum source was not used.

FIG. 14C shows values obtained by dividing the lattice constants of the a-axis by the lattice constants of the c-axis (a-axis/c-axis) in the positive electrode active material, whose results of the lattice constants are shown in FIG. 14A and FIG. 14B. FIG. 15C shows values obtained by dividing the lattice constants of the a-axis by the lattice constants of the c-axis (a-axis/c-axis) in the positive electrode active material, whose results of the lattice constants are shown in FIG. 15A and FIG. 15B.

As shown in FIG. 14C, the value of a-axis/c-axis tends to significantly change between nickel concentrations of 5% and 7.5%, and the distortion of the a-axis becomes large at a nickel concentration of 7.5%. This distortion may be derived from the Jahn-Teller distortion of trivalent nickel. It is suggested that an excellent positive electrode active material with small Jahn-Teller distortion can be obtained at a nickel concentration of lower than 7.5%.

FIG. 15A indicates that the lattice constant changes differently at manganese concentrations of 5% or higher and does not follow the Vegard's law. This suggests that the crystal structure changes at a manganese concentration of 5% or higher. Thus, the manganese concentration is preferably 4% or lower, for example.

Note that the nickel concentration and the manganese concentration in the surface portion 100a are not limited to the above ranges. In other words, the nickel concentration and the manganese concentration in the surface portion 100a may be higher than the above concentrations in some cases.

Preferable ranges of the lattice constants of the positive electrode active material of one embodiment of the present invention are examined above. In the layered rock-salt crystal structure of the positive electrode active material 100 in a discharged state or a state where charging and discharging are not performed, which can be estimated from the XRD patterns, the a-axis lattice constant is preferably greater than 2.814×10⁻¹⁰ m and less than 2.817×10⁻¹⁰ m, and the c-axis lattice constant is preferably greater than 14.05×10⁻¹⁰ m and less than 14.07×10⁻¹⁰ m. The state where charging and discharging are not performed may be, for example, the state of a powder before the formation of a positive electrode of a secondary battery.

Alternatively, in the layered rock-salt crystal structure of the positive electrode active material 100 in the discharged state or the state where charging and discharging are not performed, the value obtained by dividing the lattice constant of the a-axis by the lattice constant of the c-axis (a-axis/c-axis) is preferably greater than 0.20000 and less than 0.20049.

Alternatively, when the layered rock-salt crystal structure of the positive electrode active material 100 in the discharged state or the state where charging and discharging are not performed is subjected to XRD analysis, a first peak is observed at 2θ of greater than or equal to 18.50° and less than or equal to 19.30° and a second peak is observed at 2θ of greater than or equal to 38.00° and less than or equal to 38.80°, in some cases.

### <<XPS>>

In an inorganic oxide, a region ranging from the surface to a depth of approximately 2 nm to 8 nm (normally, less than or equal to 5 nm) can be analyzed by X-ray photoelectron spectroscopy (XPS) using monochromatic aluminum Kα radiation as an X-ray source; thus, the concentrations of elements in a region ranging to approximately half the depth of the surface portion 100a can be quantitatively analyzed by XPS. The bonding states of the elements can be analyzed by narrow scanning. Note that the quantitative accuracy of XPS is approximately ±1 atomic % in many cases. The lower detection limit is approximately 1 atomic % but depends on the element.

In the positive electrode active material 100 of one embodiment of the present invention, the concentration of one or two or more selected from the additive elements is preferably higher in the surface portion 100a than in the inner portion 100b. This means that the concentration of one or two or more selected from the additive elements in the surface portion 100a is preferably higher than the average concentration of the selected element(s) in the entire positive electrode active material 100. For this reason, for example, it can be said that the concentration of one or two or more additive elements selected from the surface portion 100a, which is measured by XPS or the like, is preferably higher than the average concentration of the additive element(s) in the entire positive electrode active material 100, which is measured by ICP-MS (inductively coupled plasma-mass spectrometry), GD-MS (glow discharge mass spectrometry), or the like. For example, the concentration of magnesium in at least part of the surface portion 100a, which is measured by XPS or the like, is preferably higher than the average concentration of magnesium in the entire positive electrode active material 100. The concentration of nickel in at least part of the surface portion 100a is preferably higher than the average concentration of nickel in the entire positive electrode active material 100. The concentration of aluminum in at least part of the surface portion 100a is preferably higher than the average concentration of aluminum in the entire positive electrode active material 100. The concentration of fluorine in at least part of the surface portion 100a is preferably higher than the average concentration of fluorine in the entire positive electrode active material 100.

Note that the surface and the surface portion 100a of the positive electrode active material 100 of one embodiment of the present invention do not contain a carbonate, a hydroxy group, or the like which is chemically adsorbed after formation of the positive electrode active material 100. Furthermore, an electrolyte solution, a binder, a conductive material, and a compound originating from any of these that are attached to the surface of the positive electrode active material 100 are not included either. Thus, in quantitative analysis of the elements contained in the positive electrode active material, correction may be performed to exclude carbon, hydrogen, excess oxygen, excess fluorine, and the like that might be detected in surface analysis such as XPS. For example, in XPS, the kinds of bonds can be identified by analysis, and a C—F bond originating from a binder may be excluded by correction.

Furthermore, before any of various kinds of analyses is performed, a sample of a positive electrode active material or a positive electrode active material layer or the like may be washed, for example, to eliminate an electrolyte solution, a binder, a conductive material, and a compound originating from any of these that are attached to the surface of the positive electrode active material. Although lithium might be dissolved into a solvent or the like used in the washing at this time, the additive element is not easily dissolved even in that case; thus, the atomic ratio of the additive element is not affected.

The concentration of the additive element may be compared using the ratio of the additive element to cobalt. The ratio of the additive element to cobalt is preferably used, in which case comparison can be performed while reducing the influence of a carbonate or the like that is chemically adsorbed after formation of the positive electrode active material. For example, in the XPS analysis, the atomic ratio of magnesium to cobalt (Mg/Co) is preferably greater than or equal to 0.4 and less than or equal to 1.5. In the ICP-MS analysis, Mg/Co is preferably greater than or equal to 0.001 and less than or equal to 0.06.

Similarly, to secure the sufficient path through which lithium is inserted and extracted, the concentrations of lithium and cobalt are preferably higher than those of the additive elements in the surface portion 100a of the positive electrode active material 100. It can be said that the concentrations of lithium and cobalt in the surface portion 100a are preferably higher than that of one or two or more selected from the additive elements contained in the surface portion 100a, which is measured by XPS or the like. For example, the concentration of cobalt in at least part of the surface portion 100a, which is measured by XPS or the like, is preferably higher than the concentration of magnesium in at least part of the surface portion 100a, which is measured by XPS or the like. Similarly, the concentration of lithium is preferably higher than the concentration of magnesium. In addition, the concentration of cobalt is preferably higher than the concentration of nickel. Similarly, the concentration of lithium is preferably higher than the concentration of nickel. The concentration of cobalt is preferably higher than the concentration of aluminum. Similarly, the concentration of lithium is preferably higher than the concentration of aluminum. The concentration of cobalt is preferably higher than the concentration of fluorine. Similarly, the concentration of lithium s preferably higher the concentration of fluorine.

It is further preferable that aluminum be widely distributed in a region ranging from the surface or the reference point to a depth of from 5 nm to 50 nm, both inclusive, for example. Therefore, it is further preferable that the concentration of aluminum be lower than or equal to 1 at % or no aluminum be detected by XPS or the like although aluminum is detected by analysis on the entire positive electrode active material 100 by ICP-MS, GD-MS, or the like.

Furthermore, when XPS analysis is performed on the positive electrode active material 100 of one embodiment of the present invention, the number of magnesium atoms is preferably greater than or equal to 0.4 times and less than or equal to 1.2 times, further preferably greater than or equal to 0.65 times and less than or equal to 1.0 times the number of cobalt atoms. The number of nickel atoms is preferably less than or equal to 0.15 times, further preferably greater than or equal to 0.03 times and less than or equal to 0.13 times the number of cobalt atoms. The number of aluminum atoms is preferably less than or equal to 0.12 times, further preferably less than or equal to 0.09 times the number of cobalt atoms. The number of fluorine atoms is preferably greater than or equal to 0.3 times and less than or equal to 0.9 times, further preferably greater than or equal to 0.1 times and less than or equal to 1.1 times the number of cobalt atoms. When the number is within the above range, it can be said that the additive element is not attached to the surface of the positive electrode active material 100 in a narrow range but widely distributed at a preferable concentration in the surface portion 100a of the positive electrode active material 100.

In the XPS analysis, monochromatic aluminum Kα radiation can be used as an X-ray source, for example. An extraction angle is, for example, 45°. For example, the measurement can be performed using the following apparatus and conditions.
Measurement apparatus: Quantera II produced by PHI, Inc.
X-ray source: monochromatic Al Kα (1486.6 eV)
Detection area: 100 μmφ
Detection depth: approximately 4 to 5 nm (extraction angle 45°)
Measurement spectrum: wide scanning, narrow scanning of each detected element

In addition, when the positive electrode active material 100 of one embodiment of the present invention is analyzed by XPS, a peak indicating the bonding energy of fluorine with another element is preferably at greater than or equal to 682 eV and less than 685 eV, further preferably approximately 684.3 eV. The above value is different from 685 eV, which is the bonding energy of lithium fluoride, and 686 eV, which is the bonding energy of magnesium fluoride.

Furthermore, when the positive electrode active material 100 of one embodiment of the present invention is analyzed by XPS, a peak indicating the bonding energy of magnesium with another element is preferably at greater than or equal to 1302 eV and less than 1304 eV, further preferably at approximately 1303 eV. The above value is different from 1305 eV, which is the bonding energy of magnesium fluoride, and is close to the bonding energy of magnesium oxide.

### <<EDX>>

The one or two or more selected from the additive elements contained in the positive electrode active material 100 preferably have a concentration gradient. It is further preferable that the additive elements contained in the positive electrode active material 100 exhibit concentration peaks at different depths from the surface. The concentration gradient of the additive element can be evaluated by exposing a cross section of the positive electrode active material 100 using FIB (Focused Ion Beam) or the like and analyzing the cross section using energy dispersive X-ray spectroscopy (EDX), EPMA (electron probe microanalysis), or the like.

In the EDX measurement, to measure a region while scanning is performed and evaluate the region two-dimensionally is referred to as EDX area analysis. The measurement for evaluation of the atomic concentration distribution in a positive electrode active material by line scan is referred to as line analysis. Furthermore, extracting data of a linear region from EDX area analysis is referred to as line analysis in some cases. The measurement of a region without scanning is referred to as point analysis.

By EDX area analysis (e.g., element mapping), the concentrations of the additive element in the surface portion 100a, the inner portion 100b, the vicinity of the crystal grain boundary 105, and the like of the positive electrode active material 100 can be quantitatively analyzed. By EDX line analysis, the concentration distribution and the highest concentration of the additive element can be analyzed. An analysis method in which a thinned sample is used, such as STEM-EDX, is preferred because the method makes it possible to analyze the concentration distribution in the depth direction from the surface toward the center in a specific region of the positive electrode active material regardless of the distribution in the front-back direction.

Since the positive electrode active material 100 is a compound containing oxygen and a transition metal into and from which lithium can be inserted and extracted, an interface between a region where oxygen and the transition metal M (Co, Ni, Mn, Fe, or the like) that is oxidized or reduced due to insertion and extraction of lithium are present and a region where oxygen and the transition metal M are absent is considered as the surface of the positive electrode active material. When the positive electrode active material is analyzed, a protective film is attached on its surface in some cases; however, the protective film is not included in the positive electrode active material. As the protective film, a single-layer film or a multilayer film of carbon, a metal, an oxide, a resin, or the like is sometimes used.

In a STEM-EDX line analysis or the like, it is sometimes difficult to precisely determine the surface because a steep change in a profile of an element is not seen in principle or due to a measurement error. Therefore, when the depth direction in a STEM-EDX line analysis or the like is mentioned, a reference point is a point where a value of the amount of the detected transition metal M is equal to 50% of the sum of the average value M_{AVE} of the amount of the detected transition metal M in the inner portion and the average value M_{BG} of the amount of the background transition metal M and a point where a value of the amount of the detected oxygen is equal to 50% of the sum of the average value O_{AVE} of the amount of detected oxygen in the inner portion and the average value O_{BG} of the amount of background oxygen. Note that in the case where the positions of the points differ between the transition metal M and oxygen, the difference is probably due to the influence of a carbonate, a metal oxide containing oxygen, or the like, which is attached to the surface. Thus, the point that is equal to 50% of the sum of the average value M_{AVE} of the amount of the detected transition metal M in the inner portion and the average value M_{BG} of the amount of the background transition metal M can be used. In the case of a positive electrode active material containing a plurality of transition metals M, the reference point can be determined using M_{AVE} and M_{BG} of an element whose count number is the largest in the inner portion 100b.

The average value M_{BG} of the amount of the background transition metal M can be calculated by averaging the amount in the range greater than or equal to 2 nm, preferably greater than or equal to 3 nm, which is outside a portion of the positive electrode active material in the vicinity of the portion at which the amount of the detected transition metal M begins to increase, for example. The average value M_{AVE} of the amount of the detected transition metal M in the inner portion can be calculated by averaging the amount in the range greater than or equal to 2 nm, preferably greater than or equal to 3 nm in a region where the count numbers of the transition metals M and oxygen atoms are saturated and stabilized, e.g., a portion that is greater than or equal to 30 nm, preferably greater than 50 nm in depth from the portion where the amount of the detected transition metal M begins to increase, for example. The average value O_{BG} of the amount of background oxygen and the average value O_{AVE} of the amount of detected oxygen in the inner portion can be calculated in a similar manner.

The surface of the positive electrode active material 100 in, for example, a cross-sectional STEM (scanning transmission electron microscope) image is a boundary between a region where an image derived from the crystal structure of the positive electrode active material is observed and a region where the image is not observed, and is determined as the outermost surface of a region where an atomic column derived from an atomic nucleus of a metal element that has a greater atomic number than lithium among the metal elements constituting the positive electrode active material is confirmed. Alternatively, the surface refers to an intersection of a tangent drawn at a luminance profile from the surface toward the bulk and an axis in the depth direction in a STEM image. The surface in a STEM image or the like may be judged in combination with analysis with higher spatial resolution.

The spatial resolution of STEM-EDX is approximately 1 nm. Thus, the maximum value of an additive element profile may be shifted by approximately 1 nm. For example, even when the maximum value of the profile of an additive element such as magnesium is outside the surface determined in the above-described manner, it can be said that a difference between the maximum value and the surface can be referred to as within the margin of error as long as the difference is less than 1 nm.

A peak in STEM-EDX line analysis refers to the maximum value of the detection intensity in each element profile or the maximum value of the characteristic X-ray of each element. As a noise in STEM-EDX line analysis, a measured value having a half width smaller than or equal to spatial resolution (R), for example, smaller than or equal to R/2 can be given.

The adverse effect of a noise can be reduced by scanning the same portion a plurality of times under the same conditions. For example, an integrated value obtained by measurement by scanning six times can be used as the profile of each element. The number of scanning is not limited to six and an average obtained by performing scanning seven or more times can be used as the profile of each element.

STEM-EDX line analysis can be performed as follows, for example. First, a protective film is deposited over a surface of a positive electrode active material. For example, carbon can be deposited with an ion sputter apparatus (MC1000, produced by Hitachi High-Tech Corporation).

Next, the positive electrode active material is thinned to fabricate a cross-section sample to be subjected to STEM analysis. For example, the positive electrode active material can be thinned with an FIB-SEM apparatus (XVision 200TBS, produced by Hitachi High-Tech Corporation). Here, picking up can be performed by a micro probing system (MPS), and an accelerating voltage at final processing condition can be, for example, 10 kV.

The STEM-EDX line analysis can be performed using (HD-2700 produced by Hitachi High-Tech Corporation) as a STEM apparatus and Octane T Ultra W (with two detectors) produced by EDAX Inc as EDX detectors. In the EDX line analysis, the emission current of the STEM apparatus is set to be higher than or equal to 6 μA and lower than or equal to 10 μA, and a portion of the thinned sample, which is not positioned at a deep level and has little unevenness, is measured. The magnification is 150,000 times, for example. The EDX line analysis can be performed under conditions where drift correction is performed, the line width is 42 nm, the pitch is 0.2 nm, and the number of frames is six or more.

EDX area analysis or EDX point analysis of the positive electrode active material 100 of one embodiment of the present invention preferably reveals that the concentration of each additive element, in particular, an additive element X in the surface portion 100a is higher than that in the inner portion 100b.

For example, EDX area analysis or EDX point analysis of the positive electrode active material 100 containing magnesium as the additive element preferably reveals that the concentration of magnesium in the surface portion 100a is higher than that in the inner portion 100b. In the EDX line analysis, a peak of the concentration of magnesium in the surface portion 100a is preferably located in a region ranging, toward the center of the positive electrode active material 100, from the surface thereof or the reference point to a depth of 3 nm, further preferably a depth of 1 nm, still further preferably a depth of 0.5 nm. In addition, the concentration of magnesium preferably attenuates, at a depth of 1 nm from the point where the concentration reaches the peak, to less than or equal to 60% of the peak concentration. In addition, the concentration of magnesium preferably attenuates, at a depth of 2 nm from the point where the concentration reaches the peak, to less than or equal to 30% of the peak concentration. Here, a “peak of concentration” refers to the local maximum value of concentration.

In the EDX line analysis, the magnesium concentration (the detected amount of magnesium/the sum of the detected amounts of magnesium, oxygen, cobalt, fluorine, aluminum, and silicon) in the surface portion 100a is preferably higher than or equal to 0.5 atom % and lower than or equal to 10 atom %, further preferably higher than or equal to 1 atom % and lower than or equal to 5 atom %.

When the positive electrode active material 100 contains magnesium and fluorine as the additive elements, the distribution of fluorine preferably overlaps with the distribution of magnesium. For example, a difference in the depth direction between a peak of the concentration of fluorine and a peak of the concentration of magnesium is preferably within 10 nm, further preferably within 3 nm, still further preferably within 1 nm.

In the EDX line analysis, a peak of the concentration of fluorine in the surface portion 100a is preferably located in a region ranging, toward the center of the positive electrode active material 100, from the surface thereof or the reference point to a depth of 3 nm, further preferably a depth of 1 nm, still further preferably a depth of 0.5 nm. It is further preferable that a peak of the concentration of fluorine be exhibited slightly closer to the surface side than a peak of the concentration of magnesium is, which increases resistance to hydrofluoric acid. For example, it is preferable that a peak of the concentration of fluorine be exhibited slightly closer to the surface side than a peak of the concentration of magnesium is by 0.5 nm or more, further preferably 1.5 nm or more.

When the positive electrode active material 100 contains nickel as the additive element, a peak of the concentration of nickel in the surface portion 100a is preferably located in a region ranging, toward the center of the positive electrode active material 100, from the surface thereof or the reference point to a depth of 3 nm, further preferably 1 nm, still further preferably 0.5 nm. When the positive electrode active material 100 contains magnesium and nickel, the distribution of nickel preferably overlaps with the distribution of magnesium. For example, a difference in the depth direction between a peak of the concentration of nickel and a peak of the concentration of magnesium is preferably within 3 nm, further preferably within 1 nm.

In the case where the positive electrode active material 100 contains aluminum as the additive element, the peak concentration of magnesium, nickel, or fluorine is preferably closer to the surface than the peak concentration of aluminum is in the surface portion 100a in the EDX line analysis. For example, the peak of the concentration of aluminum is preferably located in a region ranging from the surface of the positive electrode active material 100 or the reference point to a depth of from 0.5 nm to 50 nm, both inclusive, further preferably a depth of from 5 nm and to 50 nm, both inclusive, toward the center of the positive electrode active material 100.

EDX line, area, or point analysis of the positive electrode active material 100 preferably reveals that the atomic ratio of magnesium to cobalt (Mg/Co) at a peak of the concentration of magnesium is preferably greater than or equal to 0.05 and less than or equal to 0.6, further preferably greater than or equal to 0.1 and less than or equal to 0.4. The atomic ratio of aluminum to cobalt (Al/Co) at a peak of the concentration of aluminum is preferably greater than or equal to 0.05 and less than or equal to 0.6, further preferably greater than or equal to 0.1 and less than or equal to 0.45. The atomic ratio of nickel to cobalt (Ni/Co) at a peak of the concentration of nickel is preferably higher than or equal to 0 and lower than or equal to 0.2, further preferably higher than or equal to 0.01 and lower than or equal to 0.1. The atomic ratio of fluorine to cobalt (F/Co) at a peak of the concentration of fluorine is preferably higher than or equal to 0 and lower than or equal to 1.6, further preferably higher than or equal to 0.1 and lower than or equal to 1.4.

When the line analysis or the area analysis is performed on the positive electrode active material 100, the atomic ratio of an additive element A to cobalt Co (A/Co) in the vicinity of the crystal grain boundary 105 is preferably greater than or equal to 0.020 and less than or equal to 0.50. Alternatively, it is preferably greater than or equal to 0.025 and less than or equal to 0.30. Alternatively, it is preferably greater than or equal to 0.030 and less than or equal to 0.20. Alternatively, it is preferably greater than or equal to 0.020 and less than or equal to 0.30. Alternatively, it is preferably greater than or equal to 0.020 and less than or equal to 0.20. Alternatively, it is preferably greater than or equal to 0.025 and less than or equal to 0.50. Alternatively, it is preferably greater than or equal to 0.025 and less than or equal to 0.20. Alternatively, it is preferably greater than or equal to 0.030 and less than or equal to 0.50.

Alternatively, it is preferably greater than or equal to 0.030 and less than or equal to 0.30.

When the line analysis or the area analysis is performed on the positive electrode active material 100 containing magnesium as the additive element, the atomic ratio of magnesium to cobalt (Mg/Co) in the vicinity of the crystal grain boundary 105 is preferably greater than or equal to 0.020 and less than or equal to 0.50. Alternatively, it is preferably greater than or equal to 0.025 and less than or equal to 0.30. Alternatively, it is preferably greater than or equal to 0.030 and less than or equal to 0.20. Alternatively, it is preferably greater than or equal to 0.020 and less than or equal to 0.30. Alternatively, it is preferably greater than or equal to 0.020 and less than or equal to 0.20. Alternatively, it is preferably greater than or equal to 0.025 and less than or equal to 0.50. Alternatively, it is preferably greater than or equal to 0.025 and less than or equal to 0.20. Alternatively, it is preferably greater than or equal to 0.030 and less than or equal to 0.50. Alternatively, it is preferably greater than or equal to 0.030 and less than or equal to 0.30. When the ratio is within the above range in a plurality of portions, e.g., three or more portions of the positive electrode active material 100, it can be said that the additive element is not attached to the surface of the positive electrode active material 100 in a narrow range but widely distributed at a preferable concentration in the surface portion 100a of the positive electrode active material 100.

### <<EPMA>>

Quantitative analysis of elements can be conducted also by EPMA (electron probe microanalysis). In area analysis, distribution of each element can be analyzed.

EPMA area analysis of a cross section of the positive electrode active material 100 of one embodiment of the present invention preferably reveals that one or two or more selected from the additive elements have a concentration gradient, as in the EDX analysis. For example, it is further preferable that the additive elements exhibit concentration peaks at different depths from a surface. The preferable ranges of the concentration peaks of the additive elements are the same as those of the case of EDX.

Note that in EPMA, a region from a surface to a depth of approximately 1 μm is analyzed. Thus, the quantitative value of each element is sometimes different from measurement results obtained by other analysis methods. For example, when surface analysis is performed by EPMA on the positive electrode active material 100, the concentration of the additive element existing in the surface portion 100a might be lower than the results obtained in XPS.

### <<Raman Spectroscopy>>

As described above, at least part of the surface portion 100a of the positive electrode active material 100 of one embodiment of the present invention preferably has the rock-salt crystal structure. Thus, when the positive electrode active material 100 and a positive electrode including the positive electrode active material 100 are analyzed by Raman spectroscopy, a cubic crystal structure such as a rock-salt crystal structure is preferably observed in addition to a layered rock-salt crystal structure. In a STEM image and a nanobeam electron diffraction pattern described later, a bright spot cannot be detected when cobalt that is substituted at a lithium site, cobalt that exists at a site coordinated to four oxygen atoms, or the like does not appear with a certain frequency in the depth direction in observation. Meanwhile, Raman spectroscopy observes a vibration mode of a bond such as a Co—O bond, so that even when the number of Co—O bonds is small, a peak of a wave number of a vibration mode corresponding to the Co—O bond can be observed in some cases. Furthermore, since Raman spectroscopy can measure a range with an area of several square micrometers and a depth of approximately 1 μm of a surface portion, a Co—O bond only at the surface of a particle can be observed with high sensitivity.

When a laser wavelength is 532 nm, for example, peaks (vibration mode: E_{g}, A_{1g}) of LiCoO₂ having a layered rock-salt crystal structure are observed in ranges from 470 cm⁻¹ to 490 cm⁻¹ and from 580 cm⁻¹ to 600 cm⁻¹. Meanwhile, a peak (vibration mode: A_{1g}) of cubic CoOₓ (0<x<1) (Co_{1-y}O having a rock-salt crystal structure (0<y<1) or Co₃O₄ having a spinel crystal structure) is observed in a range from 665 cm⁻¹ to 685 cm⁻¹.

Thus, in the case where the integrated intensities of the peak in the range from 470 cm⁻¹ to 490 cm⁻¹, the peak in the range from 580 cm⁻¹ to 600 cm⁻¹, and the peak in the range from 665 cm⁻¹ to 685 cm⁻¹ are represented by I1, I2, and I3, respectively, I3/I2 is preferably greater than or equal to 1% and less than or equal to 10%, further preferably greater than or equal to 3% and less than or equal to 9%.

In the case where a cubic crystal structure such as a rock-salt crystal structure is observed in the above-described range, it can be said that a preferable range of the surface portion 100a of the positive electrode active material 100 has a rock-salt crystal structure.

### <<Nanobeam Electron Diffraction Pattern>>

As in Raman spectroscopy, features of both a layered rock-salt crystal structure and a rock-salt crystal structure are preferably observed in a nanobeam electron diffraction pattern. Note that in consideration of the above-described difference in sensitivity, in a STEM image and a nanobeam electron diffraction pattern, it is preferable that the features of a rock-salt crystal structure not be too significant at the surface portion 100a, in particular, the outermost surface (e.g., a portion from the surface to a depth of 1 nm). This is because a diffusion path of lithium can be secured and a function of stabilizing a crystal structure can be enhanced in the case where the additive element such as magnesium exists in the lithium layer while the outermost surface has a layered rock-salt crystal structure as compared with the case where the outermost surface is covered with a rock-salt crystal structure.

Therefore, for example, when a nanobeam electron diffraction pattern of a region ranging from the surface to a depth less than or equal to 1 nm and a nanobeam electron diffraction pattern of a region ranging from the surface to a depth of from 3 nm to 10 nm, both inclusive, are obtained, a difference between lattice constants calculated from the patterns is preferably small.

For example, a difference between lattice constants calculated from a measured portion from the surface to a depth of 1 nm or less and a measured portion from the surface to a depth of 3 nm or more and 10 nm or less is preferably less than or equal to 0.1 Å for the a-axis and less than or equal to 1.0 Å for the c-axis. The difference is further preferably less than or equal to 0.05 Å for the a-axis and further preferably less than or equal to 0.6 Å for the c-axis. The difference is still further preferably less than or equal to 0.04 Å for the a-axis and still further preferably less than or equal to 0.3 Å for the c-axis.

### <<Surface Roughness and Specific Surface Area>

The positive electrode active material 100 of one embodiment of the present invention preferably has a smooth surface with little unevenness. A smooth surface with little unevenness indicates that an effect of a fusing agent described later has adequately functioned and the surfaces of the additive element source and the lithium cobalt oxide have melted. Thus, a smooth surface with little unevenness indicates favorable distribution of the additive element in the surface portion 100a.

A smooth surface with little unevenness can be determined from, for example, a cross-sectional SEM image or a cross-sectional TEM image of the positive electrode active material 100 or the specific surface area of the positive electrode active material 100.

The level of the surface smoothness of the positive electrode active material 100 can be quantified from its cross-sectional SEM image, as described below, for example.

First, the positive electrode active material 100 is processed with an FIB or the like such that its cross section is exposed. At this time, the positive electrode active material 100 is preferably covered with the protective film, a protective agent, or the like. Next, a SEM image of the interface between the positive electrode active material 100 and the protective film or the like is taken. The SEM image is subjected to noise processing using image processing software. For example, the Gaussian Blur (σ=2) is performed, followed by binarization. In addition, interface extraction is performed using image processing software. Moreover, an interface line between the positive electrode active material 100 and the protective film or the like is selected with an automatic selection tool or the like, and data is extracted to spreadsheet software or the like. With the use of the function of the spreadsheet software or the like, correction is performed using regression curves (quadratic regression), parameters for calculating roughness are obtained from data subjected to slope correction, and root-mean-square surface roughness (RMS) is obtained by calculating standard deviation. This surface roughness refers to the surface roughness in at least 400 nm of the particle periphery of the positive electrode active material.

On the surface of the particle of the positive electrode active material 100 of this embodiment, root-mean-square (RMS) surface roughness, which is an index of roughness, is preferably less than 3 nm, further preferably less than 1 nm, still further preferably less than 0.5 nm.

Note that the image processing software used for the noise processing, the interface extraction, or the like is not particularly limited, and for example, “ImageJ” described in Non-Patent Document 9 to Non-Patent Document 11 can be used. In addition, the spreadsheet software or the like is not particularly limited, and Microsoft Office Excel can be used, for example.

For example, the level of surface smoothness of the positive electrode active material 100 can also be quantified from the ratio of an actual specific surface area S_{R} measured by a constant-volume gas adsorption method to an ideal specific surface area Sᵢ.

The ideal specific surface area Sᵢ is calculated on the assumption that all the particles have the same diameter as D50, have the same weight, and have ideal spherical shapes. The median diameter D50 can be measured with a particle size distribution analyzer or the like using a laser diffraction and scattering method. The specific surface area can be measured with a specific surface area analyzer or the like by a constant-volume gas adsorption method, for example.

In the positive electrode active material 100 of one embodiment of the present invention, the ratio of the actual specific surface area S_{R} to the ideal specific surface area Sᵢ obtained from the median diameter D50,S_{R}/Sᵢ, is preferably lower than or equal to 2.1.

The level of the surface smoothness of the positive electrode active material 100 can be quantified from its cross-sectional SEM image by the following method, for example.

First, a surface SEM image of the positive electrode active material 100 is obtained. At this time, conductive coating may be performed as pretreatment for observation. The surface to be observed is preferably vertical to an electron beam. In the case of comparing a plurality of samples, the same measurement conditions and the same observation area are adopted.

Then, the above SEM image is converted into an 8-bit image (which is referred to as a grayscale image) with the use of image processing software (e.g., ImageJ). The grayscale image includes luminance (brightness information). For example, in an 8-bit grayscale image, luminance can be represented by 28=256 gradation levels. A dark portion has a low gradation level and a bright portion has a high gradation level. A variation in luminance can be quantified in relation to the number of gradation levels. The quantified value is referred to as a grayscale value. By obtaining such a grayscale value, the unevenness of the positive electrode active material can be evaluated quantitatively.

In addition, a variation in luminance in a target region can also be represented with a histogram. A histogram three-dimensionally shows distribution of gradation levels in a target region and is also referred to as a luminance histogram. A luminance histogram enables visually easy-to-understand evaluation of unevenness of the positive electrode active material.

In the positive electrode active material 100 of one embodiment of the present invention, the difference between the maximum grayscale value and the minimum grayscale value is preferably less than or equal to 120, further preferably less than or equal to 115, still further preferably greater than or equal to 70 and less than or equal to 115. The standard deviation of the grayscale value is preferably less than or equal to 11, further preferably less than or equal to 8, still further preferably greater than or equal to 4 and less than or equal to 8.

### <Additional Feature>

The positive electrode active material 100 has a depression, a crack, a concave, a V-shaped cross section, or the like in some cases. These are examples of defects, and when charge and discharge are repeated, dissolution of cobalt, breakage of a crystal structure, cracking of the positive electrode active material 100, extraction of oxygen, or the like might be derived from these defects. However, when there is the filling portion 102 illustrated in FIG. 1B that fills such defects, dissolution of cobalt or the like can be inhibited. Thus, the positive electrode active material 100 can have high reliability and enable excellent cycle performance.

As described above, an excess amount of the additive element in the positive electrode active material 100 might adversely affect insertion and extraction of lithium. The use of such a positive electrode active material 100 for a secondary battery might cause an internal resistance increase, a charge and discharge capacity decrease, and the like. Meanwhile, when the amount of the additive element is insufficient, the additive element is not distributed throughout the surface portion 100a, which might diminish the effect of inhibiting degradation of a crystal structure. The additive element is required to be contained in the positive electrode active material 100 at an appropriate concentration; however, the adjustment of the concentration is not easy.

For this reason, in the positive electrode active material 100, when the region where the additive element is unevenly distributed is included, some excess atoms of the additive element are removed from the inner portion 100b of the positive electrode active material 100, so that the additive element concentration can be appropriate in the inner portion 100b. This can inhibit an internal resistance increase, a charge and discharge capacity decrease, and the like when a secondary battery is fabricated. A feature of inhibiting an internal resistance increase in a secondary battery is extremely preferable especially in charge and discharge with a large amount of current such as charge and discharge at 400 mA/g or more.

In the positive electrode active material 100 including the region where the additive element is unevenly distributed, mixing of excess additive elements to some extent in the formation process is acceptable. This is preferable because the margin of production can be increased.

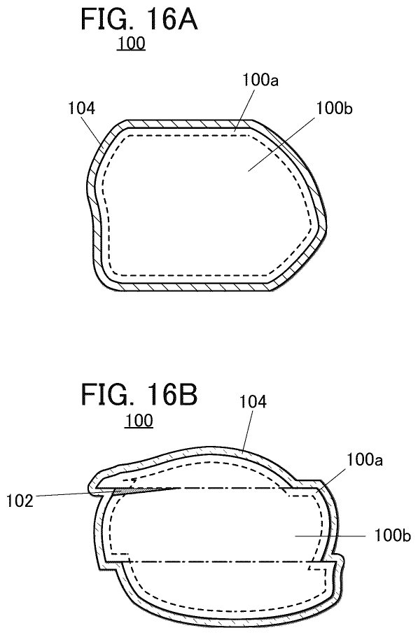

A coating portion may be attached to at least part of the surface of the positive electrode active material 100. FIG. 16A and FIG. 16B illustrates an example of the positive electrode active material 100 to which the coating portion 104 is attached.

The coating portion 104 is preferably formed by deposition of a decomposition product of an electrolyte and an organic electrolyte solution due to charge and discharge, for example. A coating portion originating from an electrolyte solution, which is formed on the surface of the positive electrode active material 100, is expected to improve charge and discharge cycle performance particularly when charge is repeated so that x in LiₓCoO₂ becomes 0.24 or less. This is because an increase in impedance of the surface of the positive electrode active material is inhibited or dissolution of cobalt is inhibited, for example. The coating portion 104 preferably contains carbon, oxygen, and fluorine, for example. The coating portion can have high quality easily when the electrolyte solution includes LiBOB and/or SUN (suberonitrile), for example. Accordingly, the coating portion 104 containing one or two or more selected from boron, nitrogen, sulfur, and fluorine is preferable because of having high quality in some cases. The coating portion 104 does not necessarily cover the positive electrode active material 100 entirely. For example, the coating portion 104 covers greater than or equal to 50%, preferably greater than or equal to 70%, further preferably greater than or equal to 90% of the surface of the positive electrode active material 100.

This embodiment can be used in appropriate combination with any of the other embodiments.

### Embodiment 2

In this embodiment, examples of a method for forming the positive electrode active material 100 of one embodiment of the present invention is described.

A way of adding the additive element is important in forming the positive electrode active material 100 having the distribution of the additive element, the composition, and/or the crystal structure described in the above embodiment. Favorable crystallinity of the inner portion 100b is important as well.

Thus, in the formation process of the positive electrode active material 100, preferably, lithium cobalt oxide is synthesized first, then an additive element source is mixed, and heat treatment is performed.

In a method of synthesizing lithium cobalt oxide containing an additive element by mixing an additive element source concurrently with a cobalt source and a lithium source, it is difficult to increase the concentration of the additive element in the surface portion 100a. In addition, after lithium cobalt oxide is synthesized, only mixing an additive element source without performing heating causes the additive element to be just attached to the lithium cobalt oxide without forming a solid solution therewith. It is difficult to distribute the additive element favorably without sufficient heating. Therefore, it is preferable that lithium cobalt oxide be synthesized, and then an additive element source be mixed and heat treatment be performed. The heat treatment after mixing of the additive element source may be referred to as annealing.

However, annealing at an excessively high temperature may cause cation mixing, which increases the possibility of entry of the additive element such as magnesium into cobalt sites. Magnesium that exists at the cobalt sites does not have an effect of maintaining a layered rock-salt crystal structure belonging to R-3m when x in LiₓCoO₂ is small. Furthermore, heat treatment at an excessively high temperature might have an adverse effect; for example, cobalt might be reduced to have a valence of two or lithium might be evaporated.

In view of the above, a material functioning as a fusing agent is preferably mixed together with the additive element source. A material having a lower melting point than lithium cobalt oxide can be regarded as a material functioning as a fusing agent. For example, a fluorine compound such as lithium fluoride is preferably used. Addition of a fusing agent lowers the melting points of the additive element source and lithium cobalt oxide. The decrease in the melting points makes it easier to favorably distribute the additive element at a temperature at which the cation mixing is unlikely to occur.

### [Initial Heating]

It is further preferable that heating be performed after the synthesis of the lithium cobalt oxide and before the mixing of the additive element. This heating is referred to as initial heating in some cases.

Owing to influence of lithium extraction from part of the surface portion 100a of the lithium cobalt oxide by the initial heating, the distribution of the additive element becomes more favorable.

Specifically, the distributions of the additive elements can be easily made different from each other by the initial heating in the following mechanism. First, lithium is extracted from part of the surface portion 100a by the initial heating. Next, the additive element sources such as a nickel source, an aluminum source, and a magnesium source and the lithium cobalt oxide including the surface portion 100a that is deficient in lithium are mixed and heated. Among the additive elements, magnesium is a divalent representative element, and nickel is a transition metal but is likely to be a divalent ion. Therefore, in part of the surface portion 100a, a rock-salt phase containing Co²⁺, which is reduced due to lithium deficiency, Mg²⁺, and Ni²⁺ is formed. Note that this phase is formed in part of the surface portion 100a, and thus is sometimes not clearly observed in an electron microscope image, such as a STEM image, and an electron diffraction pattern.

Among the additive elements, nickel is likely to form a solid solution and is diffused to the inner portion 100b in the case where the surface portion 100a is the lithium cobalt oxide that has a layered rock-salt crystal structure, but nickel is likely to remain in the surface portion 100a in the case where part of the surface portion 100a has a rock-salt crystal structure. Thus, the initial heating can make it easy for a divalent additive element such as nickel to remain in the surface portion 100a. The effect of this initial heating is large particularly at the surface having an orientation other than the (001) orientation of the positive electrode active material 100 and the surface portion 100a thereof.

Furthermore, in such a rock-salt crystal structure, the bond distance between a metal Me and oxygen (Me-O distance) tends to be longer than that in a layered rock-salt crystal structure.

For example, Me-O distance is 2.09 Å and 2.11 Å in Ni_{0.5}Mg_{0.5}O having a rock-salt crystal structure and MgO having a rock-salt crystal structure, respectively. Even when a spinel phase is formed in part of the surface portion 100a, Me-O distance is 2.0125 Å and 2.02 Å in NiAl₂O₄ having a spinel structure and MgAl₂O₄ having a spinel structure, respectively. In each case, Me-O distance is longer than 2 Å. Note that 1 Å=10-10 m.

Meanwhile, in a layered rock-salt crystal structure, the bond distance between oxygen and a metal other than lithium is shorter than the above-described distance. For example, Al—O distance is 1.905 Å (Li—O distance is 2.11 Å) in LiAlO₂ having a layered rock-salt crystal structure. In addition, Co—O distance is 1.9224 Å (Li—O distance is 2.0916 Å) in LiCoO₂ having a layered rock-salt crystal structure.

According to the ionic radius of Shannon (Shannon et al., Acta A 32 (1976) 751.), the ion radius of hexacoordinated aluminum and the ion radius of hexacoordinated oxygen are 0.535 Å and 1.4 Å, respectively, and the sum of those values is 1.935 Å.

From the above, aluminum is considered to exist in a site other than a lithium site more stably in a layered rock-salt structure than in a rock-salt structure. Thus, in the surface portion 100a, aluminum is more likely to be distributed in a region having a layered rock-salt phase at a larger depth and/or the inner portion 100b than in a region having a rock-salt phase that is close to the surface.

Moreover, the initial heating is expected to decrease defects including dislocation in the inner portion 100b and increase the crystallinity of the layered rock-salt crystal structure. The small number of defects in the inner portion 100b also probably relates to the ease of forming the (3′-type structure and/or the monoclinic O1(15)-type structure.

For this reason, the initial heating is preferably performed in order to form the positive electrode active material 100 that has the monoclinic O1(15)-type structure particularly when x in LiₓCoO₂ is, for example, greater than or equal to 0.15 and less than or equal to 0.17.

However, the initial heating is not necessarily performed. In some cases, by controlling atmosphere, temperature, time, or the like in another heating step, e.g., annealing, the positive electrode active material 100 that has the O3′-type structure and/or the monoclinic O1(15)-type structure when x in LiₓCoO₂ is small can be formed.

### <<Formation Method 1 of Positive Electrode Active Material>>

Formation method 1 of the positive electrode active material 100, in which annealing and the initial heating are performed, is described with reference to FIG. 17A to FIG. 17C.

### <Step S11>

In Step S11 shown in FIG. 17A, a lithium source (Li source) and a cobalt source (Co source) are prepared as materials for lithium and a transition metal which are starting materials.

As the lithium source, a lithium-containing compound is preferably used and for example, lithium carbonate, lithium hydroxide, lithium nitrate, lithium fluoride, or the like can be used.

The lithium source preferably has a high purity and is preferably a material having a purity higher than or equal to 99.99%, for example.

As the cobalt source, a cobalt-containing compound is preferably used, and for example, cobalt oxide, cobalt hydroxide, or the like can be used.

The cobalt source preferably has a high purity and is preferably a material having a purity of higher than or equal to 3N (99.9%), further preferably higher than or equal to 4N (99.99%), still further preferably higher than or equal to 4N5 (99.995%), yet further preferably higher than or equal to 5N (99.999%), for example. Impurities of the positive electrode active material can be controlled by using such a high-purity material. As a result, a secondary battery with an increased capacity and/or increased reliability can be obtained.

Furthermore, the cobalt source preferably has high crystallinity, and preferably includes single crystal particles, for example. The crystallinity of the cobalt source can be evaluated with a TEM (transmission electron microscope) image, a STEM (scanning transmission electron microscope) image, a HAADF-STEM (high-angle annular dark-field scanning transmission electron microscope) image, or an ABF-STEM (annular bright-field scanning transmission electron microscope) image or by X-ray diffraction (XRD), electron diffraction, neutron diffraction, or the like. Note that the above methods for evaluating crystallinity can also be employed to evaluate the crystallinity of other materials in addition to the cobalt source.

### <S12>

Next, in Step S12 shown in FIG. 17A, the lithium source and the cobalt source are ground and mixed to form a mixed material. The grinding and mixing can be performed by a dry method or a wet method. A wet method is preferable because it can crush a material into a smaller size. When the grinding and mixing are performed by a wet method, a solvent is prepared. As the solvent, a ketone such as acetone, an alcohol such as ethanol or isopropanol, an ether, dioxane, acetonitrile, N-methyl-2-pyrrolidone (NMP), or the like can be used. An aprotic solvent, which is unlikely to react with lithium, is preferably used. In this embodiment, dehydrated acetone with a purity higher than or equal to 99.5% is used. It is preferable that the lithium source and the cobalt source be mixed into dehydrated acetone whose moisture content is less than or equal to 10 ppm and which has a purity higher than or equal to 99.5% for the grinding and mixing. With the use of dehydrated acetone with the above-described purity, impurities that might be mixed can be reduced.

A ball mill, a bead mill, or the like can be used for the grinding and mixing. When a ball mill is used, aluminum oxide balls or zirconium oxide balls are preferably used as a grinding medium. Zirconium oxide balls are preferable because they release fewer impurities. When a ball mill, a bead mill, or the like is used, the peripheral speed is preferably higher than or equal to 100 mm/s and lower than or equal to 2000 mm/s in order to inhibit contamination from the medium. In this embodiment, the peripheral speed is set to 838 mm/s (the rotational frequency is 400 rpm, and the diameter of the ball mill is 40 mm).

### <Step S13>

Next, in Step S13 shown in FIG. 17A, the above mixed material is heated. The heating is preferably performed at higher than or equal to 800° C. and lower than or equal to 1100° C., further preferably at higher than or equal to 900° C. and lower than or equal to 1000° C., still further preferably at approximately 950° C. An excessively low temperature might lead to insufficient decomposition and melting of the lithium source and the cobalt source. An excessively high temperature might lead to a defect due to evaporation of lithium from the lithium source and/or excessive reduction of cobalt, for example. An oxygen vacancy or the like might be induced by a change of trivalent cobalt into divalent cobalt, for example.

When the heating time is too short, lithium cobalt oxide is not synthesized, but when the heating time is too long, the productivity is lowered. For example, the heating time is preferably longer than or equal to 1 hour and shorter than or equal to 100 hours, further preferably longer than or equal to 2 hours and shorter than or equal to 20 hours.

A temperature rising rate is preferably higher than or equal to 80° C./h and lower than or equal to 250° C./h, although depending on the end-point temperature of the heating. For example, in the case of heating at 1000° C. for 10 hours, the temperature raising rate is preferably 200° C./h.

The heating is preferably performed in an atmosphere with little water such as a dry-air atmosphere and for example, the dew point of the atmosphere is preferably lower than or equal to −50° C., further preferably lower than or equal to −80° C. In this embodiment, the heating is performed in an atmosphere with a dew point of −93° C. To reduce impurities that might enter the material, the concentrations of impurities such as CH₄, CO, CO₂, and H₂ in the heating atmosphere are each preferably lower than or equal to 5 ppb (parts per billion).

The heating atmosphere is preferably an oxygen-containing atmosphere. In a method, a dry air is continuously introduced into a reaction chamber. The flow rate of a dry air in this case is preferably 10 L/min. Continuously introducing oxygen into a reaction chamber to make oxygen flow therein is referred to as flowing.

In the case where the heating atmosphere is an oxygen-containing atmosphere, flowing is not necessarily performed. For example, a method may be employed in which the pressure in the reaction chamber is reduced, the reaction chamber is filled (which may also be referred to as purged) with oxygen, and the oxygen is prevented from entering or exiting from the reaction chamber. For example, the pressure in the reaction chamber may be reduced to −970 hPa and then, the reaction chamber may be filled with oxygen until the pressure becomes 50 hPa.

Cooling after the heating can be performed by natural cooling, and the time it takes for the temperature to decrease to room temperature from a predetermined temperature is preferably longer than or equal to 10 hours and shorter than or equal to 50 hours. Note that the temperature does not necessarily need to decrease to room temperature as long as it decreases to a temperature acceptable to the next step.

The heating in this step may be performed with a rotary kiln or a roller hearth kiln. Heating with stirring can be performed in either case of a sequential rotary kiln or a batch-type rotary kiln.

As a crucible used at the time of the heating, a crucible made of aluminum oxide is preferable. A crucible made of aluminum oxide has a material property that hardly releases impurities. In this embodiment, a crucible made of aluminum oxide with a purity of 99.9% is used. The heating is preferably performed with the crucible covered with a lid. This can prevent volatilization of a material.

A used crucible is preferred to a new crucible. In this specification and the like, a new crucible refers to a crucible that is subjected to heating two or less times while a material containing lithium, the transition metal M, and/or the additive element is contained therein. A used crucible refers to a crucible that is subjected to heating three or more times while a material containing lithium, the transition metal M, and/or the additive element is contained therein. The reason is that, in the case where a new crucible is used, some materials such as lithium fluoride might be absorbed by, diffused in, transferred to, and/or attached to a saggar. Loss of some materials due to such phenomena increases a concern that an element is not distributed in a preferable range particularly in the surface portion of the positive electrode active material. In contrast, such a risk is low in the case of a used crucible.

The heated material is ground as needed and may be made to pass through a sieve. Before collection of the heated material, the material may be moved from the crucible to a mortar. As the mortar, an agate mortar or a partially stabilized zirconia mortar is preferably used. Note that heating conditions equivalent to those in Step S13 can be employed in a later-described heating step other than Step S13.

### <Step S14>

Through the above steps, lithium cobalt oxide (LiCoO₂) can be synthesized as Step S14 in FIG. 17A.

Although the example is described in which the composite oxide is formed by a solid phase method as in Step S11 to Step S14, the composite oxide may be formed by a coprecipitation method. Alternatively, the composite oxide may be formed by a hydrothermal method.

### <Step S15>

Next, as Step S15 shown in FIG. 17A, the lithium cobalt oxide is heated. The heating in Step S15 is the first heating performed on the lithium cobalt oxide and thus is sometimes referred to as initial heating. The heating is performed before Step S20 described below and thus is sometimes referred to as preheating or pretreatment.

By the initial heating, lithium is extracted from part of the surface portion 100a of the lithium cobalt oxide as described above. In addition, an effect of increasing the crystallinity of the inner portion 100b can be expected. The lithium source and/or the cobalt source prepared in Step S11 and the like might contain impurities. The initial heating can reduce impurities in the lithium cobalt oxide completed in Step S14.

Through the initial heating, an effect of smoothing the surface of the lithium cobalt oxide is obtained. The lithium cobalt oxide having a smooth surface refers to the composite oxide having little unevenness and rounded as a whole with its corner portion rounded. A smooth surface also refers to a surface to which few foreign matters are attached. Foreign matters are deemed to cause projections and depressions and are preferably not attached to a surface. For the initial heating, there is no need to prepare a lithium compound source. For the initial heating, there is no need to prepare the additive element source. Alternatively, there is no need to prepare a material functioning as a fusing agent.

When the heating time in this step is too short, a sufficient effect is not obtained, but when the heating time in this step is too long, the productivity is lowered. For example, any of the heating conditions described for Step S13 can be selected to perform the heating. Additionally, the heating temperature in this step is preferably lower than that in Step S13 so that the crystal structure of the composite oxide is maintained. The heating time in this step is preferably shorter than that in Step S13 so that the crystal structure of the composite oxide is maintained. For example, the heating is preferably performed at a temperature of higher than or equal to 700° C. and lower than or equal to 1000° C. for longer than or equal to 2 hours and shorter than or equal to 20 hours.

The effect of increasing the crystallinity of the internal portion 100b is, for example, an effect of reducing distortion, a shift, or the like derived from differential shrinkage or the like of the lithium cobalt oxide formed in Step S13.

The heating in Step S13 might cause a temperature difference between the surface and an inner portion of the lithium cobalt oxide. The temperature difference sometimes induces differential shrinkage. It can also be deemed that the temperature difference leads to a fluidity difference between the surface and the inner portion, thereby causing differential shrinkage. The energy involved in differential shrinkage causes a difference in internal stress in the lithium cobalt oxide. The difference in internal stress is also called distortion, and the above energy is sometimes referred to as distortion energy. The internal stress is eliminated by the initial heating in Step S15 and in other words, the distortion energy is probably equalized by the initial heating in Step S15. When the distortion energy is equalized, the distortion in the lithium cobalt oxide is relieved. Accordingly, the surface of the lithium cobalt oxide may become smooth. This is also rephrased as modification of the surface. In other words, it is deemed that Step S15 reduces the differential shrinkage caused in the lithium cobalt oxide to make the surface of the composite oxide smooth.

Such differential shrinkage might cause a micro shift in the lithium cobalt oxide such as a shift in a crystal. To reduce the shift, this step is preferably performed. Performing this step can distribute a shift uniformly in the composite oxide. When the shift is distributed uniformly, the surface of the composite oxide might become smooth. This is also referred to as alignment of crystal grains. In other words, it can be deemed that Step S15 reduces the shift in a crystal or the like which is caused in the composite oxide and makes the surface of the composite oxide smooth.

In a secondary battery including lithium cobalt oxide with a smooth surface as a positive electrode active material, degradation by charging and discharging is inhibited and a crack in the positive electrode active material can be prevented.

Note that pre-synthesized lithium cobalt oxide may be used in Step S14. In this case, Step S11 to Step S13 can be omitted. When Step S15 is performed on the pre-synthesized lithium cobalt oxide, lithium cobalt oxide with a smooth surface can be obtained.

### <Step S20>

Next, as illustrated in Step S20, the additive element A is preferably added to the lithium cobalt oxide that has been subjected to the initial heating. When the additive element A is added to the lithium cobalt oxide that has been subjected to the initial heating, the additive element A can be uniformly added. It is thus preferable that the initial heating precede the addition of the additive element A. The step of adding the additive element A is described with reference to FIG. 17B and FIG. 17C.

### <Step S21>

In Step S21 shown in FIG. 17B, an additive element A source (A source) to be added to the lithium cobalt oxide is prepared. A lithium source may be prepared together with the additive element A source.

As the additive element A, the additive element described in the above embodiment can be used. Specifically, one or two or more selected from magnesium, fluorine, nickel, aluminum, titanium, zirconium, vanadium, iron, manganese, chromium, niobium, arsenic, zinc, silicon, sulfur, phosphorus, and boron can be used. Furthermore, one or two selected from bromine and beryllium can be used.

When magnesium is selected as the additive element, the additive element source can be referred to as a magnesium source. As the magnesium source, magnesium fluoride, magnesium oxide, magnesium hydroxide, magnesium carbonate, or the like can be used. Two or more of these magnesium sources may be used.

When fluorine is selected as the additive element, the additive element source can be referred to as a fluorine source. As the fluorine source, for example, lithium fluoride (LiF), magnesium fluoride (MgF₂), aluminum fluoride (AlF₃), titanium fluoride (TiF₄), cobalt fluoride (CoF₂ and CoF₃), nickel fluoride (NiF₂), zirconium fluoride (ZrF₄), vanadium fluoride (VF₅), manganese fluoride, iron fluoride, chromium fluoride, niobium fluoride, zinc fluoride (ZnF₂), calcium fluoride (CaF₂), sodium fluoride (NaF), potassium fluoride (KF), barium fluoride (BaF₂), cerium fluoride (CeF₃ and CeF₄), lanthanum fluoride (LaF₃), sodium aluminum hexafluoride (Na₃AlF₆), or the like can be used. In particular, lithium fluoride is preferable because it is easily melted in a heating step described later owing to its relatively low melting point of 848° C.

Magnesium fluoride can be used as both the fluorine source and the magnesium source. Lithium fluoride can also be used as the lithium source. Another example of the lithium source that can be used in Step S21 is lithium carbonate.

The fluorine source may be a gas; for example, fluorine (F₂), carbon fluoride, sulfur fluoride, oxygen fluoride (OF₂, O₂F₂, O₃F₂, O₄F₂, O₅F₂, O₆F₂, and O₂F), or the like may be used and mixed in the atmosphere in a heating step described later. Two or more of these fluorine sources may be used.

In this embodiment, lithium fluoride (LiF) is prepared as the fluorine source, and magnesium fluoride (MgF₂) is prepared as the fluorine source and the magnesium source. When lithium fluoride and magnesium fluoride are mixed at approximately LiF:MgF₂=65:35 (molar ratio), the effect of lowering the melting point is maximized. Meanwhile, when the proportion of lithium fluoride increases, cycle performance might be degraded because of an excess amount of lithium. Therefore, the molar ratio of lithium fluoride to magnesium fluoride is preferably LiF:MgF₂=x:1 (0≤x≤1.9), further preferably LiF:MgF₂=x:1 (0.1≤x≤<0.5), still further preferably LiF:MgF₂=x:1 (x is an approximate value of 0.33). Note that in this specification and the like, “an approximate value of a given value” means a value greater than 0.9 times and less than 1.1 times the given value.

### <Step S22>

Next, in Step S22 shown in FIG. 17B, the magnesium source and the fluorine source are ground and mixed. Any of the conditions for grinding and mixing that are described for Step S12 can be selected to perform this step.

### <Step S23>

Next, in Step S23 shown in FIG. 17B, the materials ground and mixed in the above step are collected to obtain the additive element A source (A source). Note that the additive element A source shown in Step S23 contains a plurality of starting materials and can be referred to as a mixture.

As for the particle diameter of the mixture, D50 (median diameter) is preferably greater than or equal to 600 nm and less than or equal to 10 μm, further preferably greater than or equal to 1 μm and less than or equal to 5 μm. Also when one kind of material is used as the additive element source, D50 (median diameter) is preferably greater than or equal to 600 nm and less than or equal to 10 μm, further preferably greater than or equal to 1 μm and less than or equal to 5 μm.

Such a pulverized mixture (which may contain only one kind of the additive element) is easily attached to the surface of lithium cobalt oxide particles uniformly in a later step of mixing with the lithium cobalt oxide. The mixture is preferably attached uniformly to the surface of the lithium cobalt oxide particles, in which case the additive element is easily distributed or dispersed uniformly in the surface portion 100a of the composite oxide after heating.

### <Step S21>

A process different from that in FIG. 17B is described with reference to FIG. 17C. In Step S21 shown in FIG. 17C, four kinds of additive element sources to be added to the lithium cobalt oxide are prepared. In other words, FIG. 17C is different from FIG. 17B in the kinds of the additive element sources. A lithium source may be prepared together with the additive element sources.

As the four kinds of additive element sources, a magnesium source (Mg source), a fluorine source (F source), a nickel source (Ni source), and an aluminum source (Al source) are prepared. Note that the magnesium source and the fluorine source can be selected from the compounds and the like described with reference to FIG. 17B. As a nickel source, nickel oxide, nickel hydroxide, or the like can be used. As an aluminum source, aluminum oxide, aluminum hydroxide, or the like can be used.

### <Step S22 and Step S23>

Step S22 and Step S23 shown in FIG. 17C are similar to the steps described with reference to FIG. 17B.

### <Step S31>

Next, in Step S31 shown in FIG. 17A, the lithium cobalt oxide and the additive element source A (A source) are mixed. The atomic ratio of cobalt Co in the lithium cobalt oxide to magnesium Mg contained in the additive element A source is preferably Co:Mg=100:y (0.1≤y≤6), further preferably M:Mg=100:y (0.3≤y≤3).

The conditions of the mixing in Step S31 are preferably milder than those of the mixing in Step S12 in order not to damage the shape of the lithium cobalt oxide particles. For example, conditions with a lower rotational frequency or a shorter time than those for the mixing in Step S12 are preferable. In addition, it can be said that a dry method has a milder condition than a wet method. For example, a ball mill or a bead mill can be used for the mixing. When a ball mill is used, zirconium oxide balls are preferably used as a medium, for example.

In this embodiment, the mixing is performed with a ball mill using zirconium oxide balls with a diameter of 1 mm by a dry method at 150 rpm for 1 hour. The mixing is performed in a dry room the dew point of which is higher than or equal to −100° C. and lower than or equal to −10° C.

### <Step S32>

Next, in Step S32 in FIG. 17A, the materials mixed in the above step are collected, whereby a mixture 903 is obtained. At the time of the collection, the materials may be crushed as needed and made to pass through a sieve.

Note that although FIG. 17A to FIG. 17C show the formation method in which addition of the additive element is performed only after the initial heating, the present invention is not limited to the above-described method. The addition of the additive element may be performed at another timing or may be performed a plurality of times. The timing of the addition may be different between the elements.

For example, the additive element may be added to the lithium source and the cobalt source in Step S11, i.e., at the stage of the starting materials of the composite oxide. Then, lithium cobalt oxide containing the additive element can be obtained in Step S13. In this case, there is no need to separately perform Step S11 to Step S14 and Step S21 to Step S23. This method can be regarded as being simple and highly productive.

Alternatively, lithium cobalt oxide that contains some of the additive elements in advance may be used. When lithium cobalt oxide to which magnesium and fluorine are added is used, for example, Step S11 to Step S14 and part of Step S20 can be skipped. This method can be regarded as being simple and highly productive.

Alternatively, after the heating in Step S15 is performed, to lithium cobalt oxide to which magnesium and fluorine are added in advance, a magnesium source and a fluorine source, or a magnesium source, a fluorine source, a nickel source, and an aluminum source may be further added as in Step S20.

### <Step S33>

Then, in Step S33 shown in FIG. 17A, the mixture 903 is heated. Any of the heating conditions described for Step S13 can be selected to perform the heating. The heating time is preferably longer than or equal to 2 hours. Here, the pressure in a furnace may be higher than atmospheric pressure to make the oxygen partial pressure of the heating atmosphere high. An insufficient oxygen partial pressure of the heating atmosphere might cause reduction of cobalt or the like and hinder the lithium cobalt oxide or the like from maintaining a layered rock-salt crystal structure.

Here, a supplementary explanation of the heating temperature is given. The lower limit of the heating temperature in Step S33 needs to be higher than or equal to the temperature at which a reaction between the lithium cobalt oxide and the additive element source proceeds. The temperature at which the reaction proceeds is the temperature at which interdiffusion of the elements contained in the lithium cobalt oxide and the additive element source occurs, and may be lower than the melting temperatures of these materials. It is known that in the case of an oxide as an example, solid phase diffusion occurs at the temperature 0.757 times the melting temperature Tₘ (the Tamman temperature T_{d}). Accordingly, the heating temperature in Step S33 is higher than or equal to 650° C.

Needless to say, the reaction more easily proceeds at a temperature higher than or equal to the temperature at which one or two or more selected from the materials contained in the mixture 903 are melted. For example, in the case where LiF and MgF₂ are contained in the additive element source, the lower limit of the heating temperature in Step S33 is preferably higher than or equal to 742° C. because the eutectic point of LiF and MgF₂ is around 742° C.

The mixture 903 obtained by mixing such that LiCoO₂:LiF:MgF₂=100:0.33:1 (molar ratio) exhibits an endothermic peak at around 830° C. in differential scanning calorimetry (DSC). Therefore, the lower limit of the heating temperature is further preferably higher than or equal to 830° C.

A higher heating temperature is preferable because it facilitates the reaction, shortens the heating time, and enables high productivity.

The upper limit of the heating temperature is lower than the decomposition temperature of the lithium cobalt oxide (1130° C.). At around the decomposition temperature, a slight amount of lithium cobalt oxide might be decomposed. Thus, the upper limit of the heating temperature is preferably lower than or equal to 1000° C., further preferably lower than or equal to 950° C., still further preferably lower than or equal to 900° C.

In view of the above, the heating temperature in Step S33 is preferably higher than or equal to 650° C. and lower than or equal to 1130° C., further preferably higher than or equal to 650° C. and lower than or equal to 1000° C., still further preferably higher than or equal to 650° C. and lower than or equal to 950° C., yet still further preferably higher than or equal to 650° C. and lower than or equal to 900° C. Furthermore, the heating temperature is preferably higher than or equal to 742° C. and lower than or equal to 1130° C., further preferably higher than or equal to 742° C. and lower than or equal to 1000° C., still further preferably higher than or equal to 742° C. and lower than or equal to 950° C., yet still further preferably higher than or equal to 742° C. and lower than or equal to 900° C. Furthermore, the heating temperature is preferably higher than or equal to 800° C. and lower than or equal to 1100° C., further preferably higher than or equal to 830° C. and lower than or equal to 1130° C., still further preferably higher than or equal to 830° C. and lower than or equal to 1000° C., yet still further preferably higher than or equal to 830° C. and lower than or equal to 950° C., yet still further preferably higher than or equal to 830° C. and lower than or equal to 900° C. Note that the heating temperature in Step S33 is preferably higher than that in Step S13.

In addition, at the time of heating the mixture 903, the partial pressure of fluorine or a fluoride originating from the fluorine source or the like is preferably controlled to be within an appropriate range.

In the formation method described in this embodiment, some of the materials, e.g., LiF as the fluorine source, function as a fusing agent in some cases. Owing to this function, the heating temperature can be lower than the decomposition temperature of the lithium cobalt oxide, e.g., a temperature higher than or equal to 742° C. and lower than or equal to 950° C., which allows distribution of the additive element such as magnesium in the surface portion and formation of the positive electrode active material having favorable characteristics.

However, since LiF in a gas phase has a specific gravity less than that of oxygen, heating might volatilize LiF and in that case, LiF in the mixture 903 decreases. As a result, the function of a fusing agent deteriorates. Therefore, heating needs to be performed while volatilization of LiF is inhibited. Note that even when LiF is not used as the fluorine source or the like, Li at the surface of LiCoO₂ and F of the fluorine source might react to produce LiF, which might be volatilized. Thus, such inhibition of volatilization is needed also when a fluoride having a higher melting point than LiF is used.

In view of this, the mixture 903 is preferably heated in an atmosphere containing LiF, i.e., the mixture 903 is preferably heated in a state where the partial pressure of LiF in the heating furnace is high. Such heating can inhibit volatilization of LiF in the mixture 903.

The heating in this step is preferably performed such that the particles of the mixture 903 are not adhered to each other. Adhesion of the particles of the mixture 903 during the heating might decrease the area of contact with oxygen in the atmosphere and inhibit a path of diffusion of the additive element (e.g., fluorine), thereby hindering distribution of the additive element (e.g., magnesium and fluorine) in the surface portion.

It is considered that uniform distribution of the additive element (e.g., fluorine) in the surface portion leads to a smooth positive electrode active material with little unevenness. Thus, it is preferable that the particles of the mixture 903 not be adhered to each other in order to allow the smooth surface obtained through the heating in Step S15 to be maintained or to be smoother in this step.

In the case of using a rotary kiln for the heating, the heating is preferably performed while the flow rate of an oxygen-containing atmosphere in the kiln is controlled. For example, the flow rate of an oxygen-containing atmosphere is preferably set low, or no flowing of an atmosphere is preferably performed after an atmosphere is purged first and an oxygen atmosphere is introduced into the kiln. Flowing of oxygen is not preferable because it might cause evaporation of the fluorine source, which prevents maintaining the smoothness of the surface.

In the case of using a roller hearth kiln for the heating, the mixture 903 can be heated in an atmosphere containing LiF with the container containing the mixture 903 covered with a lid, for example.

A supplementary explanation of the heating time is given here. The heating time depends on conditions such as the heating temperature and the size and composition of the lithium cobalt oxide in Step S14. In the case where the lithium cobalt oxide is small, the heating is preferably performed at a lower temperature or for a shorter time than in the case where the lithium cobalt oxide is large, in some cases.

In the case where the lithium cobalt oxide in Step S14 in FIG. 17A has a median diameter (D50) of approximately 12 μm, the heating temperature is preferably higher than or equal to 650° C. and lower than or equal to 950° C., for example. The heating time is preferably longer than or equal to 3 hours and shorter than or equal to 60 hours, further preferably longer than or equal to 10 hours and shorter than or equal to 30 hours, still further preferably approximately 20 hours, for example. Note that the temperature decreasing time after the heating is, for example, preferably longer than or equal to 10 hours and shorter than or equal to 50 hours.

In the case where the lithium cobalt oxide in Step S14 has a median diameter (D50) of approximately 5 μm, the heating temperature is preferably higher than or equal to 650° C. and lower than or equal to 950° C., for example. The heating time is preferably longer than or equal to 1 hour and shorter than or equal to 10 hours, further preferably approximately 5 hours, for example. Note that the temperature decreasing time after the heating is, for example, preferably longer than or equal to 10 hours and shorter than or equal to 50 hours.

### <Step S34>

Next, the heated material is collected in Step S34 shown in FIG. 17A, in which crushing is performed as needed; thus, the positive electrode active material 100 is obtained. Here, the collected particles are preferably made to pass through a sieve. Through the above process, the positive electrode active material 100 of one embodiment of the present invention can be formed. The positive electrode active material of one embodiment of the present invention has a smooth surface.

### <<Formation Method 2 of Positive Electrode Active Material>>

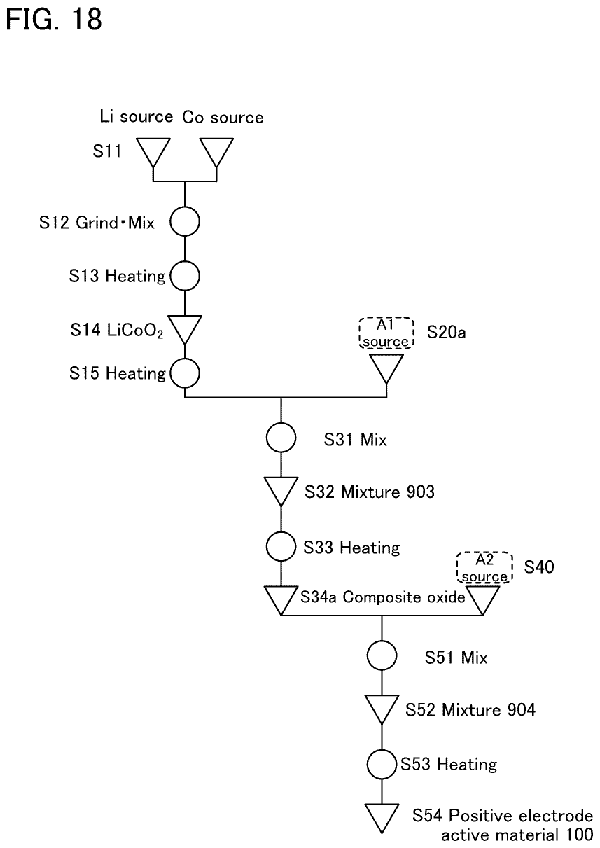

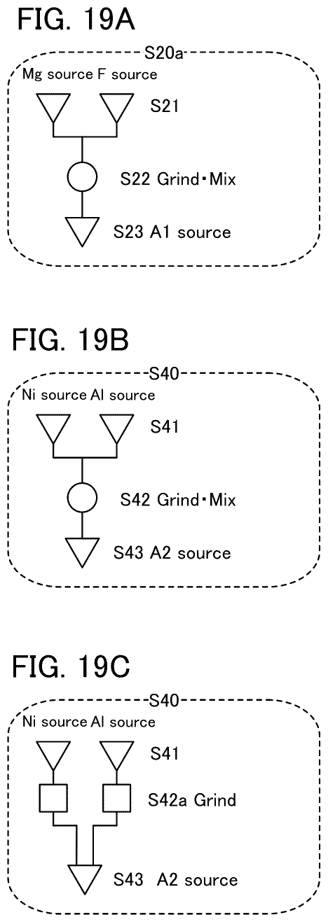

Next, as one embodiment of the present invention, a formation method 2 of a positive electrode active material, which is different from the formation method 1 of a positive electrode active material, will be described with reference to FIG. 18 to FIG. 19C. The formation method 2 of a positive electrode active material is different from the formation method 1 mainly in the number of times of adding additive elements and a mixing method. For the description except for the above, the description of the formation method 1 can be referred to.

Steps S11 to S15 in FIG. 18 are performed as in FIG. 17A to prepare lithium cobalt oxide that has been subjected to the initial heating.

### <Step S20a>

Next, as illustrated in Step S20a, an additive element A1 is preferably added to the lithium cobalt oxide that has been subjected to the initial heating.

### <Step S21>

In Step S21 shown in FIG. 19A, a first additive element source is prepared. The first additive element source can be selected from the additive elements A described for Step S21 with reference to FIG. 17B to be used. For example, one or more selected from magnesium, fluorine, and calcium can be suitably used as the additive element 41. FIG. 19A shows an example of using the magnesium source (Mg source) and the fluorine source (F source) as the first additive element source.

Step S21 to Step S23 shown in FIG. 19A can be performed under the conditions similar to those in Step S21 to Step S23 shown in FIG. 17B. As a result, the additive element source (41 source) can be obtained in Step S23.

Steps S31 to S33 shown in FIG. 18 can be performed in a manner similar to that of Steps S31 to S33 shown in FIG. 17A.

### <Step S34a>

Next, the material heated in Step S33 is collected to form lithium cobalt oxide containing the additive element A1. This composite oxide is called a second composite oxide to be distinguished from the composite oxide in Step S14.

### <Step S40>

In Step S40 shown in FIG. 18, an additive element 42 is added. Descriptions are given also with reference to FIG. 19B and FIG. 19C.

### <Step S41>

In Step S41 shown in FIG. 19B, the second additive element source is prepared. The second additive element source can be selected from the additive elements A described for Step S21 with reference to FIG. 17B to be used. For example, one or more selected from nickel, titanium, boron, zirconium, and aluminum can be suitably used as the additive element A2. FIG. 19B illustrates an example of using a nickel source (Ni source) and an aluminum source (Al source) as the second additive element source.

Step S41 to Step S43 shown in FIG. 19B can be performed under the conditions similar to those in Step S21 to Step S23 shown in FIG. 17B. As a result, the additive element source (A2 source) can be obtained in Step S43.

FIG. 19C shows a variation example of the steps which are described with reference to FIG. 19B. A nickel source (Ni source) and an aluminum source (Al source) are prepared in Step S41 shown in FIG. 19C and are separately ground in Step S42a. Accordingly, a plurality of the second additive element sources (42 sources) are prepared in Step S43. The step in FIG. 19C is different from the step in FIG. 19B in separately grinding the additive elements in Step S42a.

### <Step S51 to Step S53>

Next, Step S51 to Step S53 shown in FIG. 18 can be performed under the conditions similar to those in Step S31 to Step S34 shown in FIG. 17A. The heating in Step S53 can be performed at a lower temperature and for a shorter time than the heating in Step S33. Through the above steps, the positive electrode active material 100 of one embodiment of the present invention can be formed in Step S54. The positive electrode active material of one embodiment of the present invention has a smooth surface.

As shown in FIG. 18 to FIG. 19C, in the formation method 2, introduction of the additive element to the lithium cobalt oxide is divided into introduction of the additive element A1 and that of the additive element 42. When the introduction is divided, the additive elements can have different concentration distribution in the depth direction. The concentration of the additive element A1 can be higher in the surface portion 100a than in the inner portion 100b, and the concentration of the additive element 42 can be higher in the inner portion 100b than in the surface portion 100a, for example.

The initial heating described in this embodiment makes it possible to obtain a positive electrode active material having a smooth surface.

The initial heating described in this embodiment is performed on lithium cobalt oxide. Thus, the initial heating is preferably performed at a temperature lower than the heating temperature for forming the lithium cobalt oxide and for a time shorter than the heating time for forming the lithium cobalt oxide. The additive element is preferably added to the lithium cobalt oxide after the initial heating. The adding step may be separated into two or more steps. The steps are preferably performed in such an order to maintain the smoothness of the surface achieved by the initial heating.

The positive electrode active material 100 with a smooth surface may be less likely to be physically broken by pressure application or the like than a positive electrode active material without a smooth surface. For example, the positive electrode active material 100 is unlikely to be broken in a test involving pressure application such as a nail penetration test, meaning that the positive electrode active material 100 has high safety.

This embodiment can be used in combination with the other embodiments.

### Embodiment 3

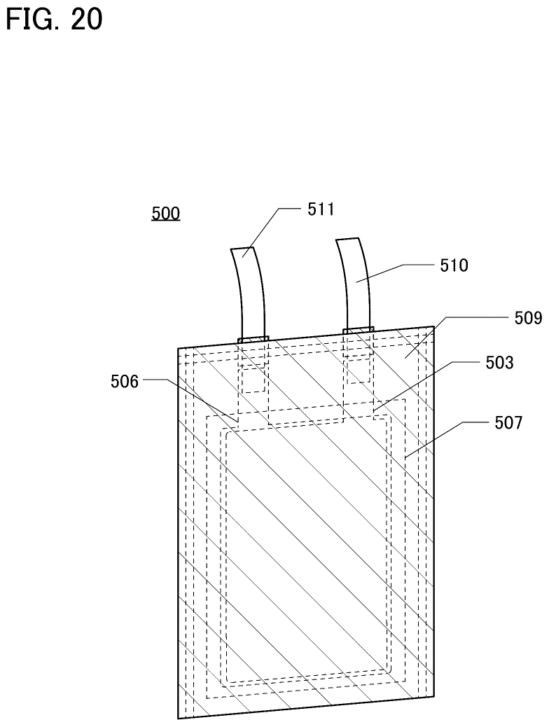

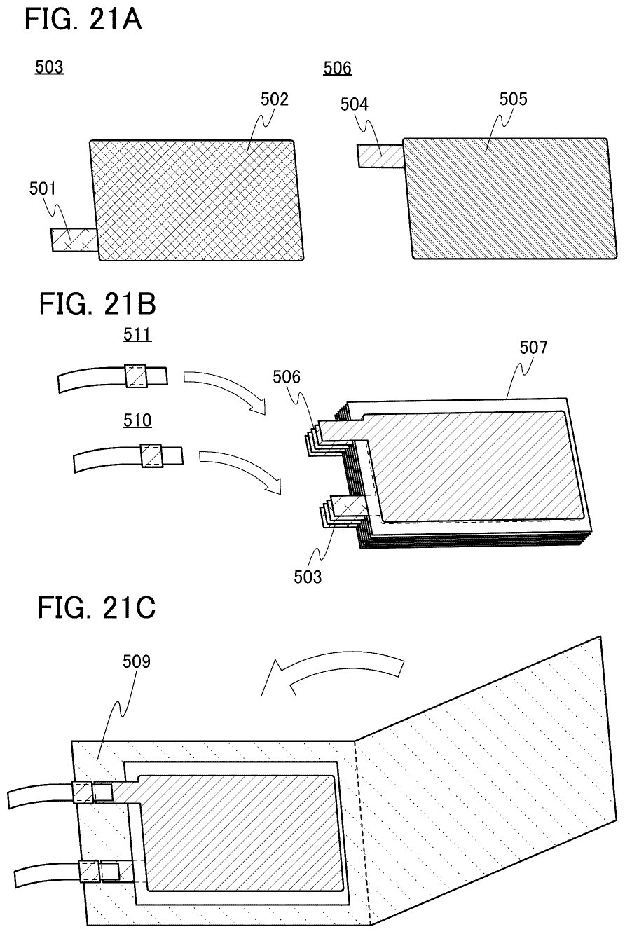

In this embodiment, examples of the secondary battery of one embodiment of the present invention are described with reference to FIG. 20 and FIG. 21.

### <Structure Example of Secondary Battery>

Hereinafter, a secondary battery in which a positive electrode, a negative electrode, and an electrolyte solution are wrapped in an exterior body and illustrated in FIG. 20 is described as an example.

### [Positive Electrode]

The positive electrode includes a positive electrode active material layer and a positive electrode current collector. The positive electrode active material layer includes a positive electrode active material, and may include a conductive material (also referred to as a conductive additive) and a binder. As the positive electrode active material, the positive electrode active material formed by the formation method described in the above embodiment is used.

The positive electrode active material described in the above embodiment and another positive electrode active material may be mixed to be used.

Example of the another positive electrode active material includes a composite oxide with an olivine crystal structure, a composite oxide with a layered rock-salt crystal structure, and a composite oxide with a spinel crystal structure. For example, a compound such as LiFePO₄, LiFeO₂, LiNiO₂, LiMn₂O₄, V₂O₅, Cr₂O₅, or MnO₂ is given.

As another positive electrode active material, it is preferable to mix lithium nickel oxide (LiNiO₂ or LiNi₁₋ₓMₓO₂ (0<x<1) (M=Co, Al, or the like)) with a lithium-containing material that has a spinel crystal structure and contains manganese, such as LiMn₂O₄. This composition can improve the characteristics of the secondary battery.

As the conductive material, a carbon-based material such as acetylene black can be used. In addition, a carbon nanotube, graphene, or a graphene compound can be used as the conductive material.

A graphene compound in this specification and the like refers to multilayer graphene, multi graphene, graphene oxide, multilayer graphene oxide, multi graphene oxide, reduced graphene oxide, reduced multilayer graphene oxide, reduced multi graphene oxide, graphene quantum dots, and the like. A graphene compound contains carbon, has a plate-like shape, a sheet-like shape, or the like, and has a two-dimensional structure formed of a six-membered ring composed of carbon atoms. The two-dimensional structure formed of the six-membered ring composed of carbon atoms may be referred to as a carbon sheet. A graphene compound may include a functional group. The graphene compound is preferably bent. The graphene compound may be rounded like carbon nanofiber.

In this specification and the like, graphene oxide contains carbon and oxygen, has a sheet-like shape, and includes a functional group, in particular, an epoxy group, a carboxy group, or a hydroxy group.

In this specification and the like, reduced graphene oxide contains carbon and oxygen, has a sheet-like shape, and has a two-dimensional structure formed of a six-membered ring composed of carbon atoms. The reduced graphene oxide functions by itself and may have a stacked-layer structure. The reduced graphene oxide preferably includes a portion where the carbon concentration is higher than 80 atomic % and the oxygen concentration is higher than or equal to 2 atomic % and lower than or equal to 15 atomic %. With such a carbon concentration and such an oxygen concentration, the reduced graphene oxide can function as a conductive material with high conductivity even with a small amount. In addition, the intensity ratio G/D of a G band to a D band of the Raman spectrum of the reduced graphene oxide is preferably 1 or more. The reduced graphene oxide with such an intensity ratio can function as a conductive material with high conductivity even with a small amount.

A graphene compound sometimes has excellent electrical characteristics of high conductivity and excellent physical properties of high flexibility and high mechanical strength. A graphene compound has a sheet-like shape. A graphene compound has a curved surface in some cases, thereby enabling low-resistant surface contact. Furthermore, a graphene compound sometimes has extremely high conductivity even with a small thickness, and thus a small amount of a graphene compound efficiently allows a conductive path to be formed in an active material layer. Hence, when a graphene compound is used as the conductive material, the area where the active material and the conductive material are in contact with each other can be increased. The graphene compound preferably covers 80% or more of the active material. Note that the graphene compound preferably clings to at least part of an active material particle. The graphene compound preferably overlays at least part of the active material particle. The shape of the graphene compound preferably conforms to at least part of the shape of the active material particle. The shape of an active material particle means, for example, unevenness of a single active material particle or unevenness formed by a plurality of active material particles. The graphene compound preferably surrounds at least part of an active material particle. The graphene compound may have a hole.

In the case where active material particles with a small diameter (e.g., 1 μm or less) are used, the specific surface area of the active material particles is large and thus more conductive paths for the active material particles are needed. In such a case, it is preferable to use a graphene compound that can efficiently form a conductive path even with a small amount.

It is particularly effective to use a graphene compound, which has the above-described properties, as a conductive material of a secondary battery that needs to be rapidly charged and discharged. For example, a secondary battery for a two- or four-wheeled vehicle, a secondary battery for a drone, or the like is required to have rapid charge and rapid discharge characteristics in some cases. In addition, a mobile electronic device or the like is required to have rapid charge characteristics in some cases. Fast charge and discharge are referred to as charge and discharge at, for example, 200 mA/g, 400 mA/g, or 1000 mA/g or more.

A plurality of sheets of graphene or the plurality of graphene compounds are formed to partly coat or adhere to surfaces of a plurality of particles of a positive electrode active material, so that the plurality of graphenes or graphene compounds preferably make surface contact with the particles of the positive electrode active material.

Here, the plurality of sheets of graphene or the plurality of graphene compounds can be bonded to each other to form a net-like graphene compound sheet (hereinafter, referred to as a graphene compound net or a graphene net). A graphene net that covers the active material can function as a binder for bonding the active material particles. Accordingly, the amount of the binder can be reduced, or the binder does not have to be used. This can increase the proportion of the active material in the electrode volume and the electrode weight. That is to say, the discharge capacity of the secondary battery can be increased.

A material used in formation of the graphene compound may be mixed with the graphene compound to be used for an active material layer 200. For example, particles used as a catalyst in formation of the graphene compound may be mixed with the graphene compound. As an example of the catalyst in formation of the graphene compound, particles containing any of silicon oxide (SiO₂ or SiOₓ (x<2)), aluminum oxide, iron, nickel, ruthenium, iridium, platinum, copper, germanium, and the like can be given. The median diameter (D50) of the particles is preferably less than or equal to 1 μm, further preferably less than or equal to 100 nm.

### [Binder]

As the binder, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Fluororubber can also be used as the binder.

As the binder, for example, water-soluble polymers are preferably used. As the water-soluble polymers, a polysaccharide can be used, for example. As the polysaccharide, one or more of starch, cellulose derivatives such as carboxymethyl cellulose (CMC), methyl cellulose, ethyl cellulose, hydroxypropyl cellulose, diacetyl cellulose, and regenerated cellulose, and the like can be used. It is further preferable that such a water-soluble polymer be used in combination with any of the above rubber materials.

Alternatively, as the binder, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

Two or more of the above materials may be used in combination for the binder.

### [Current Collector]

The current collector can be formed using a material that has high conductivity, such as a metal like stainless steel, gold, platinum, aluminum, or titanium, or an alloy thereof. It is preferable that a material used for the positive electrode current collector not dissolve at the potential of the positive electrode. Alternatively, it is possible to use an aluminum alloy to which an element that improves heat resistance, such as silicon, titanium, neodymium, scandium, or molybdenum, is added. A metal element that forms silicide by reacting with silicon may be used. Examples of the metal element that forms silicide by reacting with silicon include zirconium, titanium, hafnium, vanadium, niobium, tantalum, chromium, molybdenum, tungsten, cobalt, and nickel. The current collector can have a foil-like shape, a plate-like shape, a sheet-like shape, a net-like shape, a punching-metal shape, an expanded-metal shape, or the like as appropriate. The current collector preferably has a thickness greater than or equal to 5 μm and less than or equal to 30 μm.

### [Negative Electrode]

The negative electrode includes a negative electrode active material layer and a negative electrode current collector. The negative electrode active material layer may include a conductive material and a binder.

### [Negative Electrode Active Material]

As the negative electrode active material, an alloy-based material and/or a carbon-based material can be used, for example.

For the negative electrode active material, an element that enables charging and discharging reactions by an alloying reaction and a dealloying reaction with lithium can be used. For example, a material containing one or two or more selected from silicon, tin, gallium, aluminum, germanium, lead, antimony, bismuth, silver, zinc, cadmium, indium, and the like can be used. Such elements have higher charge and discharge capacity than carbon; in particular, silicon has a high theoretical capacity of 4200 mAh/g. For this reason, silicon is preferably used as the negative electrode active material. Alternatively, a compound containing any of the above elements may be used. Examples of the compound include SiO, Mg₂Si, Mg₂Ge, SnO, SnO₂, Mg₂Sn, SnS₂, V₂Sn₃, FeSn₂, CoSn₂, NisSn₂, CusSns, Ag₃Sn, Ag₃Sb, Ni₂MnSb, CeSb₃, LaSn₃, La₃Co₂Sn₇, CoSb₃, InSb, and SbSn. Here, an element that enables charging and discharging reactions by an alloying reaction and a dealloying reaction with lithium, a compound containing the element, and the like may be referred to as an alloy-based material.

In this specification and the like, SiO refers, for example, to silicon monoxide. Alternatively, SiO can be expressed as SiOₓ. Here, x is preferably an approximate value of 1. For example, x is preferably greater than or equal to 0.2 and less than or equal to 1.5, further preferably greater than or equal to 0.3 and less than or equal to 1.2. Alternatively, x is preferably greater than or equal to 0.2 and less than or equal to 1.2. Still alternatively, x is preferably greater than or equal to 0.3 and less than or equal to 1.5.

As the carbon-based material, graphite, graphitizing carbon (soft carbon), non-graphitizing carbon (hard carbon), carbon nanotube, graphene, carbon black, or the like can be used.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used. For example, MCMB is preferably used because it may have a spherical shape. Moreover, MCMB may preferably be used because it can relatively easily have a small surface area. Examples of natural graphite include flake graphite and spherical natural graphite.

Graphite has a low potential substantially equal to that of a lithium metal (higher than or equal to 0.05 V and lower than or equal to 0.3 V vs. Li/Li⁺) when lithium ions are inserted into graphite (while a lithium-graphite intercalation compound is formed). For this reason, a lithium-ion secondary battery can have a high operating voltage. In addition, graphite is preferable because of its advantages such as a relatively high charge and discharge capacity per unit volume, relatively small volume expansion, low cost, and a higher level of safety than that of a lithium metal.

As the negative electrode active material, an oxide such as titanium dioxide (TiO₂), lithium titanium oxide (Li₄Ti₅O₁₂), a lithium-graphite intercalation compound (LiₓC₆), niobium pentoxide (Nb₂O₅), tungsten oxide (WO₂), or molybdenum oxide (MoO₂) can be used.

Alternatively, as the negative electrode active material, Li₃₋ₓMₓN (M=Co, Ni, or Cu) with a Li₃N structure, which is a composite nitride of lithium and a transition metal, can be used. For example, Li_{2.6}Co_{0.4}N₃ is preferable because of its high charge and discharge capacity (900 mAh/g and 1890 mAh/cm³).

A composite nitride of lithium and a transition metal is preferably used, in which case lithium ions are contained in the negative electrode active material and thus the negative electrode active material can be used in combination with a material for a positive electrode active material that does not contain lithium ions, such as V₂O₅ or Cr₃O₈. Note that in the case of using a material containing lithium ions as a positive electrode active material, the composite nitride of lithium and a transition metal can be used as the negative electrode active material by extracting the lithium ions contained in the positive electrode active material in advance.

Alternatively, a material that causes a conversion reaction can be used as the negative electrode active material. For example, a transition metal oxide that does not form an alloy with lithium, such as cobalt oxide (CoO), nickel oxide (NiO), or iron oxide (FeO), may be used as the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and GesN₄, phosphides such as NiP₂, FeP₂, and CoP₃, and fluorides such as FeF₃ and BiF₃.

For the conductive material and the binder that can be included in the negative electrode active material layer, materials similar to those for the conductive material and the binder that can be included in the positive electrode active material layer can be used.

### [Negative Electrode Current Collector]

For the negative electrode current collector, a material similar to that of the positive electrode current collector can be used. Note that a material that does not alloy with carrier ions of lithium or the like is preferably used for the negative electrode current collector.

### [Electrolyte Solution]

The electrolyte solution contains a solvent and an electrolyte. As the solvent of the electrolyte solution, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination in an appropriate ratio.

A solvent containing fluorine, such as FEC, has a low HOMO. The solvent with a low HOMO withstands high voltage, which is preferable.

Alternatively, the use of one or more ionic liquids (room temperature molten salts) that are unlikely to burn and volatize as the solvent of the electrolyte solution can prevent the secondary battery from exploding and/or igniting even when the internal temperature increases owing to an internal short circuit, overcharging or the like in the secondary battery. An ionic liquid contains a cation and an anion, specifically, an organic cation and an anion. Examples of the organic cation used for the electrolyte solution include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As the electrolyte dissolved in the above-described solvent, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiCAF₉SO₃, LiC(CF₃SO₂)₃, LiC(C₂F₅SO₂)₃, LiN(CF₃SO₂)₂, LiN(C₄F₉SO₂)(CF₃SO₂), and LiN(C₂FsSO₂)₂ can be used, or two or more of these lithium salts can be used in an appropriate combination at an appropriate ratio.

As the electrolyte solution used for the secondary battery, it is preferable to use an electrolyte solution that is highly purified and contains a small amount of dust particles and elements other than the constituent elements of the electrolyte solution (hereinafter, also simply referred to as “impurities”). Specifically, the weight ratio of impurities to the electrolyte solution is preferably less than or equal to 1%, further preferably less than or equal to 0.1%, still further preferably less than or equal to 0.01%.

An additive agent such as vinylene carbonate, propane sultone (PS), tert-butylbenzene (TBB), fluoroethylene carbonate (FEC), lithium bis(oxalate) borate (LiBOB), a dinitrile compound such as succinonitrile or adiponitrile, fluorobenzene, or ethylene glycol bis(propionitrile) ether may be added to the electrolyte solution. The concentration of the material to be added in the whole solvent is, for example, higher than or equal to 0.1 wt % and lower than or equal to 5 wt %.

It is particularly preferable to use VC or LiBOB because it facilitates formation of a favorable coating portion.

Alternatively, a polymer gel electrolyte obtained in such a manner that a polymer is swelled with an electrolyte solution may be used.

When a polymer gel electrolyte is used, safety against liquid leakage and the like is improved. Moreover, a secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used.

Examples of the polymer include a polymer having a polyalkylene oxide structure, such as polyethylene oxide (PEO); PVDF; polyacrylonitrile; and a copolymer containing any of them.

For example, PVDF-HFP, which is a copolymer of PVDF and hexafluoropropylenc (HFP), can be used. The formed polymer may be porous.

Instead of the electrolyte solution, a solid electrolyte including an inorganic material such as a sulfide-based or oxide-based inorganic material, a solid electrolyte including a polymer material such as a PEO (polyethylene oxide)-based polymer material, or the like can be used. When the solid electrolyte is used, a separator and/or a spacer is not necessary. Furthermore, the battery can be entirely solidified; therefore, there is no possibility of liquid leakage and thus the safety of the battery is dramatically improved.

A material used for the electrolyte solution preferably contains few impurities.

### [Separator]

The secondary battery preferably includes a separator. The separator can be formed using, for example, paper, nonwoven fabric, glass fiber, ceramics, or synthetic fiber containing nylon (polyamide), vinylon (polyvinyl alcohol-based fiber), polyester, acrylic, polyolefin, or polyurethane. The separator is preferably formed to have an envelope-like shape to wrap one of the positive electrode and the negative electrode.

The separator may have a multilayer structure. For example, an organic material film of polypropylene, polyethylene, or the like can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

When the separator is coated with the ceramic-based material, the oxidation resistance is improved; hence, degradation of the separator during high-voltage charging and discharging can be inhibited and thus the reliability of the secondary battery can be improved. When the separator is coated with the fluorine-based material, the separator is easily brought into close contact with an electrode, resulting in high output characteristics. When the separator is coated with the polyamide-based material, in particular, aramid, the heat resistance is improved; thus, the safety of the secondary battery can be improved.

For example, both surfaces of a polypropylene film may be coated with a mixed material of aluminum oxide and aramid. Alternatively, a surface of a polypropylene film that is to be in contact with the positive electrode may be coated with the mixed material of aluminum oxide and aramid, and a surface of the polypropylene film that is to be in contact with the negative electrode may be coated with the fluorine-based material.

The use of a separator having a multilayer structure makes it possible to maintain the safety of the secondary battery even when the total thickness of the separator is small, so that the discharge capacity per volume of the secondary battery can be increased.

### [Exterior Body]

For an exterior body included in the secondary battery, a metal material such as aluminum and/or a resin material can be used, for example. A film-like exterior body can also be used. As the film, for example, it is possible to use a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body.

### <Laminated Secondary Battery and Fabricating Method Thereof>

FIG. 20 and FIG. 21 illustrate examples of the external view of a laminated secondary battery 500. In FIG. 20 and FIG. 21, a positive electrode 503, a negative electrode 506, a separator 507, an exterior body 509, a positive electrode lead electrode 510, and a negative electrode lead electrode 511 are included. When the laminated secondary battery has flexibility and is used in an electronic device at least part of which is flexible, the secondary battery can be bent as the electronic device is bent. An example of a method for fabricating the laminated secondary battery will be described with reference to FIG. 21A to FIG. 21C.

First, the negative electrode 506, the separator 507, and the positive electrode 503 are stacked. FIG. 21B illustrates the negative electrodes 506, the separators 507, and the positive electrodes 503 that are stacked. Here, an example in which five negative electrodes and four positive electrodes are used is illustrated. Next, the tab regions of the positive electrodes 503 are bonded to each other, and the positive electrode lead electrode 510 is bonded to the tab region of the positive electrode on the outermost surface. The bonding is performed by ultrasonic welding, for example. In a similar manner, the tab regions of the negative electrodes 506 are bonded to each other, and the negative electrode lead electrode 511 is bonded to the tab region of the negative electrode on the outermost surface.

After that, the negative electrodes 506, the separators 507, and the positive electrodes 503 are placed over the exterior body 509.

Subsequently, the exterior body 509 is folded along a portion shown by a dashed line, as illustrated in FIG. 21C. Then, the outer edges of the exterior body 509 are bonded to each other. The bonding can be performed by thermocompression, for example. At this time, an unbonded region (hereinafter, referred to as an inlet) is provided for part (or one side) of the exterior body 509 so that an electrolyte solution can be introduced later.

Next, the electrolyte solution (not illustrated) is introduced into the exterior body 509 from the inlet of the exterior body 509. The electrolyte solution is preferably introduced in a reduced pressure atmosphere or in an inert atmosphere. Lastly, the inlet is sealed by bonding. In this manner, the laminated secondary battery 500 can be fabricated.

When the positive electrode active material described in the above embodiment is used in the positive electrode 503, the secondary battery 500 with high discharge capacity and excellent cycle performance can be obtained.

This embodiment can be used in appropriate combination with any of the other embodiments.

### Embodiment 4

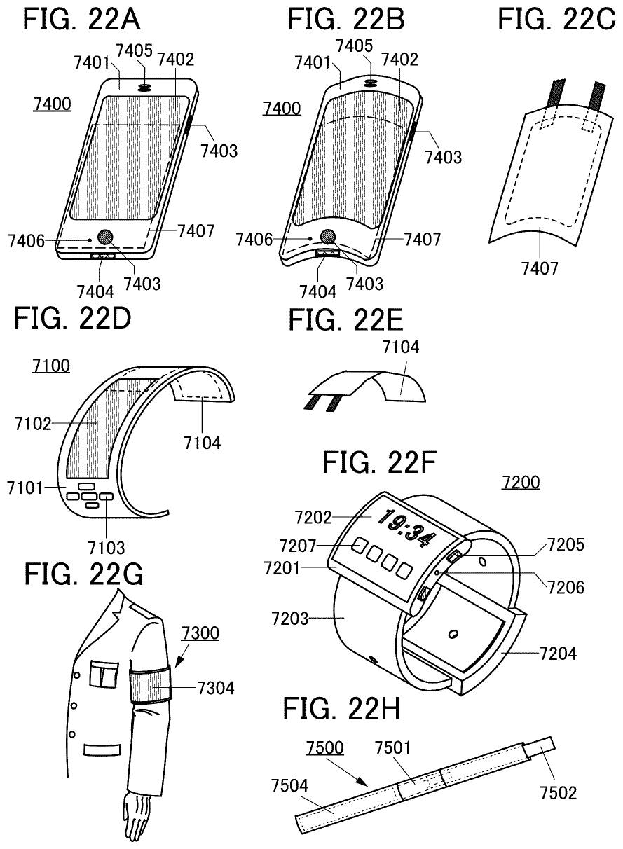

In this embodiment, examples of electronic devices each including the secondary battery of one embodiment of the present invention are described with reference to FIG. 22A to FIG. 24C.

FIG. 22A to FIG. 22G illustrate examples of electronic devices each including the secondary battery containing a positive electrode active material described in the above embodiment. Examples of electronic devices each including a secondary battery include television devices (also referred to as televisions or television receivers), monitors of computers or the like, digital cameras, digital video cameras, digital photo frames, mobile phones (also referred to as cellular phones or mobile phone devices), portable game machines, portable information terminals, audio reproducing devices, and large game machines such as pachinko machines.

Furthermore, a flexible secondary battery can be incorporated along a curved inside or outside wall surface of a house, a building, or the like or a curved interior or exterior surface of an automobile, for example.

FIG. 22A illustrates an example of a mobile phone. A mobile phone 7400 is provided with a display portion 7402 incorporated in a housing 7401, operation buttons 7403, an external connection port 7404, a speaker 7405, a microphone 7406, and the like. Note that the mobile phone 7400 includes a secondary battery 7407. When the secondary battery of one embodiment of the present invention is used as the secondary battery 7407, a lightweight mobile phone with a long lifetime can be provided.

FIG. 22B illustrates the state where the mobile phone 7400 is curved. When the whole mobile phone 7400 is bent by the external force, the secondary battery 7407 included in the mobile phone 7400 is also bent. FIG. 22C illustrates the bent secondary battery 7407. The secondary battery 7407 is a thin storage battery. The secondary battery 7407 is fixed in a state of being bent. Note that the secondary battery 7407 includes a lead electrode electrically connected to a current collector. The current collector is, for example, copper foil, and partly alloyed with gallium; thus, adhesion between the current collector and an active material layer in contact with the current collector is improved, and the secondary battery 7407 can have high reliability even in a state of being bent.

FIG. 22D illustrates an example of a bangle-type display device. A portable display device 7100 includes a housing 7101, a display portion 7102, operation buttons 7103, and a secondary battery 7104. FIG. 22E illustrates the bent secondary battery 7104. When the display device is worn on a user's arm while the secondary battery 7104 is bent, the housing changes its shape and the curvature of part or the whole of the secondary battery 7104 is changed. Note that the bending condition of a curve at a given point that is represented by a value of the radius of a corresponding circle is referred to as the radius of curvature, and the reciprocal of the radius of curvature is referred to as curvature. Specifically, part or the whole of the housing or the main surface of the secondary battery 7104 is changed in the range of radius of curvature greater than or equal to 40 mm and less than or equal to 150 mm. When the radius of curvature at the main surface of the secondary battery 7104 is in the range greater than or equal to 40 mm and less than or equal to 150 mm, the reliability can be kept high. When the secondary battery of one embodiment of the present invention is used as the secondary battery 7104, a lightweight portable display device with a long lifetime can be provided.

FIG. 22F illustrates an example of a watch-type portable information terminal. A portable information terminal 7200 includes a housing 7201, a display portion 7202, a band 7203, a buckle 7204, an operation button 7205, an input/output terminal 7206, and the like.

The portable information terminal 7200 is capable of executing a variety of applications such as mobile phone calls, e-mailing, viewing and editing texts, music reproduction, Internet communication, and a computer game.

The display surface of the display portion 7202 is curved, and images can be displayed on the curved display surface. In addition, the display portion 7202 includes a touch sensor, and operation can be performed by touching the screen with a finger, a stylus, or the like. For example, by touching an icon 7207 displayed on the display portion 7202, an application can be started.

With the operation button 7205, a variety of functions such as time setting, power on/off, on/off of wireless communication, setting and cancellation of a silent mode, and setting and cancellation of a power saving mode can be performed. For example, the functions of the operation button 7205 can be set freely by the operating system incorporated in the portable information terminal 7200.

The portable information terminal 7200 can employ near field communication based on an existing communication standard. For example, mutual communication with a headset capable of wireless communication enables hands-free calling.

Moreover, the portable information terminal 7200 includes the input/output terminal 7206, and data can be directly transmitted to and received from another information terminal via a connector. In addition, charge via the input/output terminal 7206 is possible. Note that the charging operation may be performed by wireless power feeding without using the input/output terminal 7206.

The display portion 7202 of the portable information terminal 7200 includes the secondary battery of one embodiment of the present invention. When the secondary battery of one embodiment of the present invention is used, a lightweight portable information terminal with a long lifetime can be provided. For example, the secondary battery 7104 illustrated in FIG. 22E can be provided in the housing 7201 while being curved, or can be provided in the band 7203 such that it can be curved.

The portable information terminal 7200 preferably includes a sensor. As the sensor, a human body sensor such as a fingerprint sensor, a pulse sensor, or a temperature sensor, a touch sensor, a pressure sensitive sensor, or an acceleration sensor is preferably mounted, for example.

FIG. 22G illustrates an example of an armband display device. A display device 7300 includes a display portion 7304 and the secondary battery of one embodiment of the present invention. The display device 7300 can include a touch sensor in the display portion 7304 and can serve as a portable information terminal.

The display surface of the display portion 7304 is curved, and images can be displayed on the curved display surface. A display state of the display device 7300 can be changed by, for example, near field communication based on an existing communication standard.

The display device 7300 includes an input/output terminal, and data can be directly transmitted to and received from another information terminal via a connector. In addition, charge via the input/output terminal is possible. Note that the charging operation may be performed by wireless power feeding without using the input/output terminal.

When the secondary battery of one embodiment of the present invention is used as the secondary battery included in the display device 7300, a lightweight display device with a long lifetime can be provided.

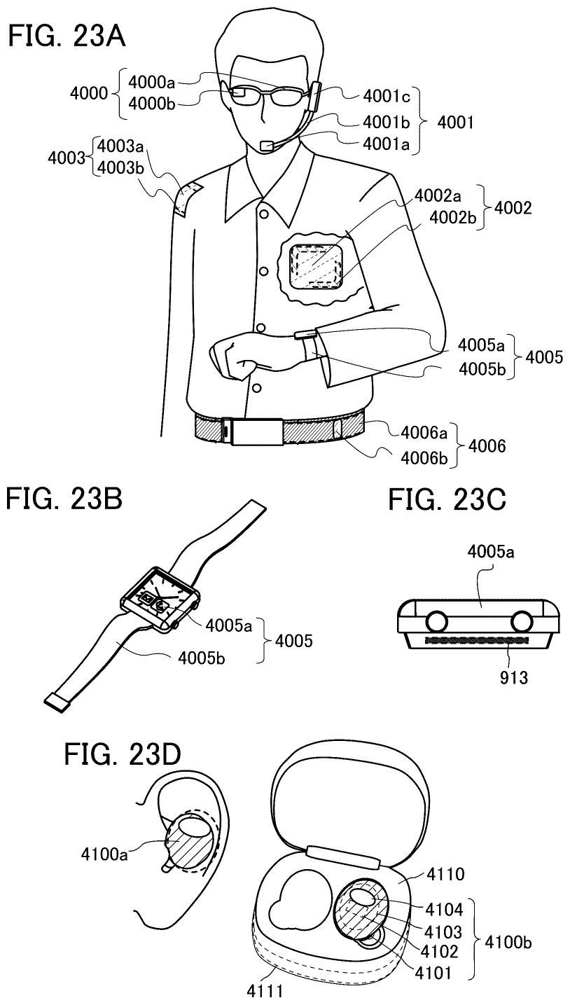

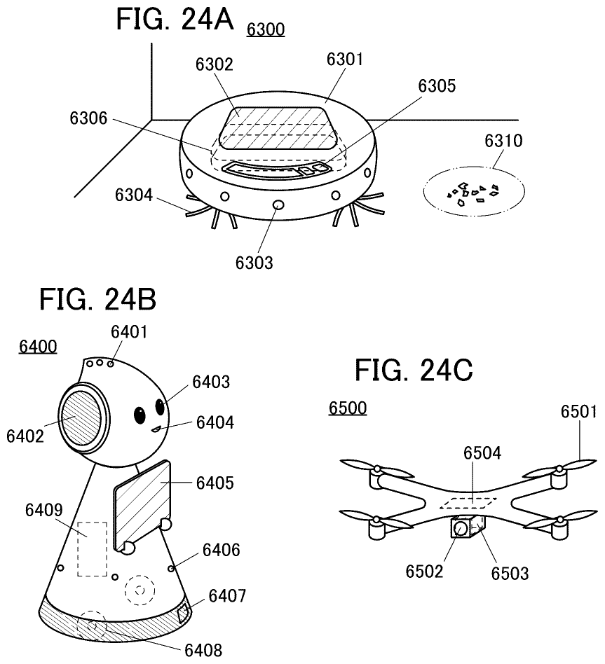

Examples of electronic devices each including the secondary battery with excellent cycle performance described in the above embodiment are described with reference to FIG. 22H, FIG. 23, and FIG. 24.

When the secondary battery of one embodiment of the present invention is used as a secondary battery of a daily electronic device, a lightweight product with a long lifetime can be provided. Examples of the daily electronic device include an electric toothbrush, an electric shaver, and electric beauty equipment. As secondary batteries of these products, small and lightweight stick type secondary batteries with high discharge capacity are desired in consideration of handling ease for users.

FIG. 22H is a perspective view of a device called a cigarette smoking device (electronic cigarette). In FIG. 22H, an electronic cigarette 7500 includes an atomizer 7501 including a heating element, a secondary battery 7504 that supplies power to the atomizer, and a cartridge 7502 including a liquid supply bottle, a sensor, and the like. To improve safety, a protection circuit that prevents overcharging and overdischarging of the secondary battery 7504 may be electrically connected to the secondary battery 7504. The secondary battery 7504 illustrated in FIG. 22H includes an external terminal for connection to a charger. When the electronic cigarette 7500 is held, the secondary battery 7504 is a tip portion; thus, it is preferable that the secondary battery 7504 have a short total length and be lightweight. With the secondary battery of one embodiment of the present invention, which has high discharge capacity and excellent cycle performance, the small and lightweight the electronic cigarette 7500 that can be used for a long time over a long period can be provided.

FIG. 23A illustrates examples of wearable devices. A secondary battery is used as a power source of a wearable device. To have improved splash resistance, water resistance, or dust resistance in daily use or outdoor use by a user, a wearable device is desirably capable of being charged with and without a wire whose connector portion for connection is exposed.

For example, the secondary battery of one embodiment of the present invention can be provided in a glasses-type device 4000 illustrated in FIG. 23A. The glasses-type device 4000 includes a frame 4000a and a display portion 4000b. The secondary battery is provided in a temple portion of the frame 4000a having a curved shape, whereby the glasses-type device 4000 can be lightweight, can have a well-balanced weight, and can be used continuously for a long time. With the use of the secondary battery of one embodiment of the present invention, space saving required with downsizing of a housing can be achieved.

The secondary battery of one embodiment of the present invention can be provided in a headset-type device 4001. The headset-type device 4001 includes at least a microphone portion 4001a, a flexible pipe 4001b, and an earphone portion 4001c. The secondary battery can be provided in the flexible pipe 4001b and/or the earphone portion 4001c. With the use of the secondary battery of one embodiment of the present invention, space saving required with downsizing of a housing can be achieved.

The secondary battery of one embodiment of the present invention can be provided in a device 4002 that can be attached directly to a body. A secondary battery 4002b can be provided in a thin housing 4002a of the device 4002. With the use of the secondary battery of one embodiment of the present invention, space saving required with downsizing of a housing can be achieved.

The secondary battery of one embodiment of the present invention can be provided in a device 4003 that can be attached to clothes. A secondary battery 4003b can be provided in a thin housing 4003a of the device 4003. With the use of the secondary battery of one embodiment of the present invention, space saving required with downsizing of a housing can be achieved.

The secondary battery of one embodiment of the present invention can be provided in a belt-type device 4006. The belt-type device 4006 includes a belt portion 4006a and a wireless power feeding and receiving portion 4006b, and the secondary battery can be provided inside the belt portion 4006a. With the use of the secondary battery of one embodiment of the present invention, space saving required with downsizing of a housing can be achieved.

The secondary battery of one embodiment of the present invention can be provided in a watch-type device 4005. The watch-type device 4005 includes a display portion 4005a and a belt portion 4005b, and the secondary battery can be provided in the display portion 4005a or the belt portion 4005b. With the use of the secondary battery of one embodiment of the present invention, space saving required with downsizing of a housing can be achieved.

The display portion 4005a can display various kinds of information such as time and reception information of an e-mail and an incoming call.

The watch-type device 4005 is a wearable device that is wound around an arm directly; thus, a sensor that measures the pulse, the blood pressure, or the like of the user may be incorporated therein. Data on the exercise quantity and health of the user can be stored to be used for health maintenance.

FIG. 23B is a perspective view of the watch-type device 4005 that is detached from an arm.

FIG. 23C is a side view. FIG. 23C illustrates a state where a secondary battery 913 is incorporated in the watch-type device 4005. The secondary battery 913 is the secondary battery described in Embodiment 4. The secondary battery 913, which is small and lightweight, is provided at a position overlapping with the display portion 4005a.

FIG. 23D illustrates an example of wireless earphones. The wireless earphones illustrated here include, but are not limited to, a pair of main bodies 4100a and 4100b.

The main bodies 4100a and 4100b each include a driver unit 4101, an antenna 4102, and a secondary battery 4103. A display portion 4104 may also be included. Moreover, a substrate where a circuit such as a wireless IC is provided, a terminal for charge, and the like are preferably included. Furthermore, a microphone may be included.

A case 4110 includes a secondary battery 4111. Moreover, a substrate where a circuit such as a wireless IC or a charge control IC is provided, and a terminal for charge are preferably included. Furthermore, a display portion, a button, and the like may be included.

The main bodies 4100a and 4100b can communicate wirelessly with another electronic device such as a smartphone. Thus, sound data and the like transmitted from another electronic device can be played through the main bodies 4100a and 4100b. When the main bodies 4100a and 4100b include a microphone, sound captured by the microphone is transmitted to another electronic device, and sound data obtained by processing with the electronic device can be transmitted to and played through the main bodies 4100a and 4100b. Hence, the wireless earphones can be used as a translator, for example.

The secondary battery 4103 included in the main body 4100a can be charged by the secondary battery 4111 included in the case 4110. As the secondary battery 4111 and the secondary battery 4103, the coin-type secondary battery or the cylindrical secondary battery of the above embodiment, for example, can be used. A secondary battery whose positive electrode includes the positive electrode active material 100 obtained in Embodiment 1 has a high energy density; thus, with the use of the secondary battery as the secondary battery 4103 and the secondary battery 4111, space saving required with downsizing of the wireless earphones can be achieved.

FIG. 24A illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not shown, the cleaning robot 6300 is provided with a tire, an inlet, and the like. The cleaning robot 6300 is self-propelled, detects dust 6310, and sucks up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object, such as a wire, that is likely to be caught by the brush 6304 by image analysis, the rotation of the brush 6304 can be stopped. The cleaning robot 6300 includes the secondary battery 6306 of one embodiment of the present invention and a semiconductor device or an electronic component. The cleaning robot 6300 including the secondary battery 6306 of one embodiment of the present invention can be a highly reliable electronic device that can operate for a long time.

FIG. 24B illustrates an example of a robot. A robot 6400 illustrated in FIG. 24B includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with the user using the microphone 6402 and the speaker 6404.

The display portion 6405 has a function of displaying various kinds of information. The robot 6400 can display information desired by a user on the display portion 6405. The display portion 6405 may be provided with a touch panel. Moreover, the display portion 6405 may be a detachable information terminal, in which case charging and data communication can be performed when the display portion 6405 is set at the home position of the robot 6400.

The upper camera 6403 and the lower camera 6406 each have a function of capturing an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 includes the secondary battery 6409 of one embodiment of the present invention and a semiconductor device or an electronic component. The robot 6400 including the secondary battery of one embodiment of the present invention can be a highly reliable electronic device that can operate for a long time.

FIG. 24C illustrates an example of a flying object. A flying object 6500 illustrated in FIG. 24C includes propellers 6501, a camera 6502, a secondary battery 6503, and the like and has a function of flying autonomously.

For example, image data captured by the camera 6502 is stored in an electronic component 6504. The electronic component 6504 can analyze the image data to detect whether there is an obstacle in the way of the movement. Moreover, the electronic component 6504 can estimate the remaining battery level from a change in the power storage capacity of the secondary battery 6503. The flying object 6500 includes the secondary battery 6503 of one embodiment of the present invention. The flying object 6500 including the secondary battery of one embodiment of the present invention can be a highly reliable electronic device that can operate for a long time.

This embodiment can be implemented in appropriate combination with the other embodiments.

### Embodiment 5

In this embodiment, examples of vehicles each including the secondary battery containing a positive electrode active material of one embodiment of the present invention are described.

The use of secondary batteries in vehicles enables production of next-generation clean energy vehicles such as hybrid electric vehicles (HVs), electric vehicles (EVs), and plug-in hybrid electric vehicles (PHVs).

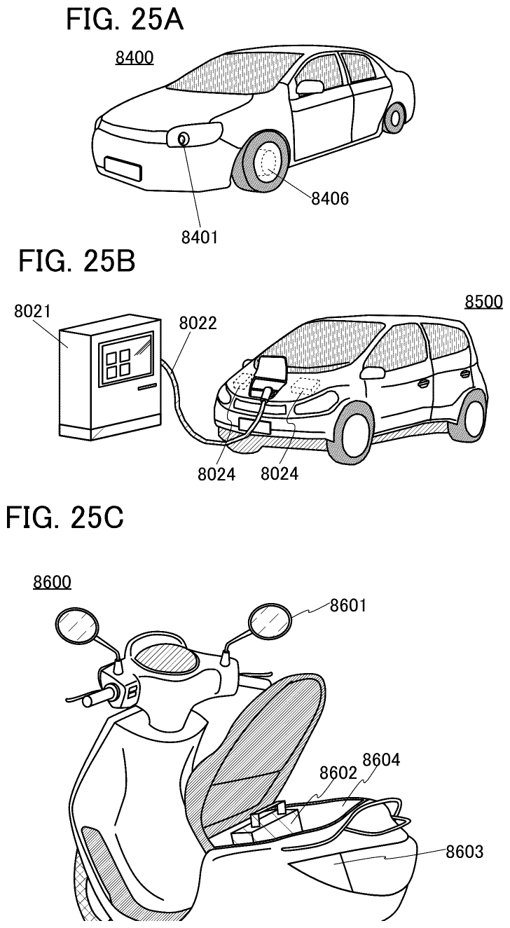

FIG. 25 illustrates examples of a vehicle including the secondary battery of one embodiment of the present invention. An automobile 8400 illustrated in FIG. 25A is an electric vehicle that runs on the power of an electric motor. Alternatively, the automobile 8400 is a hybrid electric vehicle capable of driving using either an electric motor or an engine as appropriate. The use of one embodiment of the present invention can achieve a high-mileage vehicle. The automobile 8400 includes the secondary battery. For example, the modules of the secondary battery can be arranged in a floor portion in the automobile to be used. The secondary battery can be used not only for driving an electric motor 8406, but also for supplying electric power to a light-emitting device such as a headlight 8401 and a room light (not illustrated).

The secondary battery can also supply power to a display device included in the automobile 8400, such as a speedometer or a tachometer. Furthermore, the secondary battery can supply power to a semiconductor device included in the automobile 8400, such as a navigation system.

An automobile 8500 illustrated in FIG. 25B can be charged when the secondary battery included in the automobile 8500 is supplied with electric power through external charge equipment by a plug-in system, a contactless power feeding system, and/or the like. FIG. 25B illustrates a state where a secondary battery 8024 provided in the automobile 8500 is charged from a ground installation type charging apparatus 8021 through a cable 8022. In charging, a given method such as CHAdeMO (registered trademark) or Combined Charging System may be employed as a charging method, the standard of a connector, and the like as appropriate. The charging apparatus 8021 may be a charging station provided in a commerce facility or a power source in a house. For example, with the use of a plug-in technique, the secondary battery 8024 provided in the automobile 8500 can be charged by being supplied with power from outside. Charging can be performed by converting AC electric power into DC electric power through a converter such as an ACDC converter.

Although not illustrated, the vehicle may include a power receiving device so that it can be charged by being supplied with electric power from an above-ground power transmitting device in a contactless manner. In the case of the contactless power feeding system, by fitting a power transmitting device in a road and/or an exterior wall, charging can be performed not only when the vehicle is stopped but also when driven. In addition, the contactless power feeding system may be utilized to perform transmission and reception of electric power between vehicles.

Furthermore, a solar cell may be provided in the exterior of the vehicle to charge the secondary battery when the vehicle stops and/or moves. To supply electric power in such a contactless manner, an electromagnetic induction method and/or a magnetic resonance method can be used. In addition, FIG. 25C is an example of a motorcycle using the secondary battery of one embodiment of the present invention. A motor scooter 8600 illustrated in FIG. 25C includes a secondary battery 8602, side mirrors 8601, and direction indicators 8603. The secondary battery 8602 can supply electricity to the direction indicators 8603.

Furthermore, in the motor scooter 8600 illustrated in FIG. 25C, the secondary battery 8602 can be stored in an under-seat storage 8604. The secondary battery 8602 can be stored in the under-seat storage 8604 even when the under-seat storage 8604 is small. The secondary battery 8602 is detachable; thus, the secondary battery 8602 is carried indoors when charged, and is stored before the motor scooter is driven.

According to one embodiment of the present invention, the secondary battery can have improved cycle performance and the discharge capacity of the secondary battery can be increased. Thus, the secondary battery itself can be made more compact and lightweight. The compact and lightweight secondary battery contributes to a reduction in the weight of a vehicle, and thus increases the mileage. Furthermore, the secondary battery included in the vehicle can be used as a power supply source for supplying electric power to products other than the vehicle. In such a case, the use of a commercial power supply can be avoided at peak time of electric power demand, for example. Avoiding the use of a commercial power supply at peak time of electric power demand can contribute to energy saving and a reduction in carbon dioxide emissions. Moreover, the secondary battery with excellent cycle performance can be used over a long period; thus, the use amount of rare metals typified by cobalt can be reduced.

This embodiment can be implemented in appropriate combination with the other embodiments.

### Embodiment 6

In this embodiment, thermal runaway, a nail penetration test, and the like of a secondary battery will be explained and the principle or the like that ignition is less likely to occur when a secondary battery including the positive electrode active material 100 of one embodiment of the present invention is subjected to a nail penetration test will be described.

### <Thermal Runaway of Secondary Battery>

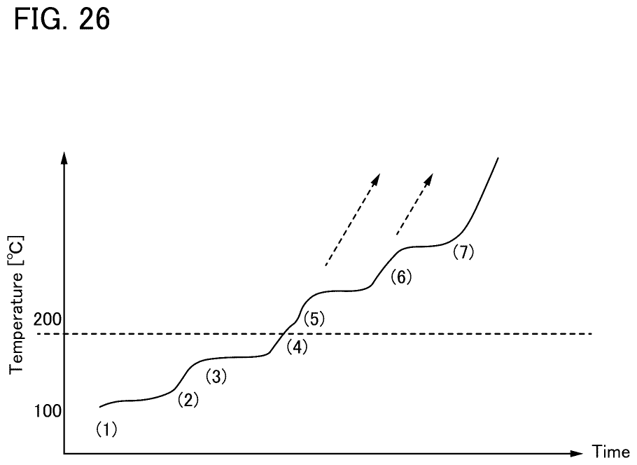

FIG. 26 shows a graph obtained by partly modifying the graph cited from [FIG. 2-11] on page 69 of Non-Patent Document 4. The graph in FIG. 26 shows the internal temperature (hereinafter simply referred to as temperature) of a secondary battery with respect to time. According to the graph, when the temperature rises, the secondary battery enters thermal runaway after passing through several states.

In general, when the temperature of the secondary battery reaches 100° C. or the vicinity thereof, (1) collapse of SEI (solid electrolyte interphase) of a negative electrode and heat generation are caused. When the temperature of the secondary battery exceeds 100° C., (2) reduction of an electrolyte solution by the negative electrode (the negative electrode is CeLi when graphite is used) and heat generation are caused, and (3) oxidation of the electrolyte solution by a positive electrode and heat generation are caused. When the temperature of the secondary battery reaches 180° C. or the vicinity thereof, (4) thermal decomposition of the electrolyte solution is caused and (5) oxygen release from the positive electrode and thermal decomposition of the positive electrode (the thermal decomposition includes a structural change in a positive electrode active material) are caused. After that, when the temperature of the secondary battery exceeds 200° C., (6) decomposition of the negative electrode is caused, and finally, (7) the positive electrode and the negative electrode come into direct contact with each other. The secondary battery enters thermal runaway after passing through the state (5), the state (6), the state (7), or the like. Thus, to prevent thermal runaway, the temperature rise of the secondary battery is preferably inhibited and the negative electrode, the positive electrode, and/or the electrolyte solution is/are preferably kept stable at high temperatures exceeding 100° C.

The positive electrode active material 100 of one embodiment of the present invention has a stable crystal structure and an effect of inhibiting release of oxygen. Thus, the secondary battery using the positive electrode active material 100 probably does not come into a state after at least the state (5) and the temperature rise of the secondary battery is probably inhibited, leading to a significant effect that thermal runaway is less likely to occur. This can be evaluated by endothermic-exothermic (DSC) measurement of a sample in which an electrolyte solution is added to a positive electrode including the positive electrode active material 100, a nail penetration test of a secondary battery including the positive electrode active material 100, or the like, for example.

It is considered that the peak appearing at higher than or equal to 250° C. and lower than or equal to 300° C. in DSC measurement results from release of oxygen from the positive electrode active material and subsequent thermal decomposition. It can be said that the higher temperature of this peak or the higher temperature of the local maximum value provides a higher thermal stability. For example, in DSC measurement of a sample in which a positive electrode including the positive electrode active material 100 is put into an electrolyte solution, a peak that appears at higher than or equal to 250° C. and lower than or equal to 300° C. preferably exhibits a local maximum value at higher than or equal to 260° C., further preferably higher than or equal to 270° C. The heat flow per weight of the positive electrode active material at the local maximum value is preferably small.

The temperature rise of the secondary battery when the nail penetration test is conducted, i.e., the difference between the temperature before the nail penetration test and the maximum temperature reached after the nail penetration test, is preferably less than or equal to 130° C., further preferably less than or equal to 100° C., still further preferably less than or equal to 80° C., yet still further preferably less than or equal to 60° C.

### <Nail Penetration Test>

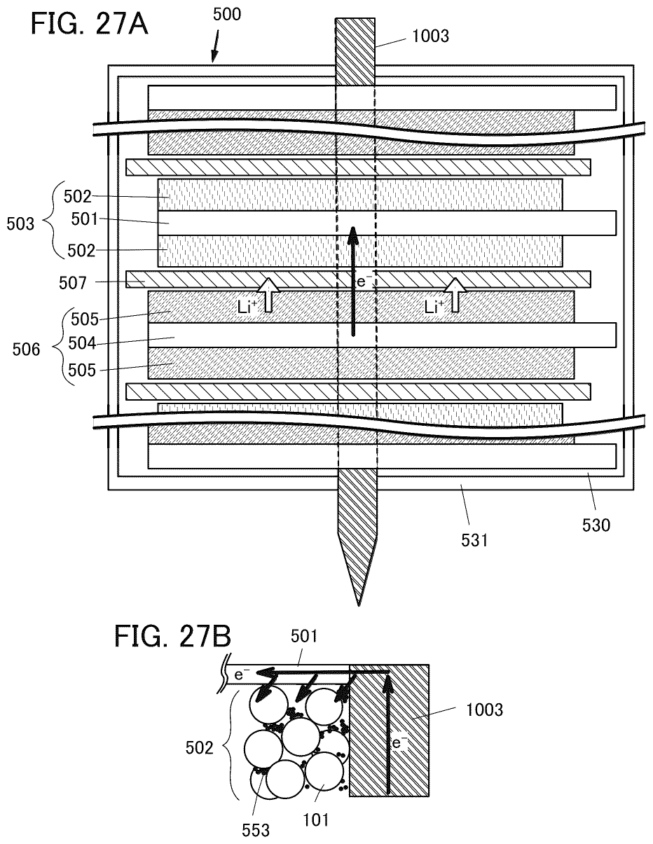

Next, a nail penetration test is described with reference to FIG. 27A to FIG. 27C and the like. In the nail penetration test, a nail 1003 having a predetermined diameter selected from a range of 2 mm to 10 mm penetrates the secondary battery 500 in a fully charged state (a state at 100% state of charge (SOC)) at a predetermined speed selected from a range of 1 mm/s to 20 mm/s, for example. FIG. 27A is a cross-sectional view illustrating a state where the nail 1003 penetrates the secondary battery 500. The secondary battery 500 has a structure in which the positive electrode 503, the separator 507, the negative electrode 506, and an electrolyte solution 530 are held in an exterior body 531. The positive electrode 503 includes a positive electrode current collector 501 and positive electrode active material layers 502 formed over both surfaces of the positive electrode current collector 501. The negative electrode 506 includes a negative electrode current collector 504 and negative electrode active material layers 505 formed over both surfaces of the negative electrode current collector 504. FIG. 27B is an enlarged view of the nail 1003 and the positive electrode current collector 501. The enlarged view details the positive electrode active material 100 of one embodiment of the present invention and a conductive material 553, which are included in the positive electrode active material layer 502.

As illustrated in FIG. 27A and FIG. 27B, when the nail 1003 penetrates the positive electrode 503 and the negative electrode 506, an internal short circuit occurs. This makes the potential of the nail 1003 equal to that of the negative electrode, so that an electron (e⁻) flows to the positive electrode 503 through the nail 1003 and the like as indicated by the arrow and Joule heat is generated in the portion where the internal short circuit has occurred and the vicinity of the portion. The internal short circuit causes carrier ions, typically lithium ions (Li⁺), to be extracted from the negative electrode 506 and to be released into the electrolyte solution as indicated by white arrows. Note that before all the lithium ions are released from the negative electrode, reductive decomposition of the electrolyte solution starts on the negative electrode surface owing to a rapid increase in the battery temperature by the Joule heat generated by the internal short circuit. This is referred to as a reduction reaction of an electrolyte solution by the negative electrode. Then, the electron (e⁻) that has flowed to the positive electrode 503 reduces the transition metal M, which is tetravalent in NCM in the charged state, so that the transition metal becomes trivalent or divalent. This reduction reaction causes oxygen release from NCM, and the electrolyte solution 530 is decomposed by the released oxygen or the like. This is referred to as an oxidation reaction of an electrolyte solution by a positive electrode.

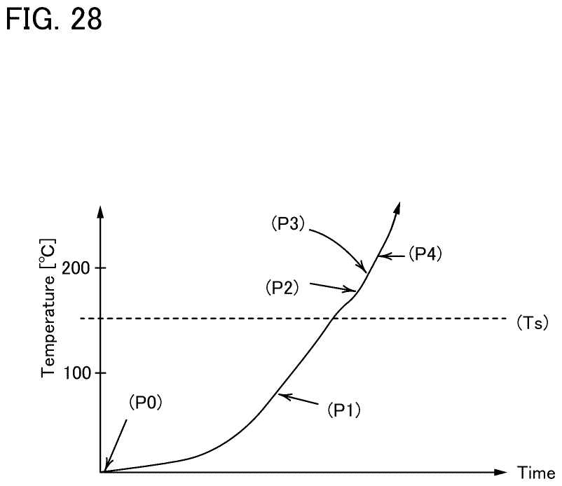

When an internal short circuit of a secondary battery occurs, its temperature changes as shown in the graph of FIG. 28. FIG. 28 is a graph obtained by partly modifying the graph cited from [FIG. 2-12] on page 70 of Non-Patent Document 4. This graph shows the temperature of a secondary battery with respect to time. According to the graph, upon an internal short circuit at (P0), the temperature of the secondary battery increases over time. Specifically, when the temperature of the secondary battery reaches 100° C. or the vicinity thereof because of Joule heat as indicated by (P1), the temperature exceeds the reference temperature (Ts) of the secondary battery. Then, reduction of an electrolyte solution by a negative electrode (the negative electrode is C₆Li when graphite is used) and heat generation of the electrolyte solution are caused at (P2), oxidation of the electrolyte solution by a positive electrode and heat generation of the electrolyte solution are caused at (P3), and heat generation due to thermal decomposition of the electrolyte solution is caused at (P4). Accordingly, the secondary battery enters thermal runaway, resulting in ignition or the like.

In the positive electrode active material at this time, a reaction occurs in which electrons rapidly flowing into the positive electrode active material reduce the transition metal M (e.g., cobalt becomes Co²⁺ from Co⁴⁺) and oxygen is released from the positive electrode active material. Since this is an exothermic reaction, positive feedback is applied to thermal runaway. In other words, inhibiting this reaction enables a positive electrode active material that does not easily undergoes thermal runaway.

Thus, in a surface portion of a positive electrode active material where the reaction easily occurs, the concentration of a metal that is less likely to release oxygen is preferably high. When oxygen is less likely to be released from the positive electrode active material, the above reduction reaction (e.g., the reaction in which Co⁴⁺ becomes Co²⁺) is inhibited. A metal that is less likely to release oxygen is a metal that forms a stable metal oxide, such as magnesium or aluminum. Nickel is also presumed to have an effect of inhibiting release of oxygen when it exists at a lithium site.

In the case where a nail penetration test is performed on a secondary battery using the positive electrode active material 100 of one embodiment of the present invention, the positive electrode active material 100 has a unique effect of inhibiting release of oxygen owning to the above-described barrier film; thus, it is considered that an oxidation reaction of the electrolyte solution and heat generation can be inhibited. Furthermore, the barrier film in the surface portion of the positive electrode active material 100 has characteristics close to those of an insulator; thus, the speed of current flowing into the positive electrode at the time of an internal short circuit probably becomes low. In that case, a significant effect that thermal runaway is less likely to occur and thus ignition or the like is less likely to occur can be obtained.

Even when the transition metal M such as cobalt is reduced, insertion of lithium ions into the positive electrode active material before oxygen release can maintain electrical neutrality and thus prevent exothermic reaction with oxygen release. Even when electrons rapidly flow into the positive electrode active material, the crystal structure of the positive electrode active material remains stable at least until insertion of lithium ions into the inner portion of the positive electrode active material from the negative electrode through the electrolyte solution is completed.

### Example 1

In this example, the positive electrode active material 100 of one embodiment of the present invention was formed and features thereof were analyzed.

### <Formation of Positive Electrode Active Material>

Samples formed in this example are described with reference to the formation methods shown in FIG. 18 and FIG. 19.

As LiCoO₂ in Step S14 in FIG. 18, commercially available lithium cobalt oxide (CELLSEED C-10N produced by NIPPON CHEMICAL INDUSTRIAL CO., LTD.) containing cobalt as the transition metal M and no additive element was prepared. The initial heating in Step S15 was performed on the lithium cobalt oxide, which was put in a crucible covered with a lid, in a muffle furnace at 850° C. for 2 hours. After the muffle furnace was filled with an oxygen atmosphere, no flowing was performed (O₂ purging). The collected amount after the initial heating showed a slight decrease in weight. The decrease in weight was probably caused by elimination of impurities such as lithium carbonate from the lithium cobalt oxide.

In accordance with Step S21 and Step S41 shown in FIG. 19A and FIG. 19C, Mg, L, Ni, and Al were separately added as the additive elements. In accordance with Step S21 shown in FIG. 19A, LiF and MgF₂ were prepared as the F source and the Mg source, respectively. The LiF and MgF₂ were weighed such that LiF:MgF₂=1:3 (molar ratio). Then, LiF and MgF₂ were mixed into dehydrated acetone and the mixture was stirred at a rotating speed of 400 rpm for 12 hours, whereby the additive element source (41 source) was produced. In the mixing, a ball mill was used and a grinding medium was zirconium oxide balls. The F source and Mg source weighing approximately 9 g in total were put in a 45-mL-capacity container of the mixing ball mill together with 20 mL of dehydrated acetone and 22 g of zirconium oxide balls (1 mmo) and mixed.

Then, the mixture was made to pass through a sieve with an aperture of 300 μm, whereby the A1 source was obtained.

Next, as Step S31, the Al source was weighed to be 1 mol % with respect to lithium cobalt oxide, and mixed with lithium cobalt oxide subjected to the initial heating by a dry method. At this time, stirring was performed at a rotational speed of 150 rpm for 1 hour. These conditions were milder than those of the stirring in the production of the Al source. Finally, the mixture was made to pass through a sieve with an aperture of 300 μm, whereby the mixture 903 having a uniform particle diameter was obtained (Step S32).

Next, as Step S33, the mixture 903 was heated. The heating conditions were 900° C. and 20 hours. During the heating, a lid was put on a crucible containing the mixture 903. The crucible was filled with an atmosphere containing oxygen and entry and exit of the oxygen were blocked (purged). By the heating, a composite oxide containing Mg and F was obtained (Step S34a).

Then, as Step S51, the composite oxide and the additive element source (42 source) were mixed. Nickel hydroxide on which a grinding step was performed was prepared as the nickel source and aluminum hydroxide on which a grinding step was performed was prepared as the aluminum source in accordance with Step S41 shown in FIG. 19B. The nickel hydroxide was weighed to be 0.5 mol % with respect to lithium cobalt oxide and the aluminum hydroxide was weighed to be 0.5 mol % with respect to lithium cobalt oxide, and then mixing with the composite oxide was performed by a dry method. At this time, stirring was performed at a rotational speed of 150 rpm for 1 hour. In the mixing, a ball mill was used and a grinding medium was zirconium oxide balls. The composite oxide, the nickel source, and the aluminum source weighing approximately 7.5 g in total were put in a 45-mL-capacity container of the mixing ball mill together with 22 g of zirconium oxide balls (1 mm @) and mixed. These conditions were milder than those of the stirring in the production of the Al source. Finally, the mixture was made to pass through a sieve with an aperture of 300 μm, whereby a mixture 904 having a uniform particle diameter was obtained (Step S52).

Next, as Step S53, the mixture 904 was heated. The heating conditions were 850° C. and 10 hours. During the heating, a lid was put on a crucible containing the mixture 904. The crucible was filled with an atmosphere containing oxygen and entry and exit of the oxygen were blocked (purged). By the heating, lithium cobalt oxide containing Mg, F, Ni, and Al was obtained (Step S54). The positive electrode active material (composite oxide) obtained in the above manner was used as Sample 1-1.

Sample 2 was not subjected to the heating in Step S15. In Sample 2, the flow rate of oxygen at the time of the heating in Step S53 was 10 L/min.

As another comparative example, lithium cobalt oxide (CELLSEED C-10N produced by NIPPON CHEMICAL INDUSTRIAL CO., LTD.) without any particular treatment was used as Sample 10.

As Sample 11, lithium cobalt oxide which was only subjected to the heating in Step S15 was used.

Table 2 shows the formation conditions of Samples 1-1, 10, and 11.

TABLE 2

| | Formation condition | | | | | |
|---|---|---|---|---|---|---|
| | | Step S15 | | Step S33 | | Step S53 |
| | | Heating | | Heating | | Heating |
| | | temperature | Step S20a | temperature | Step S40 | tempereture |
| | Step S14 | (Time) | A1 source | (Time) | A2 source | (Time) |
| Sample 1-1 | LiCoO₂ | 850° C. (2 hr) | LiF 0.33 mol % | 900° C.(20 hr) | Ni(OH)₂ 0.5 mol % | 850° C. (10 hr) |
| | | | MgF₂ 1 mol % | | Al(OH)₃ 0.5 mol % | |
| Sample 2 | | — | LiF 0.33 mol % | 900° C.(20 hr) | Ni(OH)₂ 0.5 mol % | 850° C. (10 hr) |
| | | | MgF₂ 1 mol % | | Al(OH)₃ 0.5 mol % | |
| Sample 10 | | — | — | — | — | — |
| (Comparative | | | | | | |
| example) | | | | | | |
| Sample 11 | | 850° C. (2 hr) | — | — | — | — |

### <STEM and EDX (Energy Dispersive X-Ray Spectroscopy)>

Next, Sample 10, Sample 11, and Sample 1-1 were subjected to area analysis by STEM-EDX (for example, element mapping) and electron diffraction. Sample 2 was subjected to electron diffraction.

As pretreatment before analysis, the samples were sliced by an FIB method (μ-sampling method)

STEM and EDX were performed with the following apparatuses under the following conditions.

### <<STEM Observation>>

Scanning transmission electron microscope: JEM-ARM200F manufactured by JEOL Ltd.
Observation condition, acceleration voltage: 200 kV
Magnification accuracy: ±10%

### <<EDX>>

Analysis method: energy dispersive X-ray spectroscopy (EDX)
Scanning transmission electron microscope: JEM-ARM200F manufactured by JEOL Ltd.
Acceleration voltage: 200 kV
Beam diameter: approximately 0.1 nmφ
Element analysis apparatus: JED-2300T
X-ray detector: Si drift detector
Energy resolution: approximately 140 cV
X-ray extraction angle: 21.9°
Solid angle: 0.98 sr
Number of captured pixels: 128×128

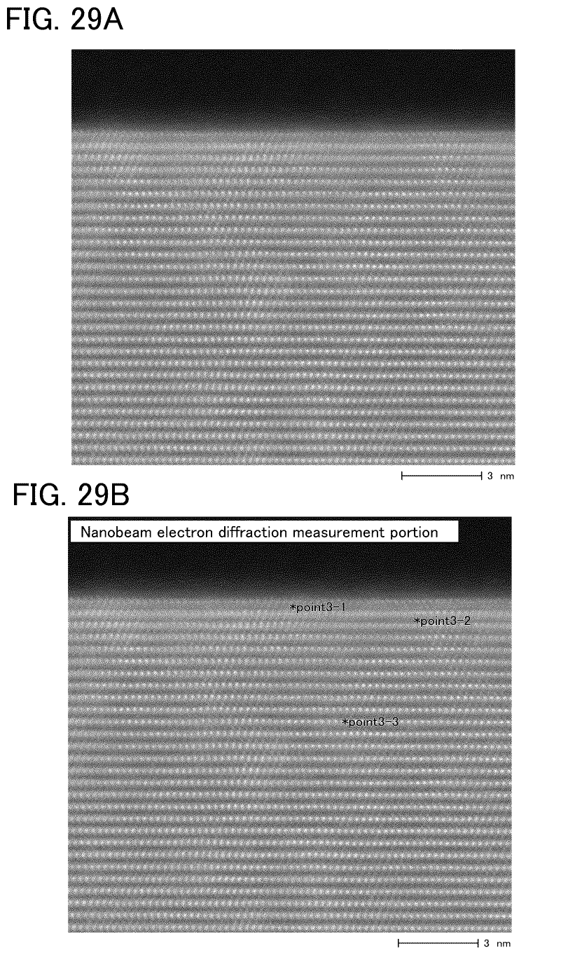

FIG. 29A and FIG. 29B show HAADF-STEM images of Sample 10. FIG. 29A shows a surface having a (001) orientation and a surface portion thereof, and FIG. 29B shows a surface having an orientation other than a (001) orientation and a surface portion thereof. In each image, a layered rock-salt crystal structure was observed. Nanobeam electron diffraction patterns are obtained at point1-1 to point1-3 and point2-1 to point2-3 in the images. Table 4 lists d values, interplanar angles, and lattice constants that are calculated on the assumption that the space group is R-3m.

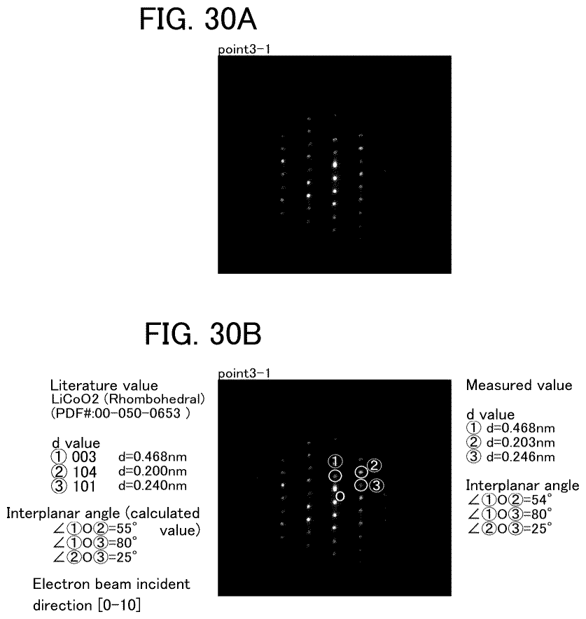

Similarly, FIG. 30A and FIG. 30B are HAADF-STEM images of Sample 11. FIG. 30A shows a surface having a (001) orientation and a surface portion thereof, and FIG. 30B shows a surface having an orientation other than a (001) orientation and a surface portion thereof. In each image, a layered rock-salt crystal structure was observed. Nanobeam electron diffraction patterns are obtained at point3-1 to point3-3 and point4-1 to point4-3 in the images. Table 4 lists d values, interplanar angles, and lattice constants that are calculated on the assumption that the space group is R-3m.

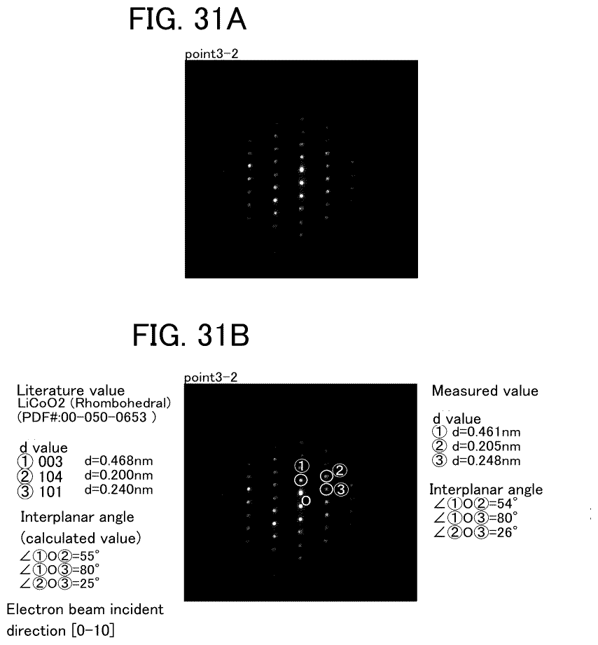

FIG. 31A is a HAADF-STEM image of a surface having a (001) orientation of Sample 1-1 and a surface portion thereof. Points where nanobeam electron diffraction patterns are obtained in FIG. 31A are denoted by point3-1 to point3-3 in FIG. 31B

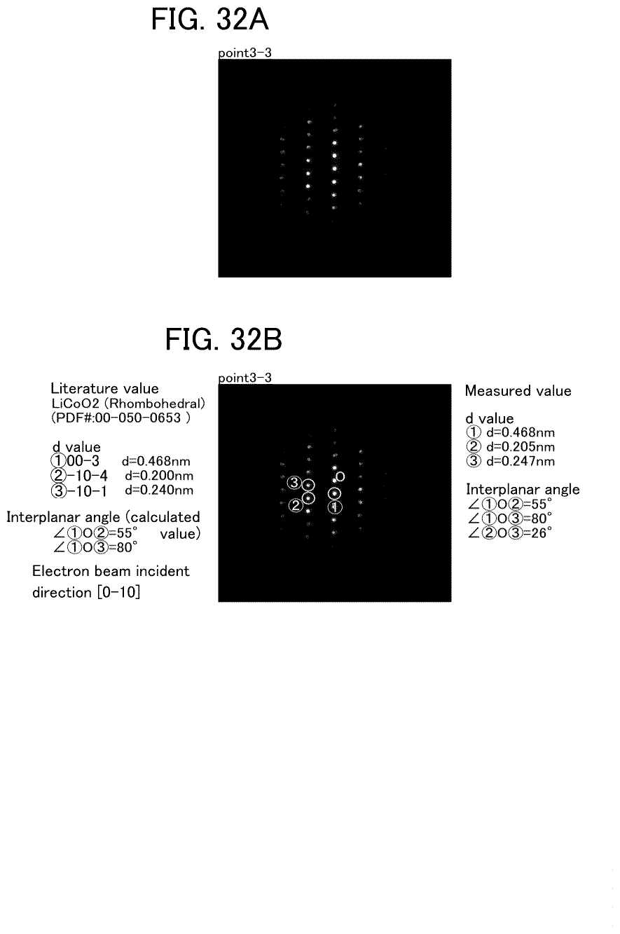

FIG. 30A shows the nanobeam electron diffraction pattern of point3-1 in FIG. 31B, and diffraction spots used for obtaining the d values and the interplanar angles are surrounded by circles in FIG. 30B. The literature values of lithium cobalt oxide (Rhombohedral) are also shown. FIG. 31A shows the nanobeam electron diffraction pattern of point3-2 in FIG. 31B, and diffraction spots used for obtaining the d values and the interplanar angles are surrounded by circles in FIG. 31B. FIG. 32A shows the nanobeam electron diffraction pattern of point3-3 in FIG. 31B, and diffraction spots used for obtaining the d values and the interplanar angles are surrounded by circles in FIG. 32B. Table 4 lists the d values, the interplanar angles, and the lattice constants that are calculated on the assumption that the space group is R-3m.

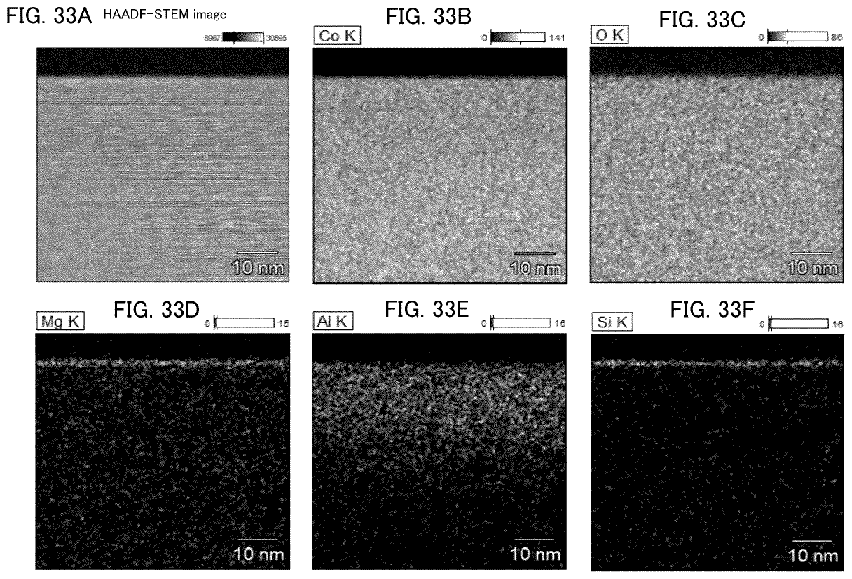

FIG. 33A is a HAADF-STEM image of the surface having a (001) orientation of Sample 1-1 and the surface portion thereof. When EDX area analysis was performed on this region, C, O, F, Mg, Al, Si, Ca, Co, and Ga were detected. Ga was probably derived from FIB processing. Si and Ca were probably a small amount of Si and a small amount of Ca that were contained in LiCoO₂ used in Step S14 and were unevenly distributed in the surface. FIG. 33B to FIG. 33F are mapping images of cobalt and oxygen, which were main elements, and magnesium, aluminum, and silicon, which were obviously unevenly distributed.

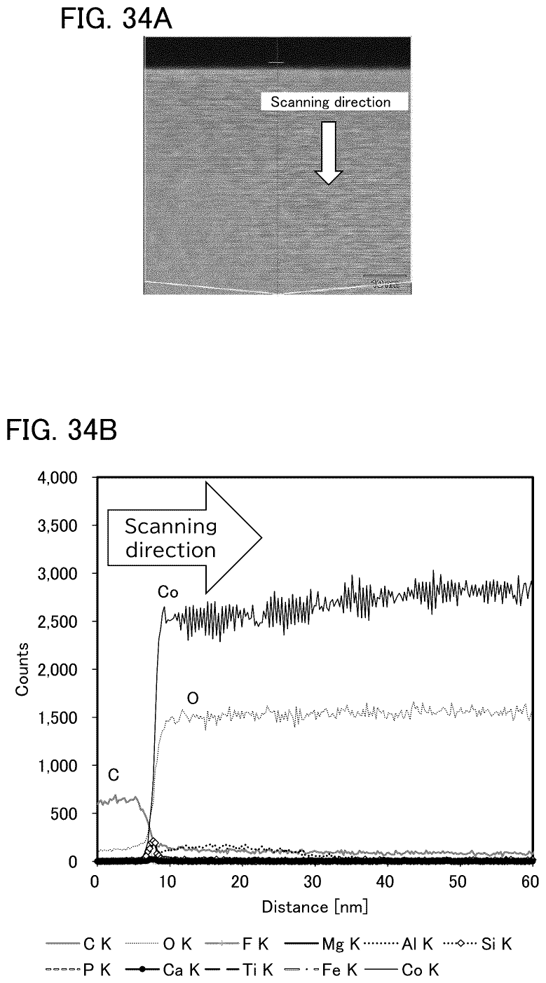

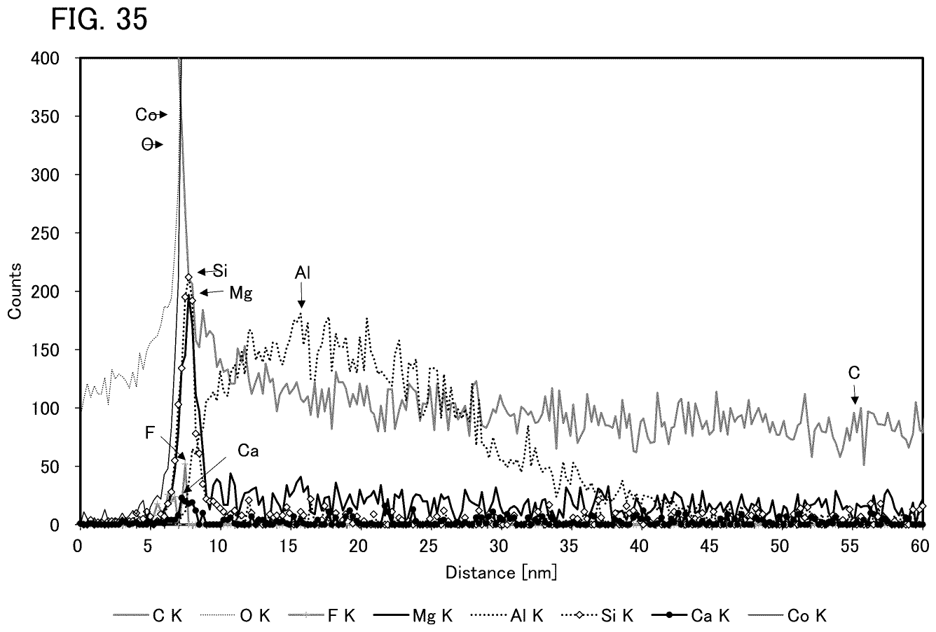

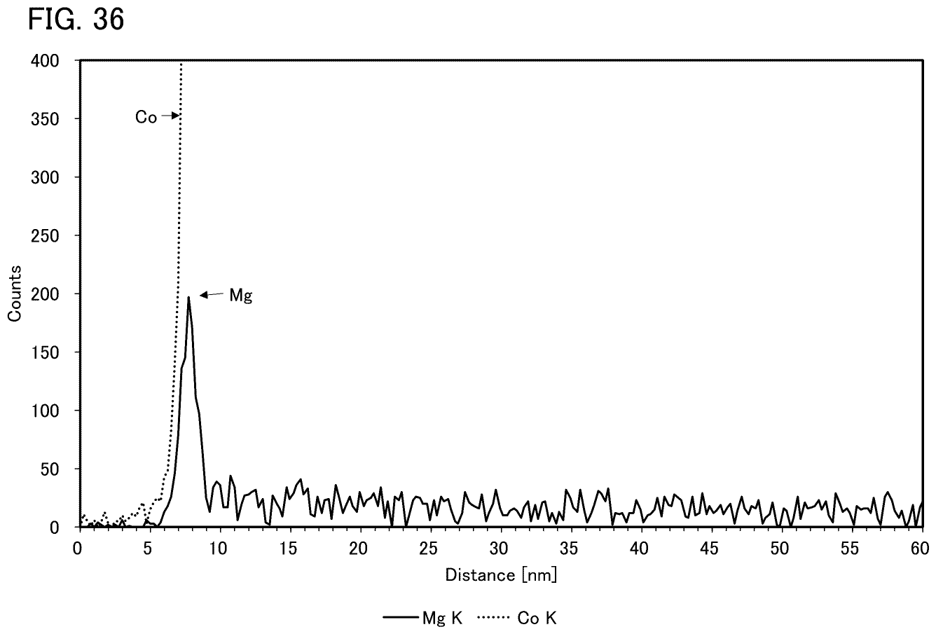

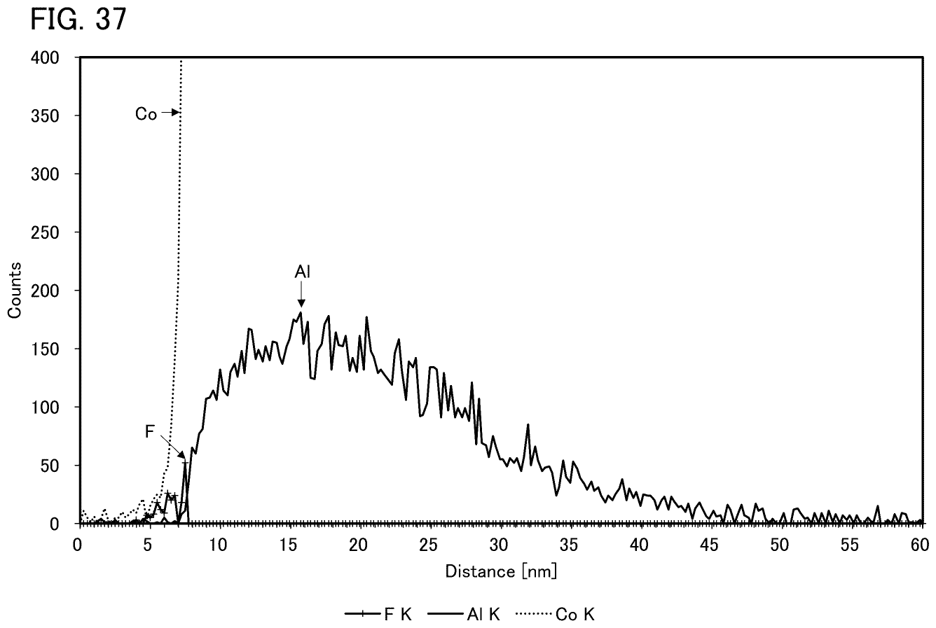

FIG. 34A is a HAADF-STEM image of the surface having a (001) orientation of Sample 1-1 and the surface portion thereof, and in this image, the scanning direction of the STEM-EDX line analysis is indicated by an arrow. FIG. 34B shows a profile of the STEM-EDX line analysis of this region. The vertical axis represents counts and the horizontal axis represents distance. FIG. 35 is an enlarged view of FIG. 34B in the vertical direction. FIG. 36 shows the profiles of cobalt and magnesium extracted from FIG. 35, and FIG. 37 shows the profiles of cobalt, aluminum, and fluorine extracted from FIG. 35.

From the profiles in FIG. 34B to FIG. 37, the reference point was estimated to be a point at a distance of 7.95 nm. Specifically, a region avoiding the vicinity of a portion where the detected amount of cobalt began to increase was defined as a distance of 0.25 to 3.49 nm in FIG. 34B and FIG. 35. A region where the counts of cobalt and oxygen atoms were saturated and stabilized corresponded to a distance of 56.1 nm to 59.3 nm. When Co that is the transition metal M was used, a point that represents 50% of the sum of M_{AVE} and M_{BG} was 1408.1 counts, and the reference point estimated using the calculated regression line corresponded to 7.95 nm. Plus or minus 1 nm is regarded as an error.

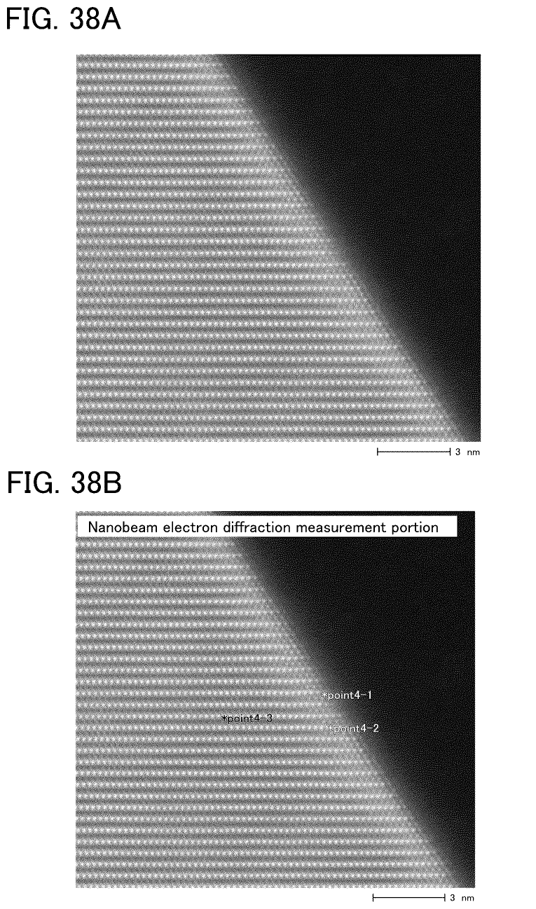

FIG. 38A is a HAADF-STEM image of a surface not having a (001) orientation of Sample 1-1 and a surface portion thereof. Points where nanobeam electron diffraction patterns are obtained in FIG. 38A are denoted by point4-1 to point4-3 in FIG. 38B.

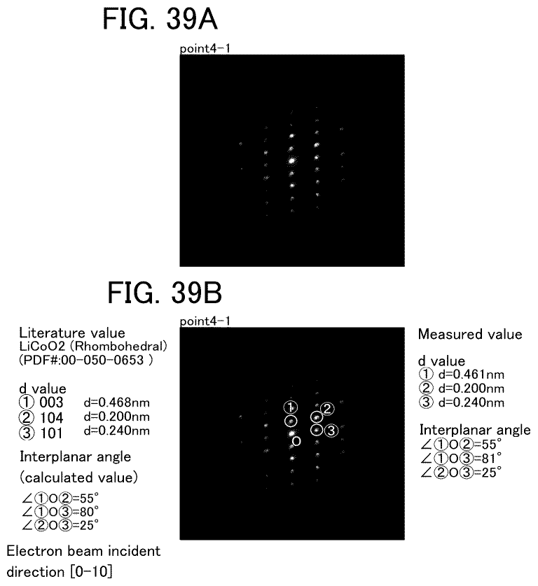

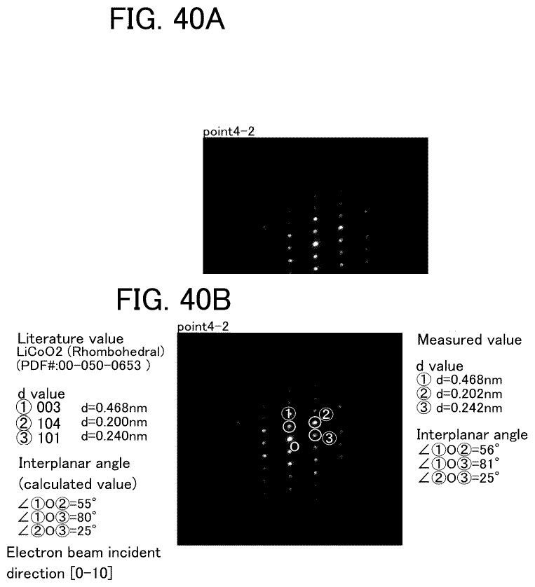

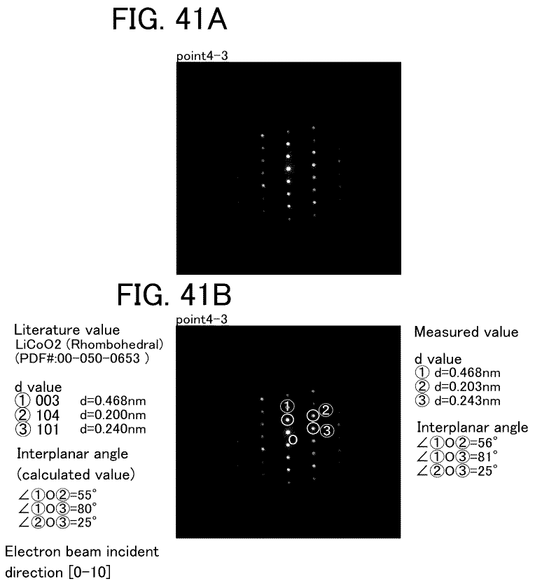

FIG. 39A shows the nanobeam electron diffraction pattern of point4-1 in FIG. 38B, and diffraction spots used for obtaining the d values and the interplanar angles are surrounded by circles in FIG. 39B. The literature value of lithium cobalt oxide is also shown. FIG. 40A shows the nanobeam electron diffraction pattern of point4-2 in FIG. 38B, and diffraction spots used for obtaining the d values and the interplanar angles are surrounded by circles in FIG. 40B. FIG. 41A shows the nanobeam electron diffraction pattern of point4-3 in FIG. 38B, and diffraction spots used for obtaining the d values and the interplanar angles are surrounded by circles in FIG. 41B. Table 4 lists the d values, the interplanar angles, and the lattice constants that are calculated on the assumption that the space group is R-3m.

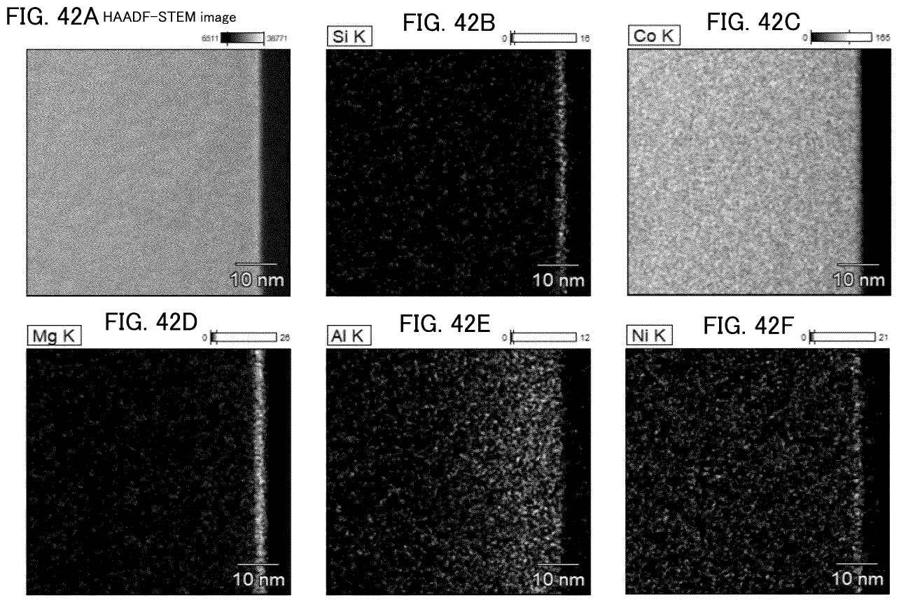

FIG. 42A is a HAADF-STEM image of the surface not having a (001) orientation of Sample 1-1 and the surface portion thereof. When EDX area analysis was performed on this region, C, O, F, Mg, Al, Si, Co, Ni, and Ga are detected. FIG. 42B to FIG. 42F are mapping images of cobalt, which was main elements, and silicon, magnesium, aluminum, and nickel, which were obviously unevenly distributed.

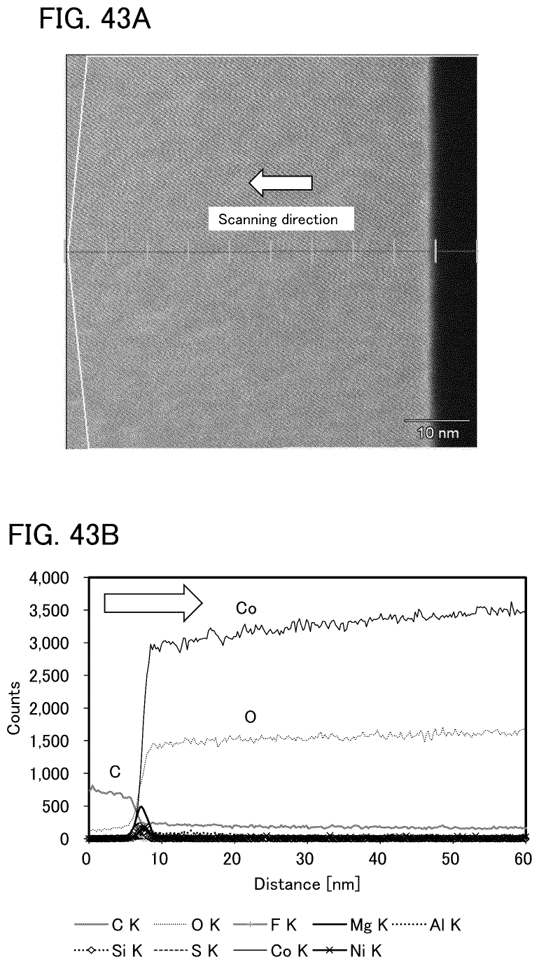

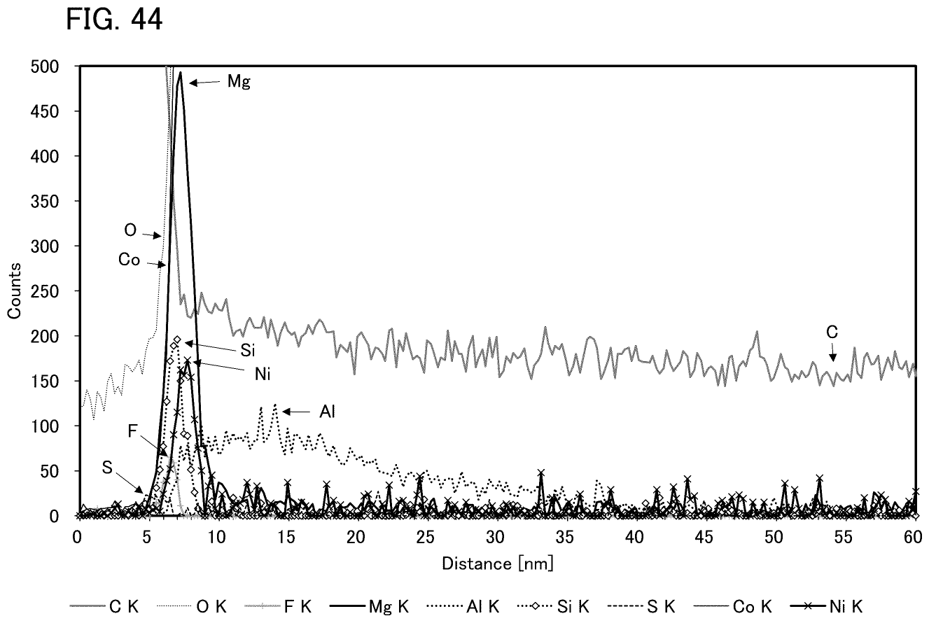

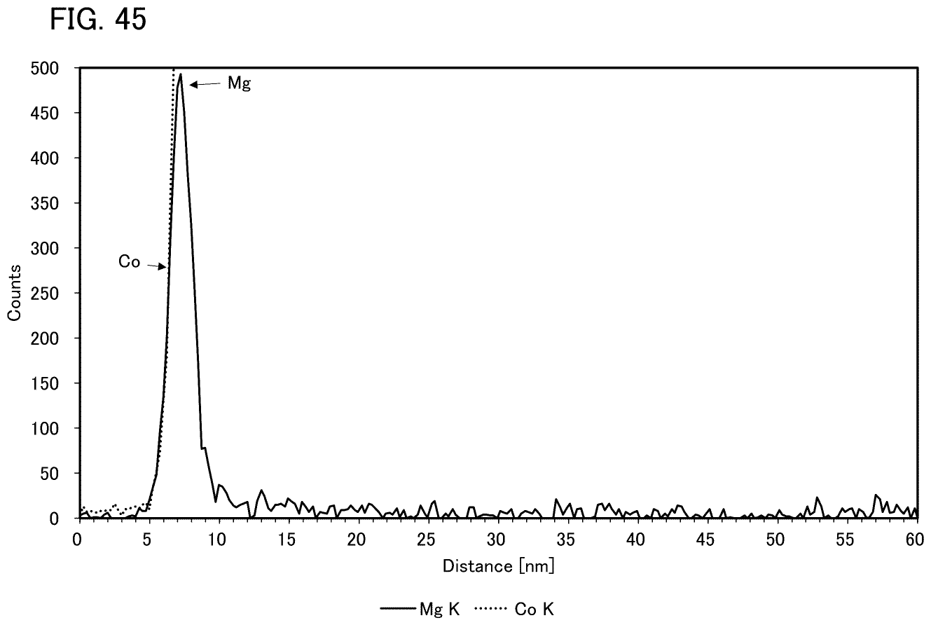

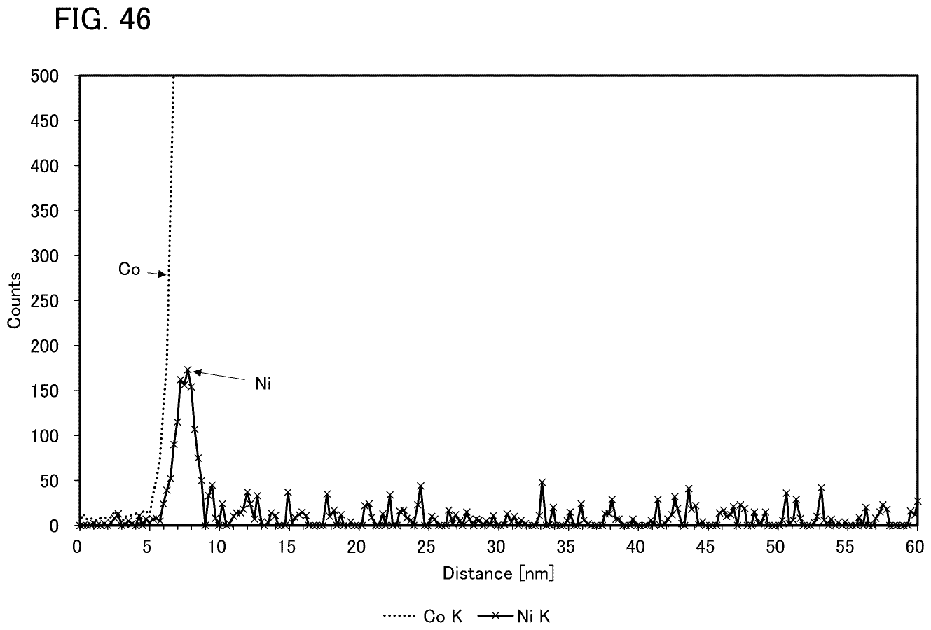

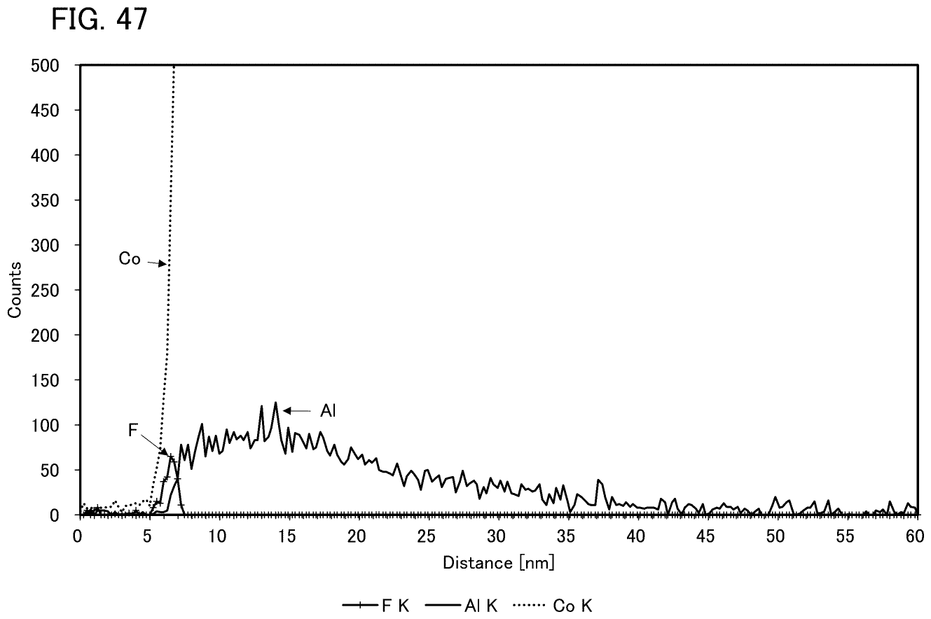

FIG. 43A is a HAADF-STEM image of the surface not having a (001) orientation of Sample 1-1 and the surface portion thereof, and in this image, the scanning direction of the STEM-EDX line analysis is indicated by an arrow. FIG. 43B shows a profile of the STEM-EDX line analysis of this region. FIG. 44 is an enlarged view of FIG. 43B in the vertical direction. FIG. 45 shows the profiles of cobalt and magnesium extracted from FIG. 44, FIG. 46 shows the profiles of cobalt and nickel extracted from FIG. 44, and FIG. 47 shows the profiles of cobalt, aluminum, and fluorine extracted from FIG. 44.

From the profiles in FIG. 43B to FIG. 47, the reference point was estimated to be 7.45 nm. Specifically, a region avoiding the vicinity where the detected amount of cobalt began to increase was defined as a distance of 0.25 to 3.49 nm in FIG. 43B and FIG. 44. A region where the counts of cobalt and oxygen atoms were saturated and stabilized corresponded to 56.1 nm to 59.3 nm. When Co that is the transition metal M was used, a point that represents 50% of the sum of M_{AVE} and M_{BG} was 1749.0 counts, and the reference point estimated using the calculated regression line corresponded to 7.45 nm. Plus or minus 1 nm is regarded as an error. Comparison between the surface having a (001) orientation and the surface not having a (001) orientation revealed the following facts.

Nickel was not detected at the surface having a (001) orientation, and was detected at the surface not having a (001) orientation. The ratio of manganese or aluminum to cobalt was different between the surface having a (001) orientation and the surface not having a (001) orientation.

Specifically, the intensity ratio of the additive elements to cobalt was Mg/Co=0.07 and Al/Co=0.06 at the surface having a (001) orientation. The half width of the distribution of magnesium was 1.38 nm.

In contrast, the intensity ratio of the additive elements to cobalt was Mg/Co=0.14, Al/Co=0.04, and Ni/Co=0.05 at the surface not having a (001) orientation. The half width of the distribution of magnesium is 1.90 nm, and the half width of the distribution of nickel is 1.67 nm.

At the surface not having a (001) orientation, nickel was distributed closer to the surface side than aluminum, and magnesium was distributed closer to the surface side than nickel.

Furthermore, the surface not having a (001) orientation had a smaller intensity ratio Al/Co than the surface having a (001) orientation, which indicates that aluminum was diffused into the positive electrode active material at the surface not having a (001) orientation.

At each surface, magnesium was distributed closer to the surface side than aluminum. As indicated by the above-described half width, the shape of the distribution of magnesium was sharper than that of aluminum. Moreover, fluorine was detected at each surface.

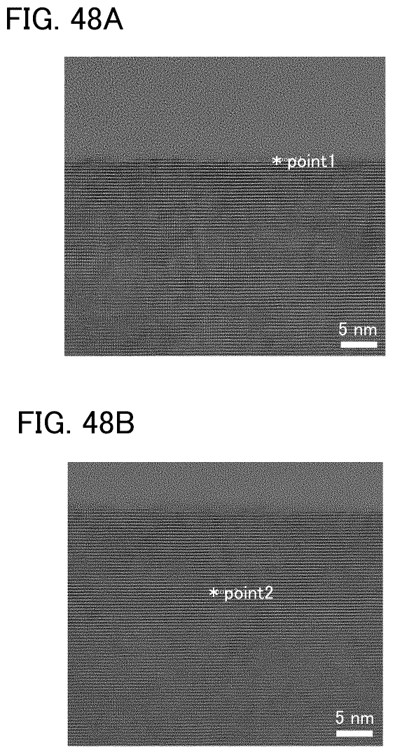

FIG. 48A and FIG. 48B are HAADF-STEM images of a surface having a (001) orientation of Sample 2 and a surface portion thereof. In these drawings, points where nanobeam electron diffraction patterns were obtained are denoted by point1 and point2. Although not shown, a nanobeam electron diffraction pattern was also obtained from a region inside Sample 2. Table 3 lists d values, interplanar angles, and lattice constants that are calculated on the assumption that the space group is R-3m.

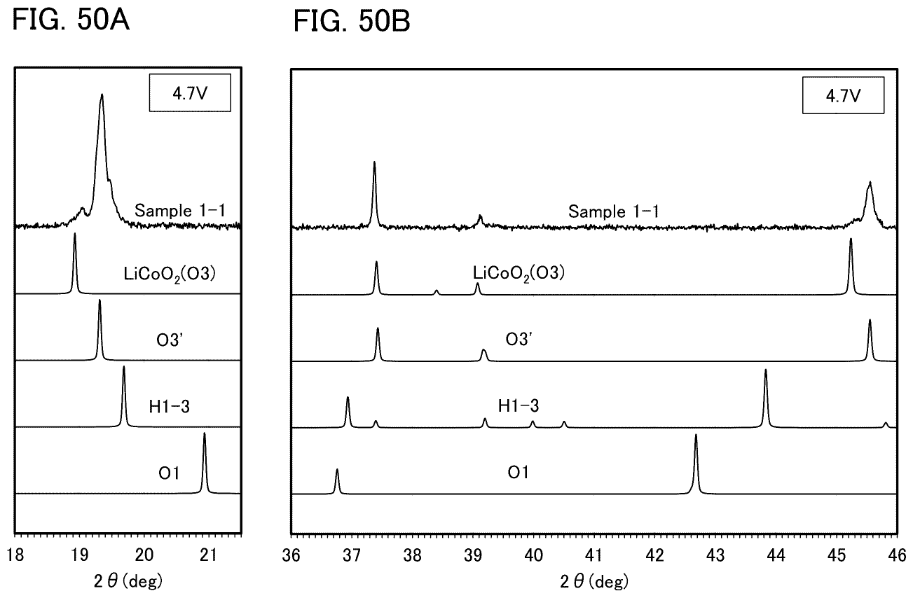

TABLE 3

| | Unit [nm] | | | | Unit [ [symbol] ] | | | | Lattice constant [ [symbol] ] | | | |
|---|---|---|---|---|---|---|---|---|---|---|---|---|
| | | Point | Point | Point | Interplanar | Point | Point | Point | | Point | Point | Point |
| Sample 10 | d value | 1-1 | 1-2 | 1-3 | angle | 1-1 | 1-2 | 1-3 | | 1-1 | 1-2 | 1-3 |
| FIG. 41(A) | \textcircled{1}101 | 0.240 | 0.239 | 0.241 | <\textcircled{1} [symbol] \textcircled{2} | 25 | 25 | 25 | [symbol] -axis | 2.81 | 2.79 | 2.82 |
| Incident direction of | \textcircled{2}104 | 0.200 | 0.200 | 0.201 | <\textcircled{1} [symbol] \textcircled{3} | 80 | 80 | 80 | [symbol] -axis | 14.07 | 14.17 | 14.15 |
| electron beam [010] | \textcircled{3}003 | 0.473 | 0.475 | 0.475 | <\textcircled{2} [symbol] \textcircled{3} | 55 | 56 | 55 | | | | |
| | | Point | Point | Point | Interplanar | Point | Point | Point | | Point | Point | Point |
| Sample 10 | d value | 2-1 | 2-2 | 2-3 | angle | 2-1 | 2-2 | 2-3 | | 2-1 | 2-2 | 2-3 |
| FIG. 41( [symbol] ) | \textcircled{1}101 | 0.243 | 0.243 | 0.240 | <\textcircled{1} [symbol] \textcircled{2} | 25 | 25 | 25 | [symbol] -axis | [symbol] | [symbol] | 2.83 |
| Incident direction of | \textcircled{2}104 | 0.203 | 0.204 | 0.201 | <\textcircled{1} [symbol] \textcircled{3} | 81 | 81 | 80 | [symbol] -axis | 14.17 | 14.40 | 14.23 |
| electron beam [010] | \textcircled{3}003 | 0.468 | 0.475 | 0.475 | <\textcircled{2} [symbol] \textcircled{3} | 55 | 56 | 55 | | | | |
| | | Point | Point | Point | Interplanar | Point | Point | Point | | Point | Point | Point |
| Sample 11 | d value | 3-1 | 3-2 | 3-3 | angle | 3-1 | 3-2 | 3-3 | | 3-1 | 3-2 | 3-3 |
| FIG. 42(A) | \textcircled{1}101 | 0.238 | 0.242 | 0.239 | <\textcircled{1} [symbol] \textcircled{2} | 25 | 25 | 25 | [symbol] -axis | 2.79 | 2.83 | 2.79 |
| Incident direction of | \textcircled{2}104 | 0.198 | 0.199 | 0.198 | <\textcircled{1} [symbol] \textcircled{3} | 80 | 79 | 79 | [symbol] -axis | 14.00 | 13.65 | 13.89 |
| electron beam [010] | \textcircled{3}003 | 0.466 | 0.461 | 0.466 | <\textcircled{2} [symbol] \textcircled{3} | 55 | 54 | 54 | | | | |
| | | Point | Point | Point | Interplanar | Point | Point | Point | | Point | Point | Point |
| Sample 11 | d value | 4-1 | 4-2 | 4-3 | angle | 4-1 | 4-2 | 4-3 | | 4-1 | 4-2 | 4-3 |
| FIG. 42(B) | \textcircled{1}101 | 0.248 | 0.245 | 0.242 | <\textcircled{1} [symbol] \textcircled{2} | 20 | 25 | 25 | [symbol] -axis | 2.93 | 2.87 | 2.84 |
| Incident direction of | \textcircled{2}104 | 0.207 | 0.203 | 0.203 | <\textcircled{1} [symbol] \textcircled{3} | 81 | 80 | 81 | [symbol] -axis | 14.20 | 13.99 | 14.32 |
| electron beam [010] | \textcircled{3}003 | 0.485 | 0.485 | 0.473 | <\textcircled{2} [symbol] \textcircled{3} | 55 | 55 | 56 | | | | |
| | | Point | Point | Point | Interplanar | Point | Point | Point | | Point | Point | Point |
| Sample 1-1 | d value | 3-1 | 3-2 | 3-3 | angle | 3-1 | 3-2 | 3-3 | | 3-1 | 3-2 | 3-3 |
| FIGS. 43-46 | \textcircled{1}003 | 0.468 | 0.461 | 0.468 | <\textcircled{1} [symbol] \textcircled{2} | 54 | 54 | 55 | [symbol] -axis | 2.88 | 2.91 | 2.90 |
| Incident direction of | \textcircled{2}104 | 0.203 | 0.205 | 0.205 | <\textcircled{1} [symbol] \textcircled{3} | 80 | 80 | 80 | [symbol] -axis | 3.95 | 13.97 | 14.13 |
| electron beam [ [symbol] ] | \textcircled{3}101 | 0.248 | 0.248 | 0.247 | <\textcircled{2} [symbol] \textcircled{3} | 25 | 26 | 26 | | | | |
| | | Point | Point | Point | Interplanar | Point | Point | Point | | Point | Point | Point |
| Sample 1-1 | d value | 4-1 | 4-2 | 4-3 | angle | 4-1 | 4-2 | 4-3 | | 4-1 | 4-2 | 4-3 |
| FIGS. 50-53 | \textcircled{1}003 | 0.481 | 0.488 | 0.468 | <\textcircled{1} [symbol] \textcircled{2} | 55 | 56 | 56 | [symbol] -axis | 2.81 | 2.84 | 2.85 |
| Incident direction of | \textcircled{2}104 | 0.200 | 0.202 | 0.203 | <\textcircled{1} [symbol] \textcircled{3} | 81 | 81 | 81 | [symbol] -axis | 13.92 | 14.12 | 14.17 |
| electron beam [ [symbol] ] | \textcircled{3}101 | 0.240 | 0.242 | 0.243 | <\textcircled{2} [symbol] \textcircled{3} | 25 | 25 | 25 | | | | |
| | | Point | Point | Inner | Interplanar | Point | Point | Inner | | Point | Point | Inner |
| Sample 2 | d value | 1 | 2 | portion | angle | 1 | 2 | portion | | 1 | 2 | portion |
| Surface and surface portion | \textcircled{1}- [symbol] | 0.151 | 0.143 | 0.142 | <\textcircled{1} [symbol] \textcircled{2} | 31 | 31 | 30 | [symbol] -axis | 2.98 | 2.85 | 2.83 |
| of (001) orientation | \textcircled{2}- [symbol] | 0.128 | 0.122 | 0.122 | <\textcircled{1} [symbol] \textcircled{3} | 90 | 89 | 90 | [symbol] -axis | 15.40 | 14.26 | 14.35 |
| Incident direction of | \textcircled{3} [symbol] | 0.268 | 0.24 | 0.24 | <\textcircled{2} [symbol] \textcircled{3} | 58 | 59 | 59 | | | | |
| electron beam [ [symbol] ] | | | | | | | | | | | | |

[symbol]

indicates data missing or illegible when filed

### <<Nanobeam Electron Diffraction Pattern>>

Note that the lattice constants shown in Table 3 were calculated from the nanobeam electron diffraction patterns and cannot be directly compared with lattice constants calculated from XRD patterns. However, the lattice constants calculated from the nanobeam electron diffraction patterns can be compared with each other, and represent the features of the samples.

As shown in Table 3, the lattice constant at point1, which is closest to the surface in Sample 2, was large. Thus, a difference between the lattice constant at the measurement point closest to the surface and the lattice constant at the measurement point on the inner side was large. This was probably because the feature of the rock-salt crystal structure such as magnesium oxide strongly appeared at the surface portion.

In contrast, in Sample 1-1, the lattice constant did not vary largely between the measurement points, and the feature of the layered rock-salt crystal structure strongly appeared even at the measurement point closest to the surface in the nanobeam electron diffraction pattern.

This was probably because the rock-salt structure of cobalt oxide (CoO) or the like was repaired to the layered rock-salt crystal structure by the initial heating.

Specifically, in Sample 2, the lattice constant of point1 (the measurement point that is less than or equal to 1 nm in depth from the surface) was larger than that of point2 (the measurement point that is greater than or equal to 3 nm and less than or equal to 10 nm in depth from the surface) by 0.13 Å in a-axis and 1.14 Å in c-axis.

In Sample 1-1, a difference between the measurement point that is less than or equal to 1 nm in depth from the surface and the measurement point that is greater than or equal to 3 nm to less than or equal to 10 nm in depth from the surface was less than or equal to 0.04 Å in a-axis and 0.3 Å in c-axis.

In Sample 1-1, lattice constants and the features of the layered rock-salt crystal structure similar to the inner portion were maintained even in a nanobeam electron diffraction pattern of a region ranging from the surface to a depth of 1 nm or less, which indicates that the function of stabilizing the crystal structure of the surface portion is intensified. This was probably because the additive elements such as magnesium are effectively inserted in lithium sites in the surface portion.

### Example 2

In this example, a positive electrode active material was formed and its crystal structure after charging was analyzed with XRD.

### <Formation of Positive Electrode Active Material>

The samples formed in this example are described with reference to the formation method shown in FIG. 17 to FIG. 19.

As LiCoO₂ in Step S14 in FIG. 17A, with use of cobalt as the transition metal M, commercially available lithium cobalt oxide (CELLSEED C-10N produced by NIPPON CHEMICAL INDUSTRIAL CO., LTD.) not containing magnesium, fluorine, aluminum, and the like was prepared. The initial heating was not performed.

As in Step S20 shown in FIG. 17B, nickel and aluminum were added as the additive elements to LiCoO₂. Nickel hydroxide was prepared as the nickel source, and aluminum hydroxide was prepared as the aluminum source. Nickel hydroxide was weighed to be 0.5 mol % with respect to lithium cobalt oxide and aluminum hydroxide was weighed to be 0.5 mol % with respect to lithium cobalt oxide, and then mixing with the composite oxide was performed by a dry method (Step S31) to obtain the mixture 903 (Step S32).

Next, as Step S33, the mixture 903 was heated. The heating conditions were 850° C. and 10 hours. During the heating, a lid was put on a crucible containing the mixture 904. By the heating, lithium cobalt oxide containing nickel and aluminum was obtained (Step S34). The other formation conditions were the same as those in Example 1. The positive electrode active material (composite oxide) obtained in the above manner was used as Sample 21.

Sample 22 was formed in a manner similar to that of Sample 21 except that only aluminum was added as the additive element.

Sample 23 was formed in a manner similar to that of Sample 21 except that only nickel was added as the additive element.

Sample 24 was formed in a manner similar to that of Sample 21 except that fluorine and magnesium were used as the additive elements, LiF and MgF₂ were prepared as the fluorine source and the magnesium source respectively and then the additive element source (A source) was formed, the A source was mixed to be 0.5 mol % with respect to lithium cobalt oxide, and heating was performed at 850° C. for 60 hours.

Sample 25 was formed in a manner similar to that of Sample 21 except that only magnesium was used as the additive element, magnesium hydroxide was prepared as the magnesium source, and magnesium hydroxide was mixed to be 0.5 mol % with respect to lithium cobalt oxide.

Sample 26 was formed in a manner similar to that of Sample 21 except that only fluorine was used as the additive element, lithium fluoride was prepared as the fluorine source, and lithium fluoride was mixed to be 1.17 mol % with respect to lithium cobalt oxide.

Next, Sample 27 was formed by addition of the magnesium source and the fluorine source in Step S20a shown in FIG. 18 and addition of the nickel source and the aluminum source in Step S40 shown in FIG. 18. Specifically, LiF and MgF₂ as the fluorine source and the magnesium source respectively were prepared to form the additive element source (A source), and the A source was mixed with LiCoO₂ to be 2 mol % with respect to lithium cobalt oxide, and then heating was performed at 850° C. for 60 hours. The obtained composite oxide and nickel hydroxide were mixed and the mixture is mixed with an isopropanol solution in which aluminum isopropoxide (C₉H₂₁AlO₃) was dissolved, and then a sol-gel reaction was made in an air atmosphere for 17 hours. After that, drying was performed at 80° C. for 3 hours in a circulation drying furnace. After that, heating was performed. The heating conditions were 850° C. and 2 hours. The conditions other than above ones were similar to those of Sample 21.

Table 4 shows the formation conditions of Sample 21 to Sample 27.

TABLE 4

| | Formation condition | | | | |
|---|---|---|---|---|---|
| | | | Step S33 | | Step S53 |
| | | | Heating | | Heating |
| | | Step S20 A source | temperature | | temperature |
| | Step S14 | Step S20a A1 source | (Time) | Step S40 A2 source | (Time) |
| Sample 21 | LiCoO₂ | Ni(OH)2 0.5 mol % | 850° C.(10 hr) | — | — |
| | | Al(OH)3 0.5 mol % | | | |
| Sample 22 | | Al(OH)3 0.5 mol % | 850° C.(10 hr) | | |
| Sample 23 | | Ni(OH)2 0.5 mol % | 850° C.(10 hr) | | |
| Sample 24 | | LiF 0.167 mol % | 850° C.(60 hr) | | |
| | | MgF2 0.5 mol % | | | |
| Sample 25 | | Mg(OH)2 0.5 mol % | 850° C.(60 hr) | | |
| Sample 26 | | LiF 1.17 mol % | 850° C.(60 hr) | | |
| Sample 27 | | LiF 0.67 mol % | 850° C.(60 hr) | Ni(OH)2 0.5 mol % | 850° C. (2 hr) |
| | | MgF2 2 mol % | | C9H21AlO3 0.5 mol % | |

Half cells were assembled using the positive electrode active material formed in the above and the positive electrode active material formed in a manner similar to that of Sample 1-1 in Example 1. The conditions of the half cells are described below.

The above-described positive electrode active materials were prepared, acetylene black (AB) was prepared as a conductive material, and polyvinylidene fluoride (PVDF) was prepared as a binder. Slurry was formed by mixing the positive electrode active material, AB, and PVDF at the positive electrode active material:AB:PVDF=95:3:2 (weight ratio), and the slurry was applied to an aluminum current collector. As a solvent of the slurry, NMP was used.

Slurry was applied to the current collector and dried to obtain a positive electrode. The pressure was not applied. In the positive electrode, the loading amount of the active material was approximately 7 mg/cm².

As an electrolyte solution, a solution which is obtained by adding vinylene carbonate (VC) at 2 wt % as an additive agent to a mixture of ethylene carbonate (EC) and diethyl carbonate (DEC) at EC:DEC=3:7 (volume ratio) was used. As an electrolyte contained in the electrolyte solution, 1 mol/L lithium hexafluorophosphate (LiPF₆) was used. For a separator, polypropylene was used.

A lithium metal was prepared as a counter electrode to form coin-type half cells including the above positive electrode and the like. With the use of this, XRD measurement after charging was performed.

The coin cell was charged and subjected to XRD measurement. The charge conditions were CC charging (0.05 C or 0.2 C, a voltage of 4.6 V, and 0.02 C cut) and a charge temperature was 25° C. The condition where 1 C=200 mA/g was used. The positive electrode of the coin cell charged under the above conditions was sealed in an airtight sample holder (produced by Bruker) in an argon atmosphere and subjected to XRD measurement.

The conditions of the XRD measurement were as follows. XRD apparatus: D8 ADVANCE produced by Bruker AXS
X-ray source: Cu
Output: 40 kV, 40 mA
Angle of divergence: Div. Slit, 0.5°
Detector: LynxEye
Scanning method: 2θ/θ continuous scanning
Measurement range (20): from 15 to 75° Step width (20): 0.01°
Counting time: 1 second/step
Rotation of sample stage: 15 rpm

From the obtained XRD patterns, the background and CuKα₂ radiation peak can be removed using analysis software, DIFFRAC. EVA. The conditions were Curvature: 25, Threshold: 1E-5, and Intensity Ratio: 0.5.

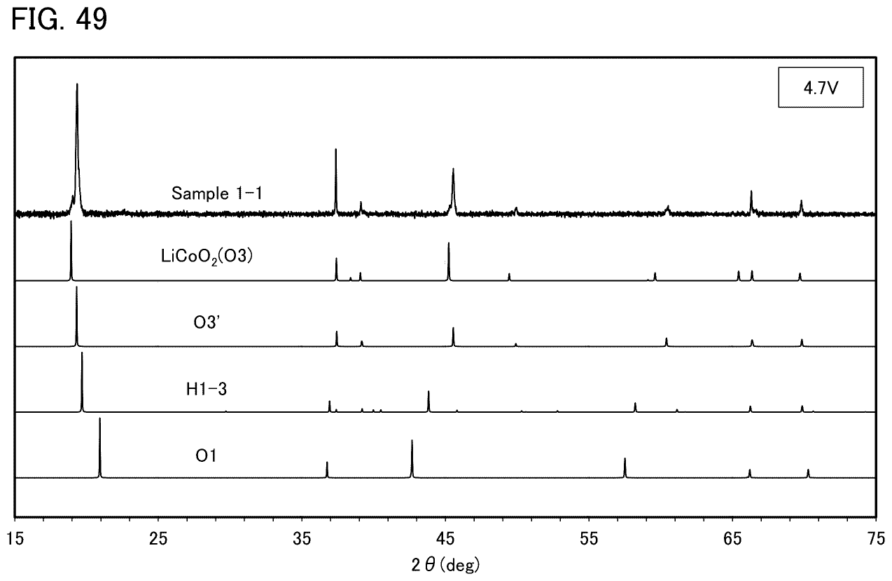

FIG. 49 shows an XRD pattern of Sample 1-1 at 4.7 V charged state. The patterns of LiCoO₂ (O3), O3′, H1-3, and O1-type structures are also shown. FIG. 50A shows an enlarged image of FIG. 49 in the range greater than or equal to 18° (deg) and less than or equal to 21.5°.

FIG. 50B shows an enlarged image of FIG. 49 in the range greater than or equal to 36° and less than or equal to 46°. The charging at this time was CCCV (an upper limit voltage of 4.7 V, a constant current of 0.2 C, a termination current of 0.02 C (1 C=200 mA/g)), and an environmental temperature was set to 25° C. The charge capacity was 215.3 mAb/g.

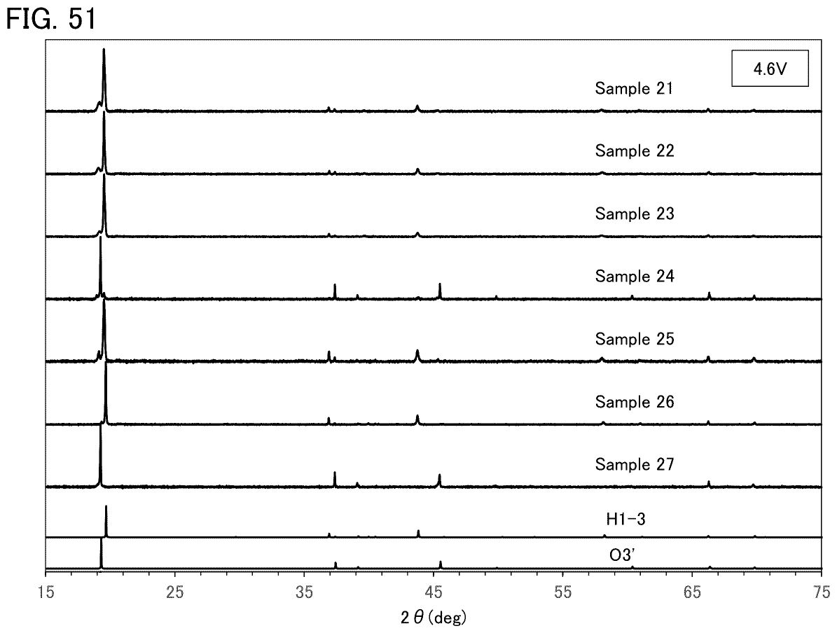

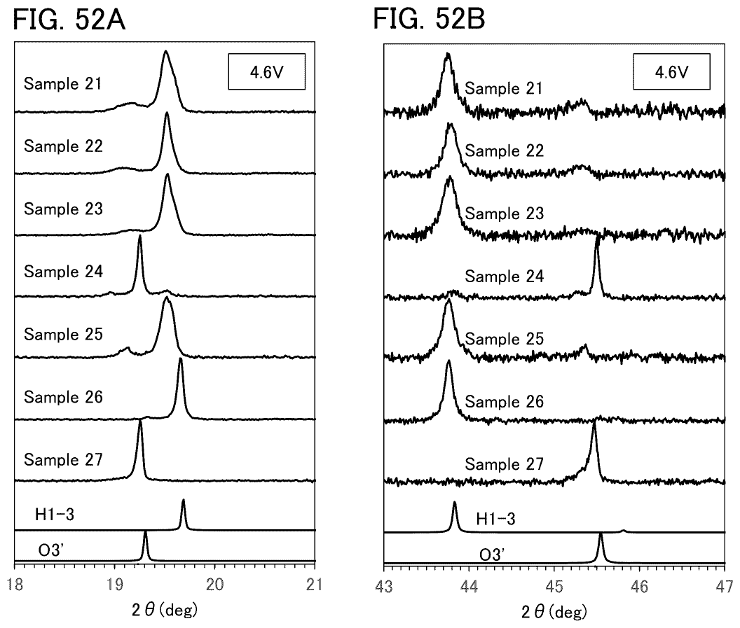

FIG. 51 shows XRD patterns of Sample 21 to Sample 27 at 4.6 V charged state. The patterns of H1-3-type structure and O3′-type structure are also shown. FIG. 52A shows an enlarged image of FIG. 51 in the range greater than or equal to 18° and less than or equal to 21°. FIG. 52B shows an enlarged image in the range of greater than or equal to 43° and less than or equal to 47° in FIG. 51. At this time, CC charging (a constant current of 0.05 C, a termination voltage of 4.6 V, and 1 C=200 mA/g) was performed on Sample 22, Sample 23, Sample 25, and Sample 26. Charging on Sample 24 was CCCV (a constant current of 0.34 C, an upper limit voltage of 4.6 V, a termination current of 0.0068 C, 1 C=200 mA/g), and charging on Sample 27 was CCCV (a constant current of 0.2 C, an upper limit voltage of 4.6 V, and a termination current of 0.02 C and 1 C=200 mA/g). The environmental temperatures for all cases were set to 25° C.

The charge capacity at this time was 232.5 mAh/g for Sample 21, 238.3 mAh/g for Sample 22, 235.3 mAh/g for Sample 23, 225.4 mAh/g for Sample 24, 233.3 mAh/g for Sample 25, 231.2 mAh/g for Sample 26 and 220.6 mAh/g for Sample 27.

As shown in FIG. 51 to FIG. 52B, Sample 1-1, Sample 24, and Sample 27 each containing magnesium and fluorine as the additive elements were found to have the O3′-type structure. This is probably because lithium fluoride used as the fluorine source functioned as a fusing agent and the distribution of magnesium was within a preferred range.

### Example 3

As a safety test of a battery using the positive electrode active material of one embodiment of the present invention, a nail penetration test and differential scanning calorimetry (DSC) measurement were performed. A method for fabricating the battery subjected to the test is described below.

### [Nail Penetration Test]

### <Formation 1 of Positive Electrode>

Sample 1-1 described in Example 1, acetylene black (AB), and polyvinylidene fluoride (PVDF) were prepared as a positive electrode active material, a conductive material, and a binding agent, respectively. The PVDF prepared was one dissolved in N-methyl-2-pyrrolidone (NMP) with a weight ratio of 5%. Next, a slurry mixed at the positive electrode active material:AB:PVDF=95:3:2 (weight ratio) was formed, and the slurry was applied to a positive electrode current collector of aluminum. As a solvent of the slurry, NMP was used.

After that, pressing treatment was performed with a roller press machine to increase the density of the positive electrode active material layer over the positive electrode current collector. The pressing treatment was performed with a linear pressure of 210 kN/m. Note that the temperature of each of an upper roll and a lower roll of the roller press machine was 120° C.

After the slurry was applied to the positive electrode current collector, the solvent was volatilized. Through the above process, Positive Electrode Sample 1 was obtained.

### <Formation 2 of Positive Electrode>

Positive Electrode Sample 2 was formed as a comparative example sample in a manner similar to that of the above-described Positive Electrode Sample 1 except that commercially available lithium cobalt oxide (CELLSEED C-10N produced by NIPPON CHEMICAL INDUSTRIAL CO., LTD.) was used instead of Positive Electrode Active Material Sample 1-1 as the positive electrode active material.

### <Formation of Negative Electrode>

Graphite was prepared as the negative electrode active material. For a binding agent, CMC and SBR were prepared. Carbon fiber (VGCF (registered trademark) produced by SHOWA DENKO K.K.) was prepared as a conductive material. Then, a slurry mixed at graphite: VGCF:CMC:SBR=97:1:1:1 (weight ratio) was formed, and the slurry was applied on a copper negative electrode current collector. As a solvent of the slurry, water was used.

After the slurry was applied on the negative electrode current collector, the solvent was volatilized. Through the above process, the negative electrode was obtained.

### <Fabrication of Lithium-Ion Battery>

A lithium-ion battery (Cell 1) was fabricated using Positive Electrode Sample 1 formed above, the negative electrode formed above, a separator, an electrolyte, and an exterior body. A lithium-ion battery (Cell 2) was fabricated using Positive Electrode Sample 2 formed above, the negative electrode formed above, a separator, an electrolyte, and an exterior body. For a method for fabricating the lithium-ion battery, the method for the laminated secondary battery described in Embodiment 3 was referred to.

As the separator, 25-μm-thick porous polypropylene film was used.

As the electrolyte, an organic electrolyte solution obtained by dissolving lithium hexafluorophosphate (LiPF₆) at 1 mol/L in a mixed organic solvent containing EC (ethylene carbonate) and DEC (diethyl carbonate) at 3:7 (volume ratio) was used.

As the exterior body, an aluminum laminated film was used.

The outer size of each cell was 4.6 cm×6.4 cm. The area of the positive electrode was 20.5 cm² and that of the negative electrode was 23.8 cm². The area of the negative electrode is preferably larger than, or specifically greater than or equal to 1.1 times and less than or equal to 1.3 times as large as, that of the positive electrode.

Next, initial charging and discharging of Cell 1 and Cell 2 were performed. Table 5 shows the initial charging and discharging method of Cell 1, and Table 6 shows the initial charging and discharging method of Cell 2. The initial charging and discharging are sometimes referred to as aging or conditioning. Note that 1 C=200 mA/g (positive electrode active material weight).

TABLE 5

| | Charge/ | |
|---|---|---|
| | Discharge | Condition |
| Step A1 | Constant | 0.01 C. Environmental temperature of 25° C. |
| | current | Charge ends when either termination voltage of |
| | charge | 4.5 V or termination capacity of 15 mAh/g is |
| | | satisfied. |
| Step A2 | Constant | 0.1 C. Environmental temperature of 25° C. |
| | current | Charge ends when either termination voltage of |
| | charge | 4.5 V or termination capacity of 120 mAh/g is |
| | | satisfied. |
| Step A3 | N/A | Left in a thermostatic chamber of 60° C. for 24 |
| | | hours. |
| Step A4 | N/A | One end of a cell is unsealed in a glove box |
| | | and the cell is resealed under the reduced pressure |
| | | environment at −60 kPa. |
| Step A5 | Constant | 0.1 C, 4.5 V. Environmental temperature of 25° |
| | current- | C. Charge ends when either termination |
| | constant | current of 0.01 C or less or termination time of |
| | voltage | 10 hours is satisfied |
| | charge | |
| Step A6 | Constant | 0.2 C. Environmental temperature of 25° C. |
| | current | Discharge ends when either termination voltage |
| | discharge | of 2.5 V or termination time of 8 hours is |
| | | satisfied. |
| Step A7 | Constant | 0.2 C, 4.5 V. Environmental temperature of 25° |
| | current- | C. |
| | constant | Charge ends when either termination current of |
| | voltage | 0.02 C or less or termination time of 8 hours is |
| | charge | satisfied |
| Step A8 | Constant | 0.2 C. Environmental temperature of 25° C. |
| | current | Discharge ends when either termination voltage |
| | discharge | of 2.5 V or termination time of 8 hours is |
| | | satisfied. |

※Step A7 and Step A8 are repeated 3 times.

TABLE 6

| | Charge/ | |
|---|---|---|
| | Discharge | Condition |
| Step A1 | Constant | 0.01 C. Environmental temperature of 25° C. |
| | current | Charge ends when either termination voltage of |
| | charge | 4.2 V or termination capacity of 15 mAh/g is |
| | | satisfied. |
| Step A2 | Constant | 0.1 C. Environmental temperature of 25° C. |
| | current | Charge ends when either termination voltage of |
| | charge | 4.2 V or termination capacity of 120 mAh/g is |
| | | satisfied. |
| Step A3 | N/A | Left in a thermostatic chamber of 60° C. for 24 |
| | | hours. |
| Step A4 | N/A | One end of a cell is unsealed in a glove box |
| | | and the cell is resealed under the reduced pressure |
| | | environment at −60 kPa. |
| Step A5 | Constant | 0.1 C, 4.2 V. Environmental temperature of 25° |
| | current- | C. Charge ends when either termination |
| | constant | current of 0.01 C or less or termination time of |
| | voltage | 10 hours is satisfied. |
| | charge | |
| Step A5 | Constant | 0.2 C. Environmental temperature of 25° C. |
| | current | Discharge ends when either termination voltage |
| | discharge | of 2.5 V or termination time of 8 hours is |
| | | satisfied. |
| Step A6 | Constant | 0.2 C, 4.2 V. Environmental temperature of 25° |
| | current- | C. |
| | constant | Charge ends when either termination current of |
| | voltage | 0.02 C or less or termination time of 8 hours is |
| | charge | satisfied. |
| Step A7 | Constant | 0.2 C. Environmental temperature of 25° C. |
| | current | Discharge ends when either termination voltage |
| | discharge | of 2.5 V or termination time of 8 hours is |
| | | satisfied. |

※Step A7 and Step A8 are repeated 3 times.

### <Nail Penetration Test>

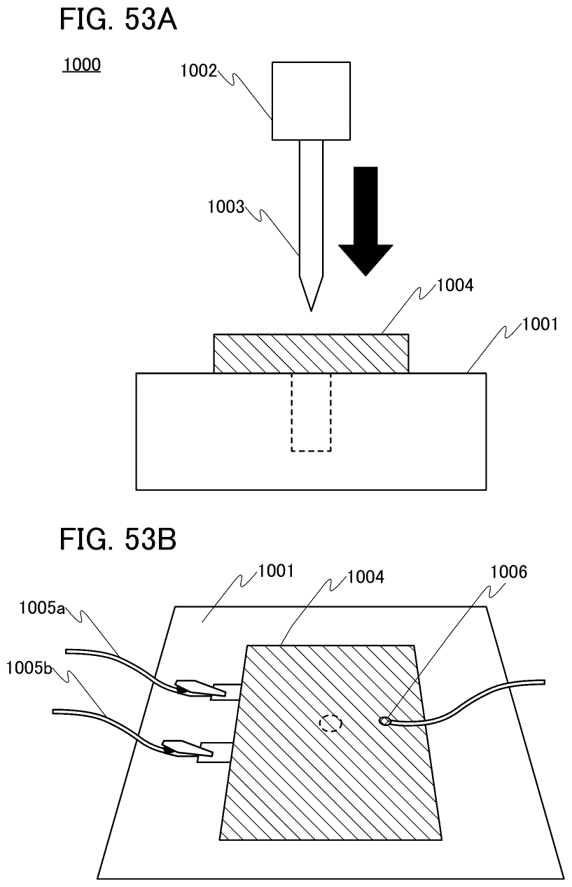

After the initial charging and discharging, a nail penetration test was performed on Cell 1 and Cell 2. For the nail penetration test, Advanced Safety Tester produced by ESPEC CORP was used. As schematic diagrams of nail penetration test device 1000, a side view and a perspective view are shown in FIG. 53A and FIG. 53B respectively.

The nail penetration test device 1000 illustrated in FIG. 53A includes a stage 1001, a driving portion 1002, and the nail 1003. The driving portion 1002 includes a driving mechanism for moving the nail 1003 in the arrow direction shown in the diagram. The driving portion 1002 operates so as to make the nail 1003 penetrate a battery 1004 disposed on the stage 1001. This operation is called nail penetration operation. The dashed line in FIG. 53A indicates a depression of the stage 1001 for holding the nail 1003 that has penetrated the secondary battery in the nail penetration operation.

FIG. 53B is a perspective view illustrating the upper side of the stage 1001 of the nail penetration test device 1000 and the vicinity of the upper side. The battery 1004 disposed over the stage 1001 is electrically connected to a wiring 1005a and a wiring 1005b. Furthermore, a temperature sensor 1006 is provided to be in contact with a surface of the exterior body of the battery 1004. Note that the position indicated by the dashed ellipse in FIG. 53B represents a position where the nail 1003 penetrates the battery 1004 in the nail penetration operation. The temperature sensor 1006 was provided at a position approximately 2 cm away from the position where the nail 1003 penetrates on the side, where the wiring 1005a and the wiring 1005b were not provided.

As the nail 1003, a nail having a diameter of 3 mm was used. The operation speed of nail penetration was 5 mm/s.

The nail penetration test was performed on Cell 1 and Cell 2 using the above-described nail penetration test device 1000. Cell 1 and Cell 2 subjected to the nail penetration test was fully charged under the condition of Step A7 in Table 5 and the condition of Step A7 in Table 6, respectively. The temperature was adjusted so that the battery temperature reached 23° C. before the nail penetration test. Table 7 shows the conditions of Cell 1 and Cell 2 including the loading amount of the positive electrode active material, the loading amount of the negative electrode active material, the charge capacity, and the like. The proportion of negative electrode capacity to positive electrode capacity in the table is a calculated ratio of the capacity of the negative electrode to the capacity of the positive electrode, on the assumption that the capacity is product of the loading amount, the charge capacity of the active material (CELLSEED C-10N was 185 mAh/g, LCO to which the impurity was added was 200 mAh/g, and graphite was used as 300 mAh/g when charged with a full cell charge voltage of 4.5 V), and the area. Note that the charge capacity of the commercially available cell was 3.18 Ah.

TABLE 7

| | | Cell 1 | | Cell 2 | |
|---|---|---|---|---|---|
| Positive | Positive electrode active material | Sample 1-1 | | Sample 2 | |
| electrode | Binder | PVdF | | | |
| | Conductive additive | Acetylene black | | | |
| | Loading amount (on one surface) | 9.8 | mg/cm² | 21.3 | mg/cm² |
| | Current collector foil/thickness | Al/20 μm | | | |
| | Pressing pressure | 210 kN/m | | | |
| Negative | Active material | Graphite | | | |
| electrode | binder, thickener | SBR, CMC | | | |
| | conductive additive | VGCF | | | |
| | Loading amount (on one surface) | 6.8 | mg/cm² | 10.1 | mg/cm² |
| | Current collector foil/thickness | Cu/18 μm | | | |
| Separator | Material/Thickness | PP(polypropylene)/25 μm | | | |
| Electrolyte | Solvent | EC:DEC = 30:70 | | | |
| solution | Lithium salt | IMLiPF₆ | | | |
| Cell | Number of positive electrode | 15 (double-side-coated) | | 7 (double-side-coated) | |
| condition | Number of negative electrode | 14 (double-side-coated) + | | 6 (double-side-coated) + | |
| | | 2 on outer side (single-side- | | 2 on outer side (single-side- | |
| | | coated) | | coated) | |
| | Exterior body | Aluminum laminated film | | | |
| Nail | Charge voltage | 4.5 | V | 4.2 | V |
| penetration | (at the time of aging) | | | | |
| test | Charge voltage | 4.5 V | | | |
| condition | (at the time of nail penetration) | | | | |
| | Design capacity | 1200 mAh | | | |
| | Proportion of negative electrode | 82.7% | | 111.9% | |
| | capacity to positive electrode | | | | |
| | capacity | | | | |

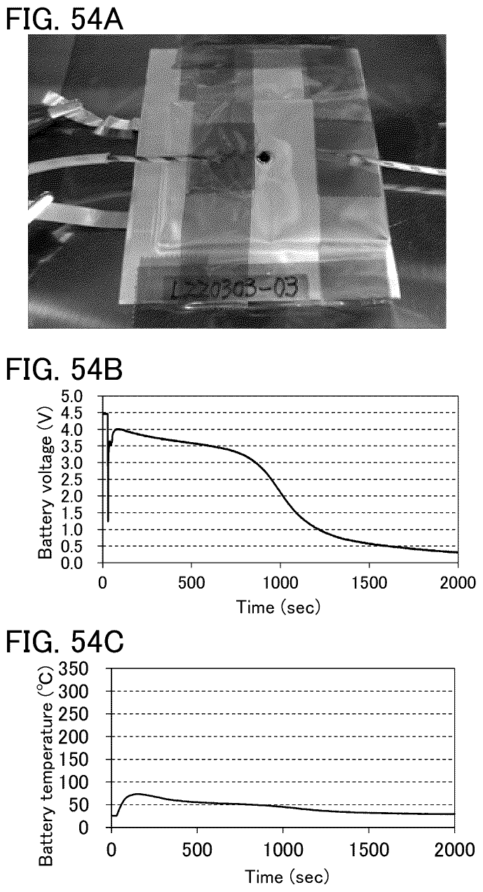

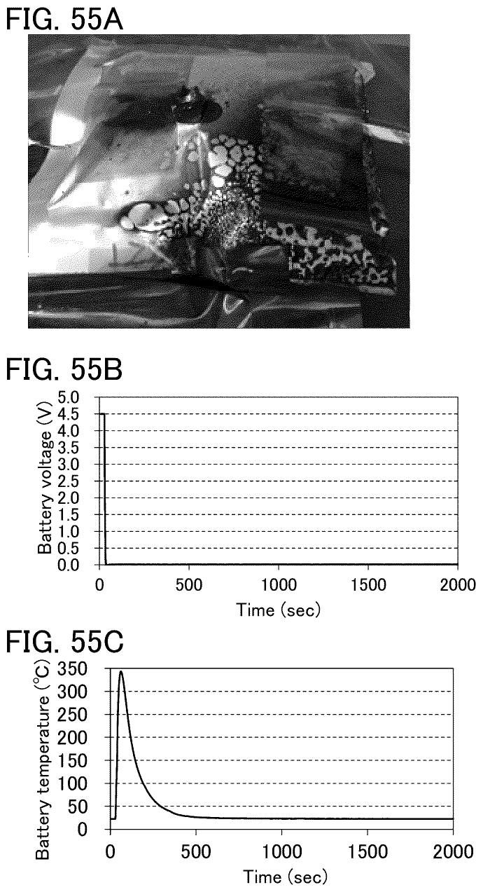

FIG. 54A to FIG. 54C show results of the nail penetration test on Cell 1. FIG. 55A to FIG. 55C show results of the nail penetration test on Cell 2.

FIG. 54A and FIG. 55A are photographs of Cell 1 and Cell 2 after the nail penetration test. FIG. 54B and FIG. 55B are graphs showing changes in the voltages of Cell 1 and Cell 2 in the nail penetration test. FIG. 54C and FIG. 55C are graphs showing temperature changes of Cell 1 and Cell 2 in the nail penetration test. Note that the nail touches the battery at 22 seconds on the horizontal axis (sec) in FIG. 54B, FIG. 54C, FIG. 55B, and FIG. 55C.

In the nail penetration test, a small amount of smoke was observed but ignition did not occur in Cell 1. On the other hand, a large amount of smoke and ignition were observed in Cell 2.

As illustrated in FIG. 54A, there was no great change in the appearance of Cell 1 after the nail penetration test, although there was liquid leakage of an electrolyte from a nail hole in the center portion of Cell 1.

In Cell 2 after the nail penetration test, the battery was expanded and the exterior body was burnt as illustrated in FIG. 55A.

As shown in FIG. 54B, the battery voltage of Cell 1 was seen decreasing to less than or equal to 1.5 V immediately after the nail penetration operation, then increasing to approximately 4.0 V, and then gradually decreasing. By contrast, as shown in FIG. 55B, the battery voltage of Cell 2 decreased to 0 V immediately after the nail penetration operation and the battery voltage remained at 0 V thereafter.

As shown in FIG. 54C, the temperature of Cell 1 increased to 73° C. after the nail penetration operation. As shown in FIG. 55C, the temperature of Cell 2 increased to 340° C.

From the above results, in the Cell 2 fabricated using the comparative example sample as the positive electrode active material, a rapid temperature rise and a voltage decrease occurred in the nail penetration test, whereas in the Cell 1 fabricated using Positive Electrode Active

Material Sample 1, the temperature rise and the voltage decrease were both gentle. It is presumable that the stable crystal structure of Positive Electrode Active Material Sample 1-1 inhibited a thermal decomposition reaction involving oxygen release from occurring even in the positive electrode active material from which much lithium was extracted, which in turn hindered ignition due to thermal runaway. In other words, the positive electrode active material of one embodiment of the present invention does not easily ignite when abnormalities such as an internal short circuit occur; that is, it can be regarded as a highly safe positive electrode active material.

### [DSC Test]

A DSC test in a charged state was performed to examine the thermal stability of Positive Electrode Active Material Sample 1-1 and Positive Electrode Active Material Sample 10. In the DSC test, a positive electrode that was charged to 4.6 V in a half cell whose negative electrode was made of a lithium metal was used.

### <Fabrication of Half Cell>

A half cell (Cell 3) was fabricated which included Positive Electrode Sample 1 formed as described above, a lithium metal foil, a separator, an electrolyte, a coin cell positive electrode can, and a coin cell negative electrode can. A half cell (Cell 4) was fabricated which included Positive Electrode Sample 2 formed as described above, a lithium metal foil, a separator, an electrolyte, a coin cell positive electrode can, and a coin cell negative electrode can. Note that the positive electrode active material loading amount of Positive Electrode Sample 1 for the DSC test was 14.5 mg/cm², and the positive electrode active material loading amount of Positive Electrode Sample 2 for the DSC test was 15.2 mg/cm².

### <Pretreatment for DSC Test>

As pretreatment for the DSC test, Cell 3 and Cell 4 described above were charged and discharged. The conditions of the charging were as follows: constant current charging at 0.1 C was performed up to 4.6 V, and constant voltage charging was performed at 4.6 V until a termination current of 0.005 C was reached. The discharging was constant current discharging at 0.1 C up to 2.5 V. The above charging and discharging were repeated twice. Note that the environmental temperature of the charging and discharging was 25° C.

Then, on Cell 3 and Cell 4, constant current charging at 0.1 C was performed up to 4.6 V and then, constant voltage charging at 4.6 V was performed until a termination current of 0.005 C was reached, so that Cell 3 and Cell 4 were in a 4.6-V charged state. After that, Cell 3 and Cell 4 in a 4.6-V charged state were disassembled in a glove box with an argon atmosphere to take out the positive electrodes, and the positive electrodes were washed with DMC to remove the electrolyte solution. After drying, each of Positive Electrode Sample 1 and Positive Electrode Sample 2 taken from Cell 3 and Cell 4, respectively, was stamped out to be 3 mmφ.

The positive electrodes (Positive Electrode Sample 1 and Positive Electrode Sample 2) stamped out were each put in a stainless steel container and then, 1 μL of an electrolyte was dripped. This electrolyte was formed under the same conditions as the electrolyte used for the half cell. Then, zirconium oxide balls with a diameter of 2 mm were put on the positive electrode in the above stainless steel container. Putting such zirconium oxide balls has an effect of inhibiting the above positive electrode from being detached from the bottom surface of the container. After that, a stainless steel lid was pressed into the above container to seal the container.

### <DSC Measurement>

For DSC measurement, Thermo plus EVO2 DSC8231, a high-sensitive differential scanning calorimeter manufactured by Rigaku Corporation, was used. For the measurement conditions, the temperature range was from room temperature to 400° C., and the temperature rise rate was 5° C./min. As a reference, only a zirconia ball was put in the same container where the sample was put, and the lid was pressed into.

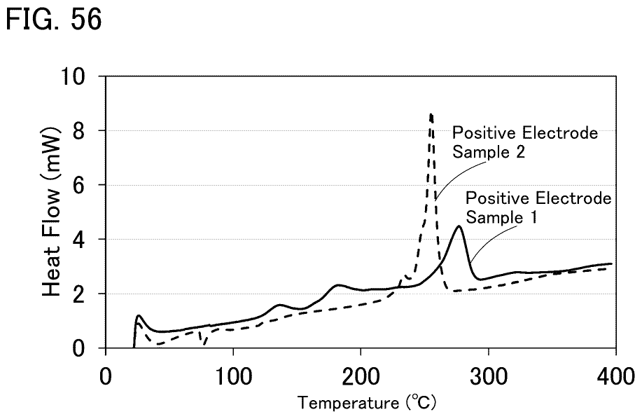

FIG. 56 shows the results of DSC measurement. The horizontal axis represents Temperature, and the vertical axis represents Heat Flow. In the graph, the solid line indicates the results for Positive Electrode Sample 1 in the 4.6-V charged state and the dashed line indicates the results for Positive Electrode Sample 10 in the 4.6-V charged state.

As shown in FIG. 56, the temperature showing the local maximum value of the peak whose area intensity of heat generation in DSC measurement was the maximum was 276.8° C. in Positive Electrode Sample 1 in the 4.6-V charged state. Meanwhile, the temperature showing the local maximum value of the peak whose area intensity of heat generation in DSC measurement was the maximum was lower than or equal to 270° C., lower than or equal to 260° C. in detail, specifically 255.2° C. in Positive Electrode Sample 2 in the 4.6-V charged state.

In comparison of the temperatures at which the maximum peaks appeared in DSC measurement, the temperature at which Positive Electrode Sample 1 in the 4.6-V charged state exhibited the local maximum value was higher than the temperature at which Positive Electrode Sample 2 in the 4.6-V charged state exhibited the local maximum value by approximately 20° C. That is, Positive Electrode Sample 1 can be regarded as having higher thermal stability than Positive Electrode Sample 10.

Note that the peak appeared around 130° C. of Positive Electrode Sample 1 was presumably attributed to a change in the crystal structure of the positive electrode active material with no oxygen release. The peak appeared around 180° C. of Positive Electrode Sample 1 was presumably attributed to decomposition of the electrolyte solution at the surface of the positive electrode active material. The peak appeared at higher than or equal to 250° C. and lower than or equal to 300° C. were presumably attributed to release of oxygen from the positive electrode active material and subsequent thermal decomposition.

### REFERENCE NUMERALS

100: positive electrode active material, 100a: surface portion, 100b: inner portion, 102: filling portion, 104: coating portion, 105: crystal grain boundary

1. A lithium-ion secondary battery comprising:
a positive electrode,
wherein the positive electrode comprises a positive electrode active material,
wherein the positive electrode active material comprises lithium cobalt oxide comprising nickel and magnesium,
wherein a detected amount of nickel in a surface portion of the positive electrode active material is larger than a detected amount of nickel in an inner portion of the positive electrode active material,
wherein a detected amount of magnesium in the surface portion of the positive electrode active material is larger than a detected amount of magnesium in the inner portion of the positive electrode active material, and
wherein a distribution of nickel and a distribution of magnesium overlap with each other in the surface portion of the positive electrode active material.

2. The lithium-ion secondary battery according to claim 1,
wherein nickel is detected at a plane other than a (001) plane of lithium cobalt oxide in the surface portion of the positive electrode active material.

3. The lithium-ion secondary battery according to claim 2,
wherein, in EDX line analysis, a difference between a depth of a peak of a detected amount of nickel and a depth of a peak of a detected amount of magnesium in the surface portion of the positive electrode active material is less than or equal to 3 nm.

4. The lithium-ion secondary battery according to claim 3,
wherein the positive electrode active material comprises aluminum, and
wherein in an EDX line analysis profile of nickel, magnesium, and aluminum comprised in the positive electrode active material, a maximum value of a detected amount of aluminum is observed at an inner portion than a maximum value of a detected amount of nickel and a maximum value of a detected amount of magnesium,
wherein when a peak width at a height of ⅕ of the maximum value of a detected amount of aluminum is divided to two parts by a vertical line drawn from the maximum value to the horizontal axis, a peak width W_{c} on an inner side is larger than a peak width Wₛ on a surface side.

5. The lithium-ion secondary battery according to claim 1,
wherein in a battery in which a counter electrode of the positive electrode is lithium, when the positive electrode is analyzed by powder X-ray diffraction using a CuKα1 ray in a state where the battery is charged to 4.6 V, a diffraction pattern of the positive electrode active material comprises a peak at least at 2θ of greater than or equal to 19.13 and less than 19.37 and 20 of greater than or equal to 45.37° and less than 45.57°.

6. The lithium-ion secondary battery according to claim 5,
wherein the positive electrode active material comprises titanium, and
wherein a detected amount of titanium in the surface portion of the positive electrode active material is larger than a detected amount of titanium in the inner portion of the positive electrode active material.

7. The lithium-ion secondary battery according to claim 5,
wherein the positive electrode active material comprises fluorine, and
wherein a detected amount of fluorine in the surface portion of the positive electrode active material is larger than a detected amount of fluorine in the inner portion of the positive electrode active material.

8. The lithium-ion secondary battery according to claim 6,
wherein the positive electrode active material comprises fluorine, and
wherein a detected amount of fluorine in the surface portion of the positive electrode active material is larger than a detected amount of fluorine in the inner portion of the positive electrode active material.

9. A lithium-ion secondary battery comprising:
a positive electrode,
wherein the positive electrode comprises a positive electrode active material,
wherein the positive electrode active material comprises lithium cobalt oxide comprising nickel, magnesium, and aluminum, and
wherein in an EDX line analysis profile of nickel, magnesium, and aluminum comprised in the positive electrode active material, a maximum value of a detected amount of aluminum is observed at an inner portion than a maximum value of a detected amount of nickel and a maximum value of a detected amount of magnesium.

10. The lithium-ion secondary battery according to claim 9, wherein when a peak width at a height of ⅕ of the maximum value of a detected amount of aluminum is divided to two parts by a vertical line drawn from the maximum value to the horizontal axis, a peak width W_{c} on an inner side is larger than a peak width Wₛ on a surface side.
